(19) United States
(12) Patent Application Publication
(10) Pub. No.: US 2022/0113459 A1
(43) Pub. Date: Apr. 14, 2022

(54) POLARIZATION SELECTIVE OPTICAL ELEMENT AND FABRICATION METHOD

(71) Applicant: Facebook Technologies, LLC, Menlo Park, CA (US)

(72) Inventors: Yun-Han LEE, Redmond, WA (US); Barry David SILVERSTEIN, Kirkland, WA (US); Lu LU, Kirkland, WA (US); Junren WANG, Mercer Island, WA (US); Babak AMIRSOLAIMANI, Redmond, WA (US)

(21) Appl. No.: 17/066,114

(22) Filed: Oct. 8, 2020

(51) Int. Cl. G02B 5/30; B05D 5/06

(52) U.S. Cl. CPC G02B 5/3016; B05D 5/06

(57) ABSTRACT

A method includes obtaining a mixture including a first composition and a second composition. The method also includes forming a layer based on the mixture. Ratios between an amount of the first composition and an amount of the second composition at at least two locations of the layer are different.

### TECHNICAL FIELD

The present disclosure relates generally to optical devices and fabrication methods and, more specifically, to a polarization selective optical element and a method for fabricating the polarization selective optical element.

### BACKGROUND

Polarization selective optical elements have gained increasing interests in optical device and system applications, for example, in beam steering devices, waveguides, and displays. A polarization volume hologram (“PVH”) is one type of a polarization selective optical element. A PVH may exhibit a polarization selectivity. For example, a PVH may primarily (or substantially) diffract an input light having a first predetermined polarization (e.g., a circular polarization having a predetermined handedness) via Bragg diffraction, and primarily transmit, with negligible diffraction, an input light having a second predetermined polarization (e.g., a circular polarization having an opposite handedness). The Bragg diffraction occurs when the input light has a wavelength within a Bragg diffraction wavelength range, and an incidence angle within a Bragg diffraction incidence angle range. A PVH may have a large diffraction angle with a high diffraction efficiency. For example, a PVH may diffract a light to a first order at a diffraction angle of 70° or larger, with a diffraction efficiency of 90% or more. A PVH may have a negligible diffraction effect on an input light having a wavelength out of the Bragg diffraction wavelength range and/or an incidence angle out of the Bragg diffraction incidence angle range. PVHs also demonstrate excellent multiplexing abilities. Due to these properties, PVHs can be implemented in various applications in a large variety of technical fields. PVH elements can be fabricated using various methods, e.g., holographic interference or holography, laser direct writing, and various other forms of lithography.

### SUMMARY OF THE DISCLOSURE

Consistent with an aspect of the present disclosure, a method includes obtaining a mixture including a first composition and a second composition. The method also includes forming a layer based on the mixture. Ratios between an amount of the first composition and an amount of the second composition at at least two locations of the layer are different.

Consistent with another aspect of the present disclosure, a method includes dispensing a first composition on a substrate to form a first layer. The method also includes exposing the first layer to a first polarization interference to form a first birefringent medium layer with a first optic axis having a first varying orientation. The method also includes dispensing a second composition onto the substrate or the first birefringent medium layer to form a second layer. The method also includes exposing the second layer to a second polarization interface to form a second birefringent medium layer with a second optic axis having a second varying orientation. The first birefringent medium layer and the second birefringent medium layer form a third birefringent medium layer having at least one of a thickness variation, a birefringence variation, or a slant angle variation in at least one dimension of the third birefringent medium layer.

Consistent with another aspect of the present disclosure, a birefringent medium layer includes a first composition having a first birefringence and a first chirality. The birefringent medium layer also includes a second composition having a second birefringence and a second chirality, the second composition being mixed with the first composition. At at least two different locations of the birefringent medium layer, ratios between amounts of the first composition and the second composition are different. The birefringent medium layer has at least one of a thickness variation, a birefringence variation, or a slant angle variation along at least one dimension at a plurality of different locations.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic three-dimensional (“3D”) view of a polarization volume hologram (“PVH”), according to an embodiment of the present disclosure;

FIGS. 1B-1D illustrate portions of schematic 3D orientational patterns of optically anisotropic molecules of a PVH, according to various embodiments of the present disclosure;

FIG. 1E illustrates a portion of a schematic in-plane orientational pattern of optically anisotropic molecules of the PVH shown in FIGS. 1B-1D, according to an embodiment of the present disclosure;

FIGS. 2A-2D schematically illustrate processes for fabricating a PVH, according to an embodiment of the present disclosure;

FIG. 3A schematically illustrates processes for dispensing a composition layer onto a surface of a substrate using an inkjet printer, according to an embodiment of the present disclosure;

FIG. 3B illustrates relationships between driving voltage waveforms for driving a flow control device coupled with a printhead and volumes of droplets dispensed by the printhead, according to an embodiment of the present disclosure;

FIG. 3C schematically illustrates a printing path of the printhead for printing a composition layer, according to an embodiment of the present disclosure;

FIGS. 4A-4F schematically illustrate processes for fabricating a PVH, according to another embodiment of the present disclosure;

FIGS. 5A-5D illustrate schematic diagrams of polarization volume holograms (“PVHs”) fabricated using the processes shown in FIGS. 4A-4F, according to various embodiments of the present disclosure;

FIGS. 6A-6E schematically illustrate processes for fabricating a PVH, according to another embodiment of the present disclosure;

FIGS. 7A-7C illustrate schematic diagrams of PVHs fabricated using the processes shown in FIGS. 6A-6E, according to various embodiments of the present disclosure;

FIGS. 8A-8F schematically illustrate processes for fabricating PVHs, according to various embodiments of the present disclosure;

FIG. 8G schematically illustrates a PVH fabricated based on the processes shown in FIGS. 8E and 8F, according to an embodiment of the present disclosure;

FIG. 9 illustrates a flowchart showing a method for fabricating a PVH, according to an embodiment of the present disclosure;

FIG. 10 illustrates a flowchart showing a method for fabricating a PVH, according to another embodiment of the present disclosure;

FIG. 11 illustrates a flowchart showing a method for fabricating a PVH, according to another embodiment of the present disclosure;

FIG. 12A illustrates a schematic diagram of a waveguide display system, according to an embodiment of the present disclosure;

FIG. 12B illustrates a schematic diagram of diffraction of an image light using a conventional waveguide display system including an out-coupling diffractive element with a uniform diffraction efficiency;

FIG. 12C illustrates a schematic diagram of diffraction of an image light using a disclosed waveguide display system, according to an embodiment of the present disclosure;

FIG. 12D illustrates a schematic diagram of diffraction of image lights using a disclosed waveguide display system, according to an embodiment of the present disclosure;

FIG. 12E illustrates a relationship between a diffraction efficiency of a disclosed PVH and the incidence angle at different locations of the PVH, according to an embodiment of the present disclosure;

FIG. 13A illustrates a schematic diagram of a near-eye display (“NED”), according to an embodiment of the present disclosure;

FIG. 13B illustrates a schematic cross sectional view of half of the NED shown in FIG. 13A, according to an embodiment of the present disclosure;

FIG. 14 schematically illustrate a system and method for fabricating a birefringent medium layer, according to an embodiment of the present disclosure;

FIG. 15 schematically illustrate a system and method for fabricating a birefringent medium layer, according to another embodiment of the present disclosure;

FIG. 16 illustrates a flowchart illustrating a method for fabricating a birefringent medium layer, according to an embodiment of the present disclosure; and

FIG. 17 illustrates a flowchart illustrating a method for fabricating a birefringent medium layer, according to another embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or a combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

The term “dispensing” encompasses any suitable manner in which a composition may be dispensed, such as coating (e.g., spin-coating), depositing (e.g., physical vapor deposition), printing (e.g., printing using an inkjet printer), etc.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“ROM”), a flash memory, etc.

The term “communicatively coupled” or “communicatively connected” indicates that related items are coupled or connected through an electrical and/or electromagnetic coupling or connection, such as a wired or wireless communication connection, channel, or network.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared (“IR”) wavelength range, or a combination thereof.

The term “film” and “layer” may include rigid or flexible, self-supporting or free-standing film, coating, or layer, which may be disposed on a supporting substrate or between substrates. The phrases “in-plane direction,” “in-plane orientation,” “in-plane rotation,” “in-plane alignment pattern,” and “in-plane pitch” refer to a direction, an orientation, a rotation, an alignment pattern, and a pitch in a plane of a film or a plane or a layer (e.g., a surface of the film or layer, or a plane parallel to the surface of the film or layer), respectively.

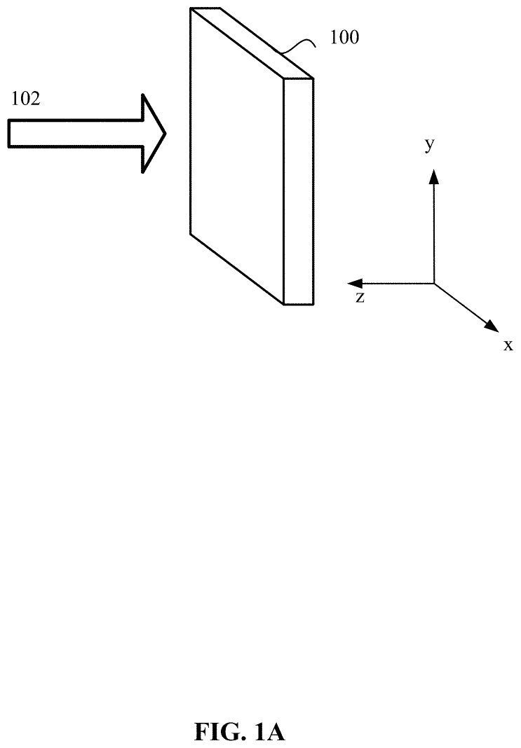

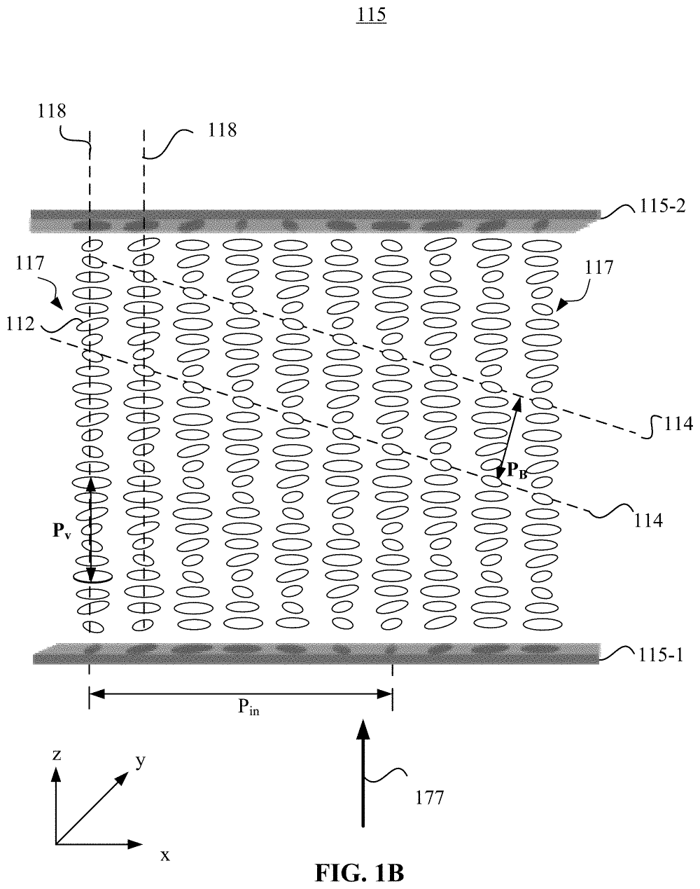

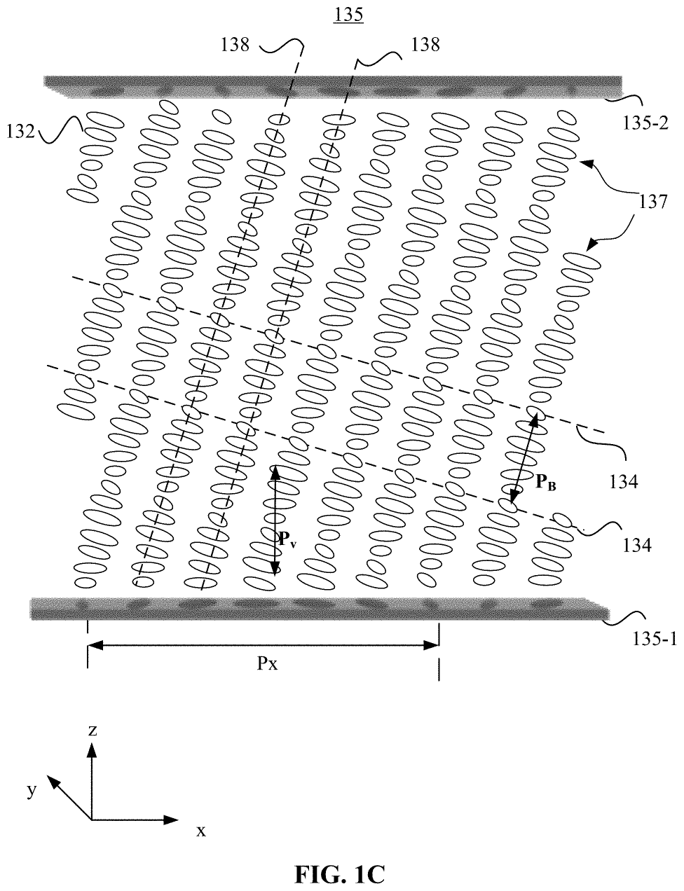

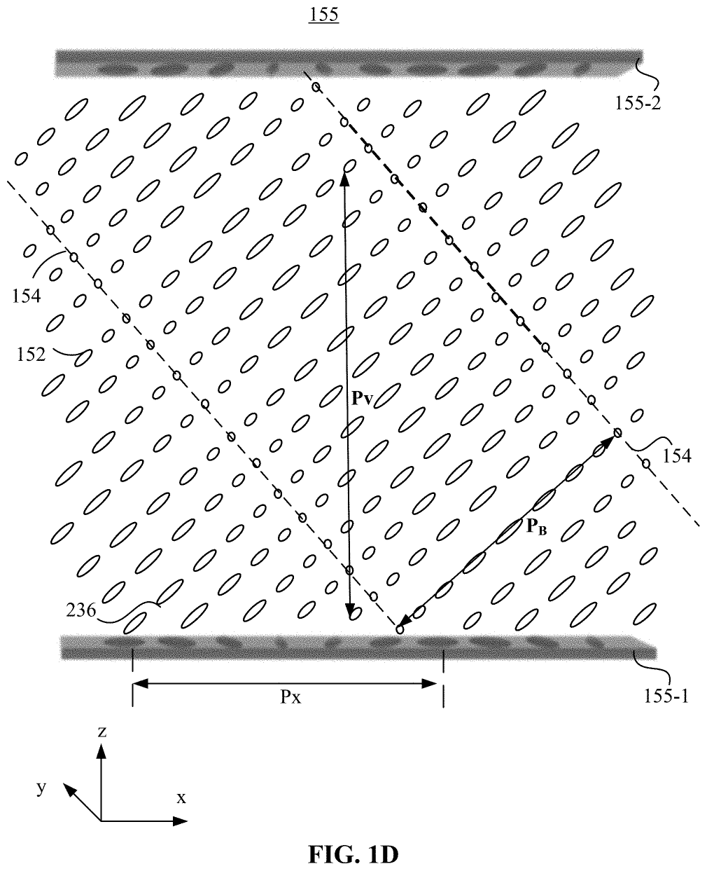

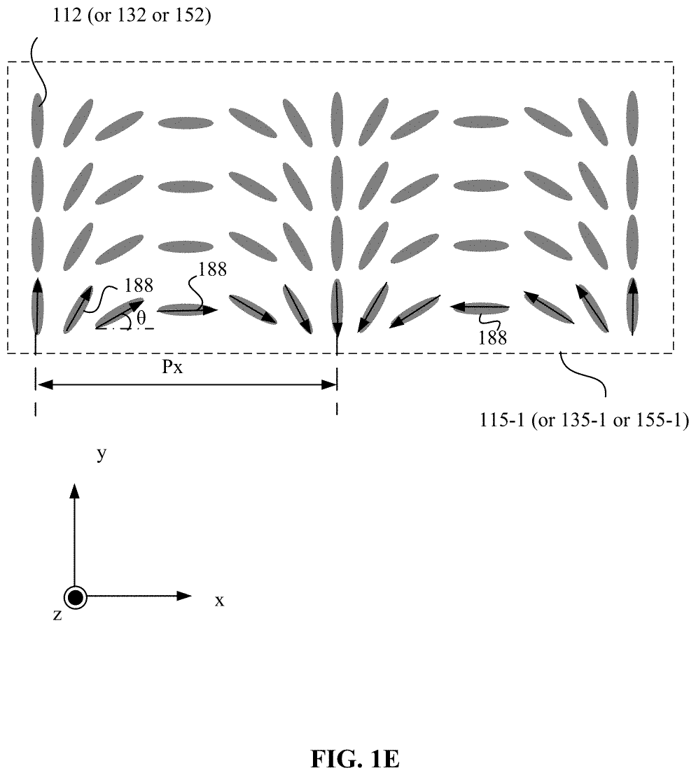

Polarization volume holograms (“PVHs”) or PVH elements have features of compactness, polarization selectivity, high diffraction efficiency, large diffraction efficiency, etc. Thus, PVHs can be implemented in various applications in a variety of technical fields. PVHs may include liquid crystal (“LC”) material with spatially varying orientations of directors of LC molecules in at least one of an in-plane direction or an out-of-plane direction. FIG. 1A illustrates a schematic three-dimensional (“3D”) view of a PVH 100 with an incident light 102 incident onto the PVH 100 along a −z-axis, according to an embodiment of the present disclosure. The PVH 100 may include a birefringent medium in a form of a layer (or a film, a plate), referred to as a birefringent medium layer. Although the PVH 100 is shown as a rectangular plate shape for illustrative purposes, the PVH 100 may have any suitable shape, such as a circular shape. In some embodiments, one or both surfaces along the light propagating path of the incident light 102 may have curved shapes. The birefringent medium layer may include optically anisotropic molecules configured in a three-dimensional (“3D”) orientational pattern to provide an optical function of the PVH 100. In some embodiments, the PVH 100 may be fabricated based on a birefringent medium, e.g., liquid crystal (“LC”) materials, having an intrinsic orientational order of optically anisotropic molecules that can be locally controlled. In some embodiments, the PVH 100 may be fabricated based on photosensitive polymers, such as amorphous polymers, liquid crystal (“LC”) polymers, etc., which may generate an induced (e.g., photo-induced) optical anisotropy and/or induced (e.g., photo-induced) local optic axis orientations when subjected to a polarized light irradiation. PVHs as described herein can also be fabricated by various other methods, such as holographic interference, laser direct writing, and various other forms of lithography. Thus, a “hologram” as described herein is not limited to fabrication by holographic interference, or “holography.” The method disclosed herein provides an efficient and cost-effective method for fabricating a high performance PVH with any desirable 1D or 2D diffraction efficiency profile (e.g., any non-uniform diffraction efficiency profile).

FIGS. 1B-1D schematically illustrate portions of 3D orientational patterns of optically anisotropic molecules included in a birefringent medium layer of the PVH 100, according to various embodiments of the present disclosure. FIG. 1E schematically illustrates a portion of an in-plane orientation pattern of the optically anisotropic molecules located in close proximity to (including those located at) at least one of a first surface or a second surface of the birefringent medium layer shown in FIGS. 1B-1D. For discussion purposes, LC molecules are used as examples of the optically anisotropic molecules of the birefringent medium layer. Each LC molecule is depicted in FIGS. 1B-1E as having rod shape with a longitudinal direction (or a length direction) and a lateral direction (or a width direction). The longitudinal direction of the LC molecule is referred to as a director of the LC molecule or an LC director. An orientation of the LC director may determine a local optic axis orientation or an orientation of the optic axis at a local point of a birefringent medium layer included in the PVH. The term “optic axis” may refer to a direction in a crystal. A light propagating in the optic axis direction may not experience birefringence (or double refraction). An optic axis may be a direction rather than a single line: lights that are parallel to that direction may experience no birefringence. Local optic axis may refer to an optic axis within a predetermined region of a crystal.

FIG. 1B schematically illustrates a portions of a 3D orientational pattern of LC molecules 112 included in a birefringent medium layer 115 of the PVH 100. As shown in FIG. 1B, the birefringent medium layer 115 may have a first surface 115-1 and second surface 115-2 facing the first surface 115-1. FIG. 1E illustrates a 2D orientational pattern of LC molecules 112 located in close proximity to or at a surface (at least one of the first surface 115-1 or the second surface 115-2) of the birefringent medium layer 115. For illustrative purposes, the LC directors of the LC molecules 112 shown in FIG. 1E are presumed to be in the surface of the birefringent medium layer or in a plane parallel with the surface with substantially small tilt angles with respect to the surface. The LC directors located in close proximity to or at the surface (at least one of the first surface 115-1 or the second surface 115-2) of the birefringent medium layer 115 may rotate continuously in at least one in-plane direction (e.g., an x-axis direction). The orientations of the LC directors located in close proximity to or at the surface (at least one of the first surface 115-1 or the second surface 115-2) of the birefringent medium layer 115 may rotate continuously in at least one in-plane direction (e.g., an x-axis direction) to define a pattern with a varying or constant in-plane pitch. For example, FIG. 1E shows the LC directors may rotate continuously in a predetermined in-plane direction (e.g., an x-axis direction). For illustrative purposes, FIG. 1E shows the orientations of the LC directors (or local optic axis orientations) may vary continuously and periodically in the predetermined in-plane direction to define a periodic in-plane rotation pattern. In other words, the orientation of the optic axis of the birefringent medium layer 115 may vary in a periodic in-plane rotation pattern.

The orientation of an LC director of an LC molecule 112 refers to the 3D orientation, as shown in FIG. 1B, which may be characterized by an azimuthal angle θ and a tilt angle. The azimuthal angle θ is shown in FIG. 1E, which is an angle formed by the LC director and a predetermined direction (the +x-axis direction in this example) in a plane (e.g., the x-y plane) parallel to the surface of the birefringent medium layer. The tilt angle of the LC director refers to an angle formed by the LC director and the surface of the birefringent medium layer (or the plane parallel to the surface).

A periodicity of the periodic in-plane rotation pattern shown in FIG. 1E may be defined as a distance over which the LC directors rotate by 360°. An in-plane pitch Pᵢₙ may be defined as a distance along the in-plane direction over which the LC directors rotate by 180° (or the orientation of the LC directors change by 180°). That is, in the embodiment shown in FIG. 1E, the in-plane pitch Pᵢₙ is half of the periodicity of the in-plane rotation pattern of the LC directors. In some embodiments, the in-plane pitch Pᵢₙ may be referred to as a horizontal pitch of the PVH 100. In some embodiments, the in-plane pitch Pᵢₙ may be uniform (e.g., same) in the predetermined in-plane direction. The predetermined in-plane direction may be any suitable direction along the surface (or in the x-y plane parallel with the surface) of the birefringent medium layer 115. For illustrative purposes, FIG. 1E shows that the predetermined in-plane direction is the x-axis direction. Thus, the in-plane pitch Pᵢₙ may be the pitch Pₓ in the x-axis direction, as shown in FIGS. 1C-1E.

As shown in FIG. 1E, for the LC molecules 112 located in close proximity to or at a surface (e.g., 115-1 or 115-2) of the birefringent medium layer (e.g., 115), the orientations of the LC directors may be represented by in-plane orientations (in the x-y plane), as indicated by arrows 188, when the tilt angle of the LC molecules 112 is small or substantially zero degree. As shown in FIG. 1E, at the surface (e.g., 115-1 or 115-2) of the birefringent medium layer (e.g., 115), the directors of the LC molecules (e.g., 112) may continuously rotate in a predetermined rotation direction, e.g., a clockwise direction or a counter-clockwise direction along a predetermined in-plane direction (e.g., the +x-axis direction). The continuous rotation of the LC directors (or the continuous change of the orientations of the LC directors or the continuous change of the azimuthal angle of the LC molecules 112) may exhibit a periodic in-plane rotation pattern in the +x-axis direction, as shown in FIG. 1E. The periodicity of the periodic in-plane rotation pattern may be defined as a distance in the x-axis direction over which orientations of the LC directors change by 360°, and the in-plane pitch Pᵢₙ (which is Pₓ in this example) may be half of the periodicity, i.e., a distance over which the orientations of the LC directors change by 180°. The rotation of the LC directors of the LC molecules 112 at the surface of the birefringent medium layer 115 may cause other LC molecules 112 in the volume of the birefringent medium layer 115 (those not at the surface) also to rotate. The rotation of the LC molecules 112 within the birefringent medium layer 115 may exhibit a handedness, e.g., right handedness or left handedness. In some embodiments, the periodic in-plane rotation pattern of LC directors (or referred to as the periodic in-plane rotation pattern of the optic axis) of the birefringent medium layer 115 may be caused by an alignment pattern provided by a recording medium or an alignment structure.

Referring back to FIG. 1B, in a volume of the birefringent medium layer 115, the LC molecules 112 may be arranged in a plurality of helical structures 117 with a plurality of helical axes 118 and a helical pitch Pₕ along the helical axes. The azimuthal angles of the LC molecules 112 arranged along a single helical structure 117 may continuously vary around a helical axis 118 in a predetermined rotation direction, e.g., clockwise direction or counter-clockwise direction. In other words, the LC directors of the LC molecules 112 arranged along a single helical structure 117 may continuously rotate around the helical axis 118 in a predetermined rotation direction to continuously change the azimuthal angle. Accordingly, the helical structure 117 may exhibit a handedness, e.g., right handedness or left handedness. The helical pitch Pₕ may be defined as a distance along the helical axis 118 over which the LC directors rotate around the helical axis 118 by 360°, or the azimuthal angles of the LC molecules vary by 360°.

In the embodiment shown in FIG. 1B, the helical axes 118 may be substantially perpendicular to the first surface 115-1 and/or the second surface 115-2 of the birefringent medium layer 115. In other words, the helical axes 118 of the helical structures 117 may be in a thickness direction (e.g., a z-axis direction) of the birefringent medium layer 115. That is, the LC molecules 112 may have substantially small tilt angles (including zero degree tilt angles), and the LC directors of the LC molecules 112 may be substantially orthogonal to the helical axis 118. The birefringent medium layer 115 (or the PVH 100 including the birefringent medium layer 115) may have a vertical pitch Pᵥ, which may be defined as a distance along the thickness direction of the birefringent medium layer 115 over which the LC directors of the LC molecules 112 rotate around the helical axis 118 by 180° (or the azimuthal angles of the LC directors vary by 180°).

As shown in FIG. 1B, the LC molecules 112 from the plurality of helical structures 117 having a first same orientation (e.g., same tilt angle and azimuthal angle) may form a first series of slanted and parallel refractive index planes 114 periodically distributed within the volume of the birefringent medium layer 115. Although not labeled, LC molecules 112 with a second same orientation (e.g., same tilt angle and azimuthal angle) different from the first same orientation may form a second series of slanted and parallel refractive index planes periodically distributed within the volume of the birefringent medium layer 115. Different series of slanted and parallel refractive index planes may be formed by LC molecules 112 having different orientations. In the same series of parallel and periodically distributed, slanted refractive index planes 114, the LC molecules 112 may have the same orientation and the refractive index may be the same. Different series of slanted refractive index planes may correspond to different refractive indices. When the number of the slanted refractive index planes (or the thickness of the birefringent medium film) increases to a sufficient value, Bragg diffraction may be established according to the principles of volume gratings. Thus, the slanted and periodically distributed refractive index planes 114 may also be referred to as Bragg planes 114. Thus, within the birefringent medium layer 115, there exist different series of Bragg planes.

A distance (or a period) between adjacent Bragg planes 114 of the same series may be referred to as a Bragg period PB. The different series of Bragg planes formed within the volume of the birefringent medium layer 115 (or the volume of the PVH 100) may produce a varying refractive index profile that is periodically distributed in the volume of the birefringent medium layer 115. The birefringent medium layer 115 (or the PVH 100) may diffract an input light satisfying a Bragg condition through Bragg diffraction. A slant angle α of the PVH 100 including the birefringent medium layer 115 may be defined as α=90°−β, where β=arctan (Pᵥ/Pₓ). In some embodiments, the PVH 100 including the birefringent medium layer 115 shown in FIG. 1B with a tilt angle 0°<α<45°, may function as a transmissive PVH.

FIG. 1C illustrates a portion of a 3D orientational pattern of LC molecules 132 included in a birefringent medium layer 135, according to another embodiment of the present discourse. Similar to the LC molecules 112 located in close proximity to or at a surface (at least one of the first surface 115-1 or the second surface 115-2) of the birefringent medium layer 115 shown in FIG. 1B and FIG. 1E, the LC molecules 132 located in close proximity to or at a surface (at least one of a first surface 135-1 or a second surface 135-2) of the birefringent medium layer 135 may be configured with LC directors rotating continuously and periodically in a predetermined rotation direction (e.g., clockwise or counter-clockwise) along a predetermined in-plane direction (e.g., an x-axis direction) at the surface or in a plane parallel with the surface. That is, orientations of LC directors may vary continuously and periodically in the predetermined in-plane direction (e.g., an x-axis direction) along the surface or the plane parallel with the surface. The continuous rotation may have an in-plane rotation pattern with an in-plane pitch P. In some embodiments, the in-plane pitch Pₓ may be uniform (or same). The LC molecules may form a plurality of Bragg planes 134 similar to the Bragg planes 114 shown in FIG. 1B. FIG. 1E shows the periodic in-plane rotation pattern of LC directors of the LC molecules 132 located in close proximity to or at a surface (e.g., 135-1 or 135-2) of the birefringent medium layer 135.

In the embodiment shown in FIG. 1C, helical axes 138 of helical structures 137 may be tilted with respect to a first surface 135-1 and/or a second surface 135-2 of the birefringent medium layer 135 (or with respect to the thickness direction of the birefringent medium layer 135). For example, the helical axes 138 of the helical structures 137 may have an acute angle or obtuse angle with respect to the first surface 135-1 and/or the second surface 135-2 of the birefringent medium layer 135. In some embodiments, the LC directors of the LC molecule 132 may be substantially orthogonal to the helical axes 138 (i.e., the tilt angle may be substantially zero degree). In some embodiments, the LC directors of the LC molecule 132 may be tilted with respect to the helical axes 138 at an acute angle. The birefringent medium layer 135 (or the PVH 100 including the birefringent medium layer 135) may have a vertical periodicity (or pitch) Pᵥ. A slant angle α of the PVH 100 including the birefringent medium layer 135 may be defined as α=90°−β, where β=arctan (Pᵥ/Pₓ). In some embodiments, the PVH 100 including the birefringent medium layer 135 shown in FIG. 1C with a slant angle of 45°<α<90° may function as a reflective PVH.

FIG. 1D illustrates a portion of a schematic 3D orientational pattern of LC molecules 152 included in a birefringent medium layer 155, according to another embodiment of the present discourse. As shown in FIG. 1D, the birefringent medium layer 155 may include a first surface 155-1 and a second surface 155-2 facing the first surface 155-1. Similar to the LC molecules 112 located in close proximity to or at a surface of the birefringent medium layer 115 shown in FIG. 1B and FIG. 1E, the LC molecules 152 located in close proximity to or at a surface (at least one of the first surface 155-1 or the second surface 155-2) of the birefringent medium layer 155 may be configured with LC directors continuously rotating in a predetermined rotation direction (e.g., clockwise) along a predetermined in-plane direction (e.g., an x-axis direction) at the surface or in a plane parallel with the surface. The continuous rotation may exhibit a periodic in-plane rotation pattern with an in-plane pitch Pᵢₙ (which is Pₓ in this example) In some embodiments, the in-plane pitch Pᵢₙ may be uniform (e.g., same) or may vary in the predetermined in-plane direction (e.g., the x-axis direction). FIG. 1E also shows the periodic in-plane rotation pattern of the orientations of the LC directors of the LC molecules 152 located in close proximity to or at the surface (e.g., 155-1 or 155-2) of the birefringent medium layer 155.

Referring back to FIG. 1D, in the volume of the birefringent medium layer 155, the LC molecules 152 may be arranged in a plurality of series of slanted and periodic refractive index planes (or Bragg planes) 154, similar to the configuration shown in FIG. 1B. The birefringent medium layer 155 (or the PVH 100 including the birefringent medium layer 155) may also have a vertical periodicity (or pitch) Pᵥ in a thickness direction of the birefringent medium layer 155. A slant angle α of the PVH 100 including the birefringent medium layer 115 may be defined as α=90°−β, where β=arctan (Pᵥ/Pₓ). In some embodiments, the PVH 100 including the birefringent medium layer 155 shown in FIG. 1D with a slant angle of 0°<α<45° may function as a transmissive PVH.

The periodic in-plane rotation pattern of the directors of the LC molecules located in close proximity to or at a surface of the birefringent medium layer (or the periodic local optic axis orientations of the birefringent medium layer at a surface of the birefringent medium layer) shown in FIG. 1E is for illustrative purposes only, which is not intended to limit the scope of the present disclosure. Although not shown, the directors of the LC molecules located in close proximity to or at a surface of the birefringent medium layer (or the local optic axis orientations of the birefringent medium layer at a surface of the birefringent medium layer) may be configured to have an in-plane orientation pattern with a varying pitch in at least one in-plane direction, e.g., radial directions.

In some embodiments, PVHs fabricated based on the disclosed method may have a uniform diffraction efficiency. In some embodiments, PVHs fabricated based on the disclosed method may have a non-uniform diffraction efficiency (e.g., a one-dimensional (“1D”) or two-dimensional (“2D”) diffraction efficiency profile). In some applications, a PVH with a non-uniform diffraction efficiency may improve the optical performance of an optical assembly or system in which the PVH is implemented. The diffraction efficiency of a PVH may be affected by various parameters, such as the thickness, the birefringence, and/or the slant angle α of the PVH, etc. The birefringence and the slant angle α of the PVH may be related to the material properties of a birefringent medium forming the PVH. For example, the birefringence of the PVH may be related to the birefringence of the birefringent medium, and the slant angle α of the PVH may be related to a chirality of the birefringent medium. In some embodiments, the birefringent medium may include a host birefringent material and a chiral dopant doped into the host birefringent material at a predetermined concentration. The chirality may be introduced by the chiral dopant doped into the host birefringent material, e.g., chiral dopant doped into nematic LCs, or chiral reactive mesogens (“RMs”) doped into achiral RMs. RMs may be also referred to as a polymerizable mesogenic or liquid-crystalline compound, or polymerizable LCs. For simplicity, in the following description, the term “liquid crystal(s)” or “LC(s)” may encompass both mesogenic and LC materials. When the chirality of the birefringent medium is introduced by the chiral dopant doped into the host birefringent material, the slant angle α of the PVH may be determined by a helical twist power (“HTP”) of the chiral dopant and the concentration of the chiral dopant doped into the host birefringent material. In some embodiments, the birefringent medium may include a birefringent material having an intrinsic molecular chirality, and no chiral dopant may be needed. The chirality of the birefringent medium may result from the intrinsic molecular chirality of the birefringent material. For example, the birefringent material may include chiral liquid crystal molecules, or molecules having one or more chiral functional groups. In some embodiments, the birefringent material may include twist-bend nematic LCs (or LCs in twist-bend nematic phase), in which LC directors may exhibit periodic twist and bend deformations forming a conical helix with doubly degenerate domains having opposite handednesses. The LC directors of twist-bend nematic LCs may be tilted with respect to the helical axis. Thus, the twist-bend nematic phase may be considered as the generalized case of the conventional nematic phase in which the LC directors are orthogonal with respect to the helical axis. When the chirality of the birefringent medium results from the intrinsic molecular chirality of the birefringent material included in the birefringent medium, the slant angle α of the PVH may be determined by twist parameters (e.g., a twist constant) of the birefringent material.

For discussion purposes, when a birefringent medium including a birefringent material with a chirality (e.g., an introduced chirality or an intrinsic chirality) is used to form a PVH, the birefringence and the chirality of the birefringent medium may be considered to be substantially the same as the birefringence and the chirality of the birefringent material included in the birefringent medium, respectively. In the disclosed embodiments, when two birefringent media having a substantially same birefringence are used to form two PVHs respectively, the birefringence of the two PVHs may be substantially the same. When two birefringent media having different birefringences are used to form two PVHs respectively, the birefringences of the two PVHs may be different. When two birefringent media having a substantially same chirality are used to form two PVHs respectively, provided that the in-plane pitches of the two PVHs are substantially the same, the slant angles of the two PVHs may be substantially the same. When two birefringent media having different chiralities are used to form two PVHs respectively, provided that the in-plane pitches of the two PVHs are substantially the same, the slant angles of the two PVHs may be different. When two birefringent media having different birefringences and different chiralities are used to form two PVHs respectively, the birefringences of the two PVHs may be different, and provided that the in-plane pitches of the two PVHs are substantially the same, the slant angles of the two PVHs may be different.

In some embodiments, when two birefringent media have a substantially same birefringence, the two birefringent media may be the same birefringent medium or different birefringent media. In some embodiments, when two birefringent media have a substantially same chirality, the two birefringent media may include chiral dopants of a substantially same helical twist power (“HTP”) with a substantially same doping concentration, or chiral dopants of different helical twist powers (“HTPs”) with different doping concentrations, or birefringent materials with a substantially same intrinsic chirality. In some embodiments, when two birefringent media have different chiralities, the two birefringent media may include chiral dopants of a substantially same HTP with different doping concentrations, or chiral dopants of different HTPs with a same doping concentration or different doping concentrations, or birefringent materials with different intrinsic chiralities.

The present disclosure provides fabrication methods of a PVH with a non-uniform diffraction efficiency (e.g., a 1D or 2D non-uniform diffraction efficiency profile) through introducing one or more of a thickness variation, a slant angle variation, or a birefringence variation in one or more dimensions (or directions), e.g., within a plane perpendicular to a thickness direction of the PVH. The PVH may be a reflective PVH or a transmissive PVH. In some embodiments, the fabrication method may include dispensing a composition on an alignment structure to form a birefringent medium layer having a thickness variation in the one or more dimensions, e.g., within the plane perpendicular to the thickness direction of the birefringent medium layer. The fabrication method may also include polymerizing the birefringent medium layer to form a PVH having a thickness variation in the one or more dimensions, e.g., within the plane perpendicular to the thickness direction of the PVH. In some embodiments, the composition may be a birefringent medium that includes a birefringent material having a chirality. In some embodiments, the composition may include other ingredients, such as monomers, initiators (e.g., photo- or thermo-initiators), etc. In some embodiments, the alignment structure may be configured to provide a spatially varying alignment pattern, e.g., a linearly periodic alignment pattern with a uniform period.

In some embodiments, the fabrication method may include printing, using an inkjet printer, a layer of the composition on the alignment structure to form the birefringent medium layer. In some embodiments, the fabrication method may include controlling volumes of droplets of the composition that are dispensed (e.g., printed) at predetermined locations (or positions, portions) of the alignment structure, to form the birefringent medium layer having a predetermined thickness variation in the one or more dimensions, e.g., within the plane perpendicular to the thickness direction of the birefringent medium layer. Volumes of the droplets of the composition dispensed at at least two locations may be different. The different volumes of the droplets may be determined based on a predetermined thickness variation profile. That is, each location of the alignment structure may correspond to a predetermined volume. The thickness variation profile may be a 1D linear profile, a 1D non-linear profile, a 2D linear profile, or a 2D non-linear profile. After polymerizing the birefringent medium layer, a PVH having the predetermined thickness variation in the one or more dimensions, e.g., within the plane perpendicular to the thickness direction of the PVH may be obtained.

In some embodiments, the fabrication method may include dispensing a first composition on an alignment structure to form a first layer. In some embodiments, the first layer may form a first birefringent medium layer. In some embodiments, the first composition may include a first birefringent medium or material. The method may include dispensing a second composition on the first layer to form a second layer. In some embodiments, the second layer may form a second birefringent medium layer. In some embodiments, the second composition may include a second birefringent medium or material. The method may include heating the first and second layers to mix the first composition and the second composition together to form a third layer. The third layer may be a third birefringent medium layer. The method may include polymerizing the third layer. In some embodiments, the polymerized third layer may be a PVH. In some embodiments, at least one (e.g., each) of the first layer or the second layer may be configured to have a thickness variation in one or more dimensions, e.g., within a plane perpendicular to a thickness direction of the first layer or the second layer, respectively. In other words, at least one of the first layer or the second layer may include a 1D or 2D thickness variation profile. When polymerized, the polymerized third layer may have a uniform thickness or a thickness variation in one or more dimensions, e.g., within a plane perpendicular to a thickness direction of the polymerized third layer. That is, the polymerized third layer may have a 1D or 2D thickness variation profile or a uniform thickness profile. For example, the PVH fabricated with the disclosed method may include a thickness variation in one or more dimensions, e.g., within a plane perpendicular to a thickness direction of the PVH, i.e., a 1D or 2D thickness variation profile.

In some embodiments, the fabrication method may include dispensing (e.g., printing), using an inkjet printer, the first composition (e.g., a first birefringent medium) on the alignment structure to form the first layer (e.g., first birefringent medium layer). The first layer may have different thicknesses at different locations of the alignment structure. To dispense the first composition with different thicknesses, volumes of the droplets of the first composition dispensed at the different locations may be controlled by controlling a flow control device provided at or coupled with a printhead of the inkjet printer. In some embodiments, the fabrication method may include applying different driving voltage waveforms to the flow control device at the printhead (or to a plurality of flow control devices at a plurality of printheads) of the inkjet printer to dispense (e.g., eject) droplets of the first composition with different predetermined volumes at the predetermined locations of the alignment structure. The volumes at at least two locations may be different. The different driving voltage waveforms may correspond to different volumes of the droplets. In some embodiments, the fabrication method may include dispensing (e.g., printing), using the inkjet printer, the second composition on the first layer to form the second layer. The second layer may have different thicknesses at different locations of the first layer (corresponding to the locations of the alignment structure). In some embodiments, to achieve different thicknesses, different driving voltage waveforms may be applied to the flow control device(s) at the printhead(s) to dispense droplets of the second composition with predetermined volumes at the predetermined locations of the first layer. The volumes of the droplets of the second composition dispensed at at least two different locations may be different. In some embodiments, through controlling a volume of the droplet of the first composition and a volume of the droplet of the second composition dispensed (e.g., printed) at different predetermined locations, a total volume of the third layer at different predetermined locations may be controlled. Thus, a thickness variation of the third layer may be controlled. Different volumes of the first composition and the second composition may be configured for different predetermined locations based on a desirable thickness variation profile of the PVH. In some embodiments, through controlling a volume of the droplet of the first composition and a volume of the droplet of the second composition dispensed (e.g., printed) at a same predetermined location, a ratio between the amount (volume) of the first composition and the amount (volume) of the second composition dispensed at the same predetermined location may be controlled at any suitable ratio or any suitable predetermined ratio range. Different ratios between the amounts of the first composition and the second composition may be configured for different predetermined locations based on a desirable slant angle variation profile and/or a desirable birefringence variation profile of the PVH.

In some embodiments, each of the first composition and the second composition may include a birefringent material having a chirality (e.g., an introduced chirality or an intrinsic chirality). In some embodiments, the first composition and the second composition may have different birefringences and a substantially same chirality. In some embodiments, the first composition and the second composition may have a substantially same birefringence and different chiralities. In some embodiments, the first composition and the second composition may have different birefringences and different chiralities. Thus, after heating the first and second layers to mix the first composition and the second composition to form the third layer, the third layer may have at least one of a predetermined thickness variation, a predetermined slant angle variation, or a predetermined birefringence variation in one or more dimensions, e.g., within a plane perpendicular to the thickness direction of the third layer. After polymerizing the third layer, a PVH having at least one of a predetermined thickness variation, a predetermined slant angle variation, or a predetermined birefringence variation in one or more dimensions, e.g., within a plane perpendicular to the thickness direction of the PVH may be obtained. Accordingly, a PVH with a non-uniform diffraction efficiency (e.g., a predetermined 1D or 2D non-uniform diffraction efficiency profile) may be obtained.

The disclosed fabrication methods may allow for flexible control of the thickness variation, the slant angle variation, and/or the birefringence variation in the one or more dimensions, e.g., within the plane perpendicular to the thickness direction of a PVH, via controlling the volumes of the first composition and the second composition dispensed at predetermined locations. The disclosed fabrication methods may provide cost-effective and contactless solutions to fabricate a PVH with a predetermined 1D or 2D non-uniform diffraction efficiency profile, which may be a high performance PVH that can be implemented in numerous applications in a variety of technical fields.

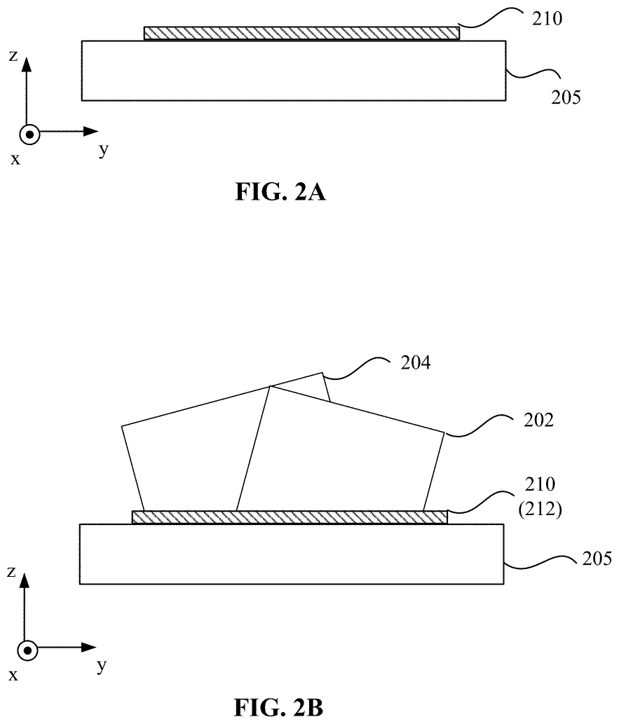

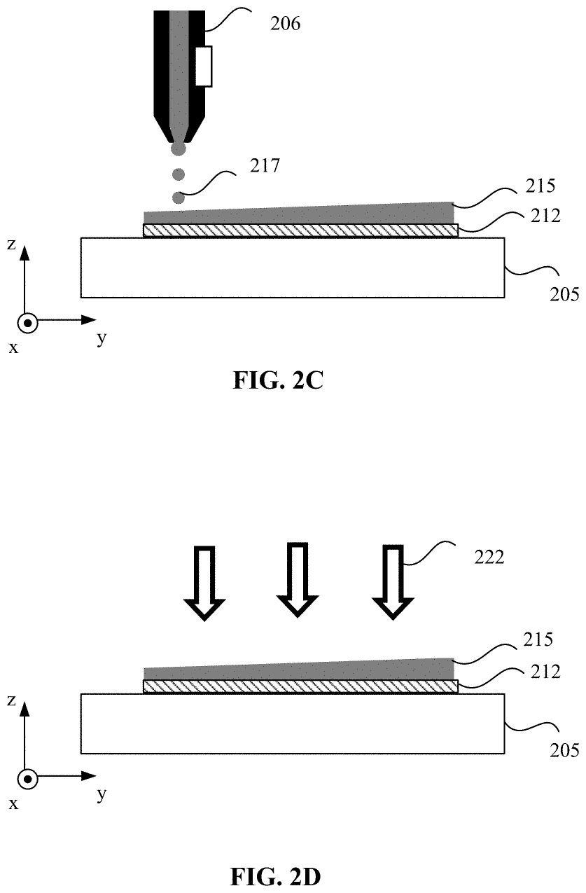

FIGS. 2A-2D schematically illustrate processes for fabricating a PVH with a thickness variation, according to an embodiment of the present disclosure. For illustrative purposes, the substrate and different layers (or films, structures) formed thereon are shown as having flat surfaces. In some embodiments, the substrate and different layers (or films, structures) may have curved surfaces. As shown in FIG. 2A, an alignment material may be dispensed, e.g., spin-coated or deposited, on a surface (e.g., a top surface) of a substrate 205 to form an alignment material layer 210. The substrate 205 may provide support and protection to various layers, films, and/or structures formed thereon. In some embodiments, the substrate 205 may be at least partially transparent at least in the visible wavelength band (e.g., about 380 nm to about 700 nm). In some embodiments, the substrate 205 may be at least partially transparent in at least a portion of the infrared (“IR”) band (e.g., about 700 nm to about 1 mm). The substrate 205 may include a suitable material that is at least partially transparent to lights of the above-listed wavelength ranges, such as, a glass, a plastic, a sapphire, or a combination thereof, etc. The substrate 205 may be rigid, semi-rigid, flexible, or semi-flexible. In some embodiments, the substrate 205 may be a part of another optical element or device (e.g., another opto-electrical element or device). For example, the substrate 205 may be a solid optical lens or a part of a solid optical lens. In some embodiments, the substrate 205 may be a part of a functional device, such as a display screen. In some embodiments, the substrate 205 may be used to fabricate, store, or transport the fabricated PVH. In some embodiments, the substrate 205 may be detachable or removable from the fabricated PVH after the PVH is fabricated or transported to another place or device. That is, the substrate 205 may be used in fabrication, transportation, and/or storage to support the PVH provided on the substrate 205, and may be separated or removed from the PVH when the fabrication of the PVH is completed, or when the PVH is to be implemented in an optical device. In some embodiments, the substrate 205 may not be separated from the PVH.

The alignment material layer 210 formed on the top surface of the substrate 205 may be processed (e.g., cured, dried, rubbed, and/or subjected to a light irradiation, etc.) to form an alignment structure 212 configured to provide a predetermined in-plane alignment pattern. In some embodiments, the predetermined in-plane alignment pattern may be a spatially varying alignment pattern, e.g., a periodic alignment pattern with a uniform period. The alignment structure 212 may be any suitable alignment structure, such as a rubbed polyimide layer, an aligned photo-alignment material (“PAM”) layer, a plurality of nano- or micro-structures, an alignment network, or a combination thereof. For discussion purposes, a photo-alignment material (“PAM”) is used as an example of the alignment material of the alignment material layer 210. Thus, the alignment material layer 210 may also be referred to as a PAM layer 210 for discussion purposes.

In some embodiments, the PAM layer 210 may have a thickness of about 10 nanometers. In some embodiments, the PAM may include photosensitive molecules that may undergo orientational ordering when subjected to a polarized light irradiation. The PAM layer 210 may be exposed to a spatially varying polarized light irradiation. As a result, the photosensitive molecules may be aligned according to local polarization directions. The spatially varying polarized light irradiation may be generated by, e.g., a polarization interference, or a laser directing, etc. In some embodiments, as shown in FIG. 2B, the PAM layer 210 may be exposed to a polarization interference formed by two circularly polarized lights 202 and 204 having opposite handednesses. The two circularly polarized lights 202 and 204 may be two coherent lights. The two circularly polarized lights 202 and 204 may be ultraviolet (“UV”), violet, or blue lights having wavelengths within an absorption band of the PAM. After being subjected to a sufficient exposure of the polarization interference formed by the circularly polarized lights 202 and 204, the photosensitive molecules in the PAM layer 210 may be aligned according to local polarization directions of the polarization interference. In some embodiments, both of the two circularly polarized lights 202 and 204 may be collimated lights. In some embodiments, one of the two circularly polarized lights 202 and 204 may be a collimated light and the other may be a diverging or converging light. The exposed PAM layer 210 may be configured to provide a spatially varying alignment pattern with a constant or varying pitch. In some embodiments, when both of the two circularly polarized lights 202 and 204 are collimated lights the exposed PAM layer 210 may be configured to provide a spatially varying alignment pattern that is a periodic alignment pattern with a uniform period (or pitch). In some embodiments, the period (or pitch) of the periodic alignment pattern may be determined by an angle between the circularly polarized lights 202 and 204.

After the alignment material layer 210 is processed to form the alignment structure 212, as shown in FIG. 2C, a first composition (e.g., a first birefringent medium) 217 may be dispensed on the alignment structure 212 to form a first layer (e.g., a first birefringent medium layer) 215 having a thickness variation in one or more dimensions, e.g., within a plane perpendicular to a thickness direction of the first layer (e.g., the first birefringent medium layer) 215. For example, the plane may be the x-y plane shown in FIG. 2C. The thickness direction may be the z-axis direction. For discussion purpose, the first layer 215 is also referred to as a first birefringent medium layer 215. In some embodiments, the first composition 217 may be an LC precursor including polymerizable LCs, such as reactive mesogens (“RMs”). For example, the first composition 217 may include a mixture of achiral RMs (as nematic LC host), chiral RMs with a photopolymerizable methacrylate group, and photo-initiators, where the mixture may be dissolved in a solvent, e.g., toluene. In some embodiments, the first composition 217 may include a mixture of nematic LCs, mono-functional chiral monomers, multi-functional monomers, and photo-initiators, where the mixture may be dissolved in a solvent, e.g., toluene. The alignment structure 212 may be configured to at least partially align the LC molecules of the first composition 217 included in the first birefringent medium layer 215 in the spatially varying alignment pattern, e.g., the periodic alignment pattern. For example, the LC molecules located in close proximity to (including those at) an interface between the first birefringent medium layer 215 and the alignment structure 212 may be aligned by the alignment structure 212, such that LC directors may rotate continuously in a predetermined direction. For example, orientations of the LC directors may vary continuously and periodically in the predetermined direction. The LC directors of LC molecules within the volume of the first birefringent medium layer 215 that are disposed over the LC molecules located in close proximity to or at the interface between the first birefringent medium layer 215 and the alignment structure 212 may twist in a helical fashion along a direction of the helical axes.

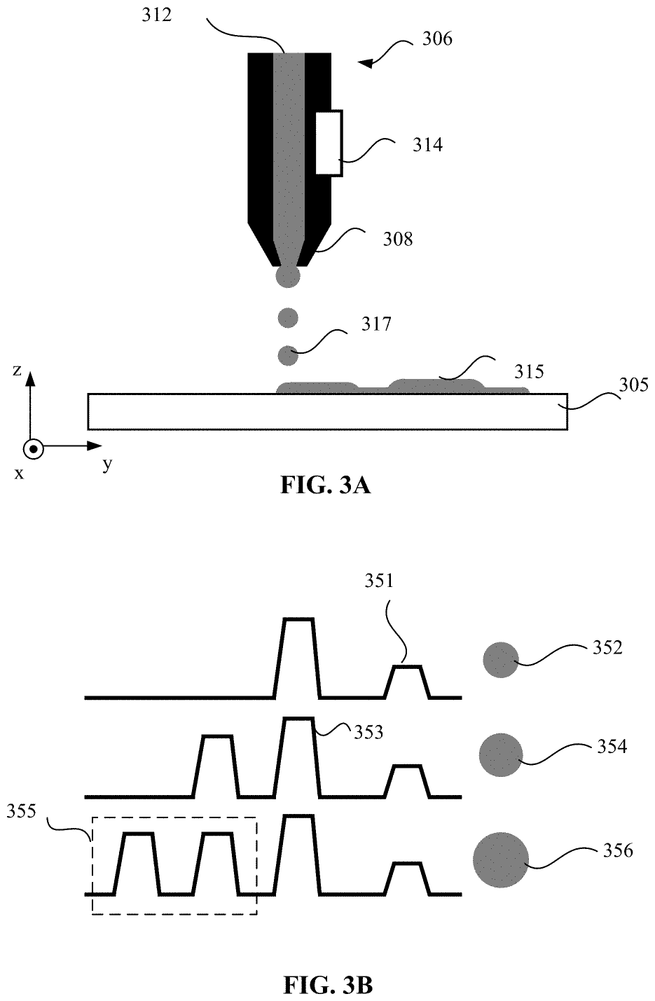

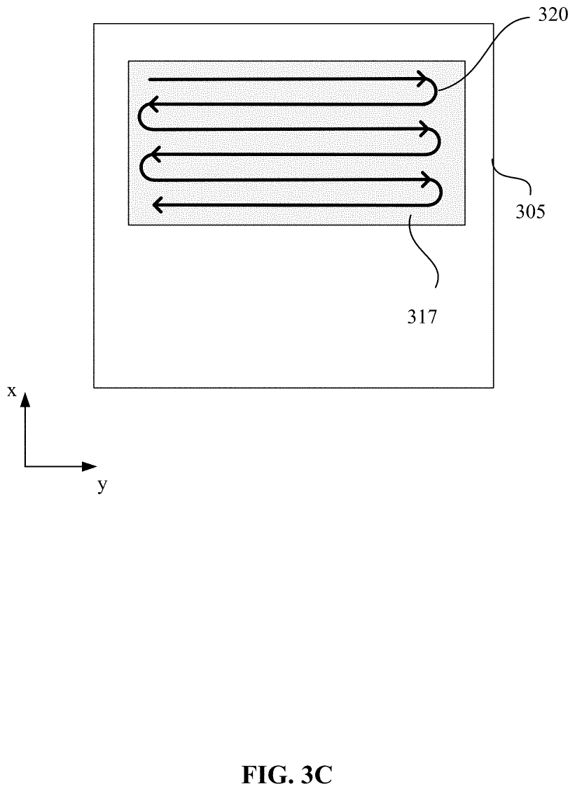

The first birefringent medium layer 215 having a thickness variation in one or more dimensions, e.g., within a plane perpendicular to the thickness direction of the birefringent medium layer 215 may be formed on the alignment structure 212 using any suitable methods. In some embodiments, as shown in FIG. 2C, an inkjet printer (FIG. 2C merely shows a printhead 206 of the inkjet printer, which may include more than one printhead and other parts known in the art) may dispense (e.g., print) the first composition 217 on the alignment material layer 210 to form the first birefringent medium layer 215. The first birefringent medium layer 215 may have a thickness variation in one or more dimensions, e.g., within a plane perpendicular to the thickness direction of the first birefringent medium layer 215. The details of inkjet printing the first birefringent medium layer 215 with a thickness variation on the alignment structure will be discussed in connection with FIGS. 3A and 3B.

After the first birefringent medium layer 215 with a thickness variation is formed on the alignment structure 212, the first birefringent medium layer 215 may be polymerized, e.g., thermally polymerized, or photo-polymerized, etc. In some embodiments, as shown in FIG. 2D, the first birefringent medium layer 215 may be irradiated with, e.g., a UV light 222. Under a sufficient UV light irradiation, the first birefringent medium layer 215 may be polymerized to stabilize the 3D orientation pattern of the LC molecules. In some embodiments, the polymerized first birefringent medium layer 215 may form a PVH having a thickness variation in one or more dimensions, e.g., within a plane perpendicular to the thickness direction of the PVH.

Referring to FIGS. 2A-2D, in some embodiments, the substrate 205 may include, as an integral part, the alignment structure 212 configured to align LC molecules included in the first composition 217 in a spatially varying alignment pattern, after the first composition 217 is dispensed onto the alignment structure 212. That is, the alignment structure 212 may be integrally formed with the substrate 205. In some embodiments, the alignment structure 212 and/or the substrate 205 may be detachable or removable from the rest of the PVH after the rest of the PVH is fabricated or transported to another place or device. That is, the alignment structure 212 and/or the substrate 205 may be used in fabrication, transportation, and/or storage to support the films provided on the substrate 205, and may be separated or removed from the PVH when the fabrication of the PVH is completed, or when the PVH is to be implemented in an optical device. Thus, the final product of the PVH may not include the alignment structure 212 and/or the substrate 205. In some embodiments, the substrate 205 including the alignment structure 212 separately formed on the substrate 205 or integrally formed with the substrate 205 may be directly provided, and the processes shown in FIGS. 2A and 2B may be omitted.

The thickness variation may be a one-dimensional (“1D”) variation. For example, the thickness of the first birefringent medium layer 215 may vary in the y-axis direction, as shown in FIG. 2D. In some embodiments, the thickness may vary in the x-axis direction, or in any other direction in the x-y plane. In some embodiments, the thickness variation may be a two-dimensional (“2D”) variation. For example, the thickness may vary in both the x-axis and y-axis directions, or may vary in radial or circumferential directions. In some embodiments, the one-dimensional or two-dimensional thickness variation may be linear, e.g., gradually increasing or decreasing. In some embodiments, the one-dimensional or two-dimensional thickness variation may be non-linear (e.g., a parabolic shape, a wavy shape, a Gaussian shape, etc.). In some embodiments, the 1D or 2D thickness variation may have a random or irregular profile.

FIG. 3A is a schematic diagram illustrating inkjet printing of an LC precursor 317 on a surface of a substrate 305 to form a birefringent medium layer 315 with a thickness variation in one or more dimensions, e.g., within a plane perpendicular to the thickness direction of the birefringent medium layer 315, according to an embodiment of the present discourse. An alignment structure that may be separately formed on the substrate 305 or integrally formed with the substrate 305 is not shown in FIG. 3A. Any suitable inkjet printer may be used to print the LC precursor 317 on the substrate 305 to form the birefringent medium layer 315. For example, an inkjet printer may include a carriage (not shown) configured to support one or more printheads (for illustrative purposes, a printhead 306 is shown) over the substrate 305 placed on a stage (not shown) during printing. The relative position of the printhead 306 relative to the substrate 305 by moving at least one of the carriage or the stage. The movement of the carriage and/or the stage may be linear, one dimensional, two dimensional, circular, spiral, or in any other pattern. In some embodiments, the carriage may be movable in one or more linear paths (e.g., the x-axis direction and/or the y-axis direction) and the stage may be stationary. In some embodiments, the carriage may be movable in a curved path (e.g., in a circumferential direction, a spiral direction, etc.). In some embodiments, the carriage may be stationary, and the stage may be movable in one or more linear paths or a curved path. In some embodiments, the stage may be 2D-translational (e.g., movable in the x-axis and y-axis directions) and/or rotational (e.g., rotatable).

In some embodiments, the printhead 306 may include a nozzle 308 with an ink outlet, an ink supply channel 312 through which a body of ink is supplied to the nozzle 308, and a flow control device 314. The flow control device 314 may be configured to dispense a predetermined volume of ink droplets of a composition 317 (e.g., a birefringent medium or material, such as an LC precursor) onto the substrate 305. That is, the amount of ink (e.g., a birefringent medium composition) dispensed at each location on the substrate 305 may be controlled by the flow control device 314. In some embodiments, the flow control device 314 may include a piezoelectric actuator or any other suitable flow control actuators. In some embodiments, the inkjet printer may include a controller (not shown) configured to control the movement of the stage and the carriage, thereby controlling the relative positions of the printhead 306 with respect to the substrate 305. In some embodiments, the controller may also control a driving voltage supplied to the flow control device 314 for driving the flow control device 314. For example, the controller may control a waveform of the driving voltage (also referred to as a driving voltage waveform) supplied to the flow control device 314 to control the volume of the droplet (or the size of the droplet). In some embodiments, the inkjet printer may include an ink cartridge for storing the ink (e.g., a birefringent medium composition).

The inkjet printer may be configured to print lines, dots, and/or any other suitable patterns. In some embodiments, the inkjet printer may be communicatively coupled to a computer. The computer may control the printing operations of the inkjet printer and may receive data from the inkjet printer. In some embodiments, the computer may receive input from a user, and may transmit a programmed moving or printing path to the controller at the inkjet printer for controlling the movement of the stage or the carriage. In some embodiments, the computer may receive input from the user regarding the waveform for controlling the amount of ink dispensed at each location on the substrate, and may transmit the waveform to the controller at the inkjet printer for controlling the flow control device 314. In some embodiments, the controller may be a part of the computer or may be a part of the inkjet printer.

FIG. 3B shows a plurality of example driving voltage waveforms and the corresponding sizes of the droplets. As shown in FIG. 3B, different driving voltage waveforms may correspond to different sizes (or volumes) of the droplets. To form a birefringent medium layer having a thickness variation at different locations, droplets of different volumes may be dispensed at different locations of the substrate 305. At least one of a duration or a magnitude of the waveform may be configured to achieve different sizes. For example, in some embodiments, both a duration and a magnitude of the driving voltage waveform may be configured to control the volumes of the droplets of the composition 317 (which may be an LC precursor). Thus, the volumes of the droplets dispensed from the printhead 306 may be modulated by controlling the duration and/or the magnitude of the driving voltage waveform. For example, as shown in FIG. 3B, when driven by a voltage having a waveform 351, the printhead 306 may dispense a droplet 352 having a first size. When driven by a voltage having a waveform 353, the printhead 306 may dispense a droplet 354 having a second size, which may be larger than the first size. When driven by a voltage having a waveform 355, the printhead 306 may dispense a droplet 356 having a third size, which may be larger than the second size. The driving voltage waveforms 351, 353, and 356 may be different from one another, and the printhead 306 may dispense droplets 352, 354, and 356 of different volumes or sizes. For example, each of the driving voltage waveforms 351 and 353 may include one pulse with a same pulse width. The magnitude of the driving voltage waveform 353 may be larger than the magnitude of the driving voltage waveform 351. As a result, the volume (or size) of the LC droplet 354 may be larger than the volume (or size) of the LC droplet 352. The driving voltage waveform 355 may include two pulses having a pulse width that is the same as the pulse width of the pulse included in the driving voltage waveform 353. Although the magnitude of the driving voltage waveform 355 may be lower than the magnitude of the driving voltage waveform 353, the volume (or size) of the LC droplet 356 may be larger than the volume (or size) of the LC droplet 354. The relationship between the duration and/or the magnitude of the driving voltage waveform and the volume of the LC droplet shown in FIG. 3B is for illustrative purposes. Other relationship between the duration and the magnitude of the driving waveform and the volume of the droplet may also be used.

FIG. 3C illustrates a printing path 320 that may be implemented when printing the birefringent medium layer 315, according to an embodiment of the present disclosure. The printing path 320 may be created by the relative movement between the printhead 306 and the substrate 305. In some embodiments, the printing path 320 may be a moving path of the printhead 306, or a moving path of the stage on which the substrate 305 rests. As shown in FIG. 3C, the composition 317 (which may be an LC precursor) may be printed in a predetermined direction along the printing path 320. Referring to FIGS. 3A-3C, through controlling the duration and/or the magnitude of the driving voltage waveform applied to the flow control device 314, droplets of the composition with predetermined volumes may be dispensed from the printhead 306 at predetermined locations of the substrate 305 while printing along the printing path 320. As a result, local thicknesses t(x, y) of the birefringent medium layer 315 may be controlled to have a predetermined thickness variation profile, which may be 1D or 2D. After the printing along the printing path 320 is completed, the birefringent medium layer 315 with a predetermined 1D or 2D thickness variation profile may be obtained. Referring to FIGS. 3A-3C, in some embodiments, the printhead 306 may be heated (e.g., through a heating device, which is not shown in FIGS. 3A-3C) to a temperature that is close to a nematic-to-isotropic transition point of the composition 317 (e.g., the LC precursor), to provide a desirable viscosity suitable for printing.

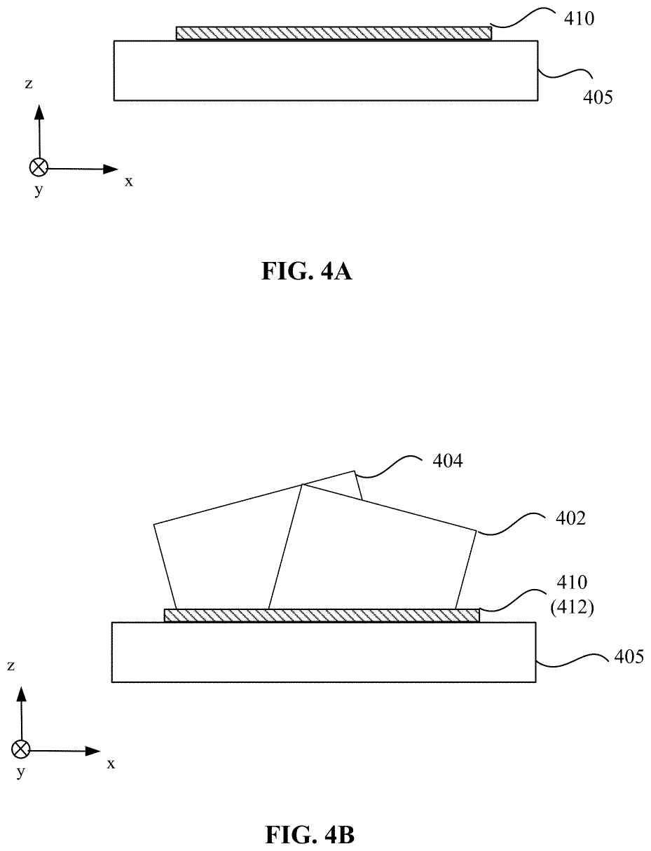

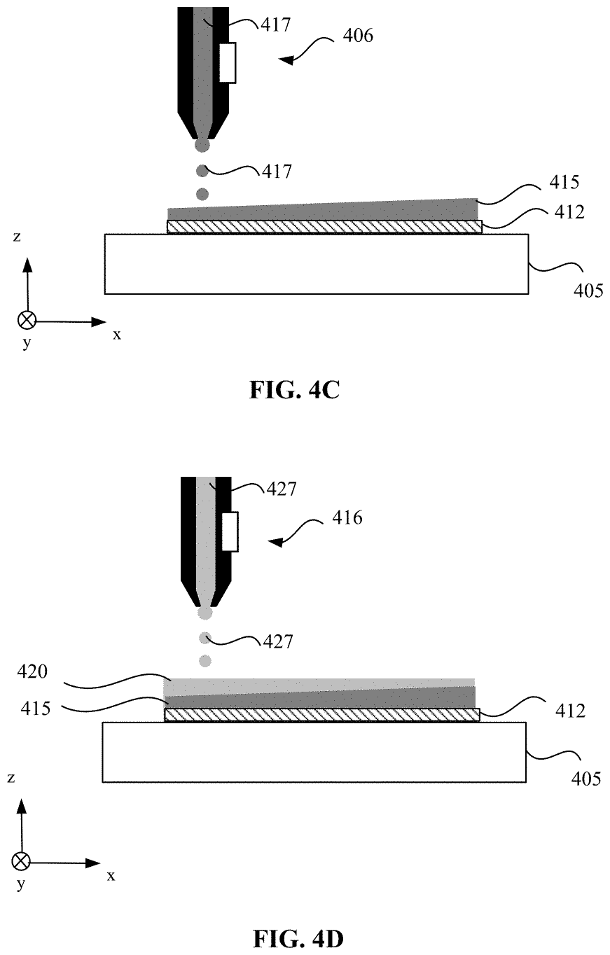

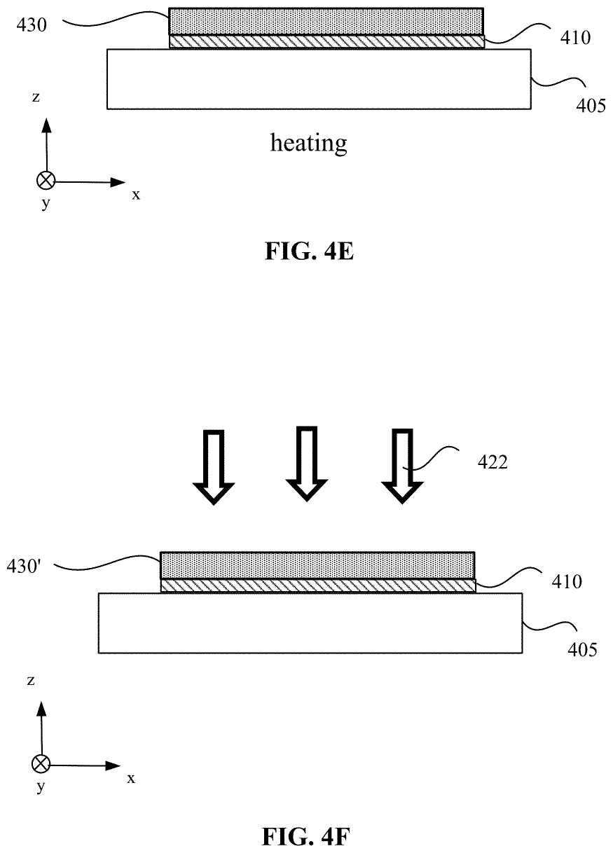

FIGS. 4A-4F illustrate schematic diagrams showing processes for fabricating a PVH, according to an embodiment of the present disclosure. The PVH may be configured to have at least one (e.g., two or more) of a thickness variation, a slant angle variation, or a birefringence variation in one or more dimensions, e.g., within a plane perpendicular to the thickness direction of the PVH. The fabrication processes shown in FIGS. 4A-4F may include steps or processes similar to those shown in FIGS. 2A-2D. The PVH fabricated based on the processes shown in FIGS. 4A-4D may include elements similar to those included in the PVH fabricated based on the processes shown in FIGS. 2A-2D. Descriptions of the similar steps and similar elements can refer to the descriptions rendered above in connection with FIGS. 2A-2F. Although the substrate and films or layers are shown as having flat surfaces, in some embodiments, the substrate and films or layers formed thereon may have curved surfaces.

The fabrication processes shown in FIGS. 4A-4C may be similar to the fabrication processes shown in FIGS. 2A-2C, and descriptions of the similar steps and similar elements can refer to the descriptions rendered above in connection with FIGS. 2A-2C. As shown in FIGS. 4A and 4B, an alignment material layer 410 may be formed on a substrate 405, and processed (e.g., exposed to a polarization interference formed by two coherent circularly polarized lights 402 and 404 having opposite handednesses) to obtain an alignment structure 412. The alignment structure 412 may be configured to provide a spatially varying alignment pattern, e.g., a periodic alignment pattern. In some embodiments, the alignment structure 412 may be pre-formed on the substrate 405, and the substrate 405 with the alignment structure 412 may be provided directly. Thus, the process of forming the alignment structure 412 may be omitted in some embodiments. After the alignment structure 412 is formed or provided, as shown in FIG. 4C, a first composition (e.g., LC precursor) 417 may be dispensed on the alignment structure 412 to form a first layer 415. In some embodiments, the first layer 415 of the first composition 417 may form a first birefringent medium layer 415. In some embodiments, as shown in FIG. 4C, a first printhead 406 of the inkjet printer may print the first composition 417 at predetermined locations (or portions) of the alignment structure 412 to form the first birefringent medium layer 415. Although one first printhead 406 is shown in FIG. 4C for illustrative purposes, the inkjet printer may include a plurality of first printheads 406 for dispensing the first composition 417 at different locations of the alignment structure 412 simultaneously or sequentially.

After the first birefringent medium layer 415 is formed on the alignment structure 412, as shown in FIG. 4D, a second composition (e.g., LC precursor) 427 may be dispensed by a second printhead 416 at predetermined locations (or portions) of the first birefringent medium layer 415 to form a second layer 420. In some embodiments, the second layer 420 may be a second birefringent medium layer 420. In some embodiments, the predetermined locations of the first birefringent medium layer 415 may correspond to the predetermined locations of the alignment structure 412. In some embodiments, the predetermined locations of the first birefringent medium layer 415 may partially overlap with the corresponding predetermined locations of the alignment structure 412. Although one second printhead 416 is shown in FIG. 4D for illustrative purposes, the inkjet printer may include a plurality of second printheads 416 configured to dispense the second composition 427 at different locations of the alignment structure 412 simultaneously or sequentially. In the following descriptions, LC precursors may be used as examples of the first composition 417 and the second composition 427. Hence, the first composition 417 may be referred to as the first LC precursor 417, and the second composition 427 may be referred to as the second LC precursor 427.

At least one of the first birefringent medium layer 415 and the second birefringent medium layer 420 may be configured to have a thickness variation in one or more dimensions, e.g., within a plane perpendicular to a thickness direction of the corresponding birefringent medium layer. In some embodiments, as shown in FIGS. 4C and 4D, each of the first birefringent medium layer 415 and the second birefringent medium layer 420 may have a thickness variation in one or more dimensions, e.g., within a plane perpendicular to the thickness direction of the respective birefringent medium layer. The fabrication process of printing a birefringent medium layer having a thickness variation in one or more dimensions, e.g., within a plane perpendicular to the thickness direction of the birefringent medium layer may be similar to the process described above in connection with FIGS. 3A-3C. The one or more dimensions in which the thickness varies in the first birefringent medium layer 415 and the second birefringent medium layer 420 may be the same or may be different in different layers. For example, in the first birefringent medium layer 415 the thickness may increase in the positive x-axis direction, and in the second birefringent medium layer 420 the thickness may increase in the negative x-axis direction. In some embodiments, the thickness may increase in the same direction (e.g., both increase in the +x-axis direction or in the −x-axis direction) in the first birefringent medium layer 415 and the second birefringent medium layer 420.

After the second birefringent medium layer 420 is formed, as shown in FIG. 4E, the first birefringent medium layer 415 and the second birefringent medium layer 420 may be heated to mix together the first composition 417 (or the first birefringent medium layer 415) and the second composition 427 (or the second birefringent medium layer 420) to form a third birefringent medium layer 430. In some embodiments, the first birefringent medium layer 415 and the second birefringent medium layer 420 may be heated to a temperature at which a mixture of the first LC precursor 417 and the second LC precursor 427 may be at an LC phase, an isotropic phase, or at a transition from the LC phase to the isotropic phase. The third birefringent medium layer 430 may have at least one (e.g., two or more) of a thickness variation, a birefringence variation, or a slant angle variation in one or more dimensions, e.g., within a plane perpendicular to the thickness direction of the third birefringent medium layer 430. After the third birefringent medium layer 430 is cooled to a predetermined temperature, e.g., a room temperature, the third birefringent medium layer 430 may be polymerized to form a polymerized third birefringent medium layer 430′. In some embodiments, the polymerized third birefringent medium layer 430′ may be referred to as a PVH. The polymerized third birefringent medium layer 430′ (e.g., the PVH) may have at least one (e.g., two or more) of a thickness variation, a birefringence variation, or a slant angle variation in one or more dimensions, e.g., within a plane perpendicular to the thickness direction of the PVH, similar to the third birefringent medium layer 430. In some embodiments, as shown in FIG. 4F, the third birefringent medium layer 430 may be irradiated with, e.g., a UV light 422. Under a sufficient UV light irradiation, the third birefringent medium layer 430 may become photo-polymerized to stabilize the 3D orientation pattern of the LC molecules.

Referring to FIGS. 4C and 4D, in some embodiments, the first LC precursor 417 and the second LC precursor 427 may have different birefringences and a substantially same chirality. In some embodiments, the first LC precursor 417 may include a first host birefringent material and a first chiral dopant doped into the first host birefringent material with a first concentration of the first chiral dopant. The second LC precursor 427 may include a second host birefringent material and a second chiral dopant doped into the second host birefringent material with a second concentration of the second chiral dopant. The first host birefringent material and the second host birefringent material may have different birefringences (e.g., a first birefringence and a second birefringence). In some embodiments, the first chiral dopant and the second chiral dopant may have the same helical twist power (“HTP”), and the first concentration and the second concentration may be substantially the same. In some embodiments, the first chiral dopant and the second chiral dopant may have different HTPs, and the first concentration and the second concentration may be different. In some embodiments, the first LC precursor 417 and the second LC precursor 427 may include birefringent materials with different birefringences and a substantially same intrinsic chirality. For example, the first LC precursor 417 may have a first birefringence with a first intrinsic chirality, and the second LC precursor 427 may have a second birefringence different from the first birefringence and a second chirality that is substantially the same as the first chirality.

When the first LC precursor 417 having the first birefringence and the second LC precursor 427 having the second birefringence are mixed to form a mixture (e.g., during the heating process), through controlling the volume (or amount) of the first LC precursor 417 and the volume (or amount) of the second LC precursor 427 dispensed at a same predetermined location of the alignment structure 412, a ratio between the volume (or amount) of the first LC precursor 417 and the volume (or amount) of the second LC precursor 427 at the predetermined location in the mixture may be controlled to be a predetermined ratio or within a predetermined ratio range. Accordingly, the birefringence at a predetermined location of the mixture may be controlled to be any suitable value between the first birefringence and the second birefringence. By configuring the ratios between the volumes of the first LC precursor 417 and the volumes of the second LC precursor 427 at predetermined locations of the third birefringent medium layer 430, the third birefringent medium layer 430 may be fabricated with a predetermined birefringence variation in one or more dimensions, e.g., within a plane perpendicular to the thickness direction of the third birefringent medium layer 430 (e.g., a predetermined 1D or 2D birefringence variation). The polymerized third birefringent medium layer 430′ may have the same birefringence variation as the third birefringent medium layer 430.

In some embodiments, the birefringence variation at different locations of the third birefringent medium layer 430 may be introduced by mixing amounts (or volumes) of the first composition (e.g., LC precursor) 417 and the second composition (e.g., LC precursor) 427 in different ratios. At each location, the birefringence of the third birefringent medium layer 430 may be a function of the first birefringence, the second birefringence, a ratio of the first volume (or amount, or thickness) of the first composition and the second volume (or amount, or thickness) of the second composition. Thus, by configuring the ratio between the first volume and the second volume at the predetermined location to be a predetermined ratio or within a predetermined ratio range, the birefringence at the predetermined location in the third birefringent medium layer 430 may be configured to be any suitable value between the first birefringence and the second birefringence. In some embodiments, by configuring at least one of a first thickness variation (i.e., different amounts or volumes of the first composition 417 at different locations) or a second thickness variation (i.e., different amounts or volumes of the second composition 427 at different locations), the ratio between the first volume and the second volume at the predetermined location may be controlled to be a predetermined ratio or within a predetermined ratio range, and the birefringence at the predetermined location in the third birefringent medium layer 430 may be configured to be any suitable value between the first birefringence and the second birefringence. Thus, when the first birefringent medium layer 415 and the second birefringent medium layer 420 are mixed, a birefringence variation may be achieved at different locations of the third birefringent medium layer 430.

During the inkjet printing processes shown in FIGS. 4C and 4D, the first printhead 406 (or a plurality of the first printheads 406) may dispense LC droplets of the first LC precursor 417 (having the first birefringence) of first predetermined volumes at predetermined locations of the alignment structure 412 to form the first birefringent medium layer 415. The first birefringent medium layer 415 may have a uniform (or the same) birefringence (e.g., the first birefringence) across the first birefringent medium layer 415. After the first birefringent medium layer 415 is formed, the second printhead 416 (or a plurality of the second printheads 416) may dispense LC droplets of the second LC precursor 427 (having the second birefringence) of second predetermined volumes at the corresponding locations of the first birefringent medium layer 415 to form the second birefringent medium layer 420. The second birefringent medium layer 420 may have a uniform (or the same) birefringence (e.g., the second birefringence) across the second birefringent medium layer 420. At least one of the first birefringent medium layer 415 and the second birefringent medium layer 420 may be configured with a thickness variation at different locations of the birefringent medium layer. The thickness variation may be in one or more dimensions, e.g., within a plane perpendicular to the thickness direction of the birefringent medium layer 415.

For illustrative purpose, FIGS. 4C and 4D shows the first birefringent medium layer 415 may be configured with a first thickness variation at different locations, and the second birefringent medium layer 420 may be configured with a second thickness variation at different locations. The first thickness variation may be in one or more dimensions, e.g., within a plane perpendicular to the thickness direction of the first birefringent medium layer 415. The second thickness variation may be in one or more dimensions, e.g., within a plane perpendicular to the thickness direction of the second birefringent medium layer 420. In some embodiments, the second thickness variation may be in the same one or more dimensions as the first thickness variation. In some embodiments, the first thickness variation may have a first thickness variation profile, and the second thickness variation may have a second thickness variation profile. The first thickness variation profile and the second thickness variation profile may be different.

After the second birefringent medium layer 420 is formed, the first birefringent medium layer 415 having the uniform birefringence (e.g., the first birefringence) and the first thickness variation and the second birefringent medium layer 420 having the uniform birefringence (e.g., the second birefringence) and the second thickness variation may be heated to mix together to form the third birefringent medium layer 430. At each predetermined location of the third birefringent medium layer 430, the birefringence may be a function of the first birefringence, the second birefringence, and a ratio between the volume (or amount, thickness) of the first LC precursor 417 and the volume (or amount, thickness) of the second LC precursor 427. By configuring volume of the LC droplets of the first LC precursor 417 and the volume of the LC droplets of the second LC precursor 427 dispensed at each of the predetermined locations of the alignment structure 412, the ratio between the volume of the first LC precursor 417 and the volume of the second LC precursor 427 may be configured to be a predetermined ratio or within a predetermined ratio range. Thus, the birefringence at each predetermined location in the third birefringent medium layer 430 may be configured to be any suitable value between the first birefringence and the second birefringence. The ratios at different predetermined locations of the alignment structure 412 may be different. Thus, the birefringences of the third birefringent medium layer 430 at different locations corresponding to different predetermined locations of the alignment structure 412 may be different, resulting in a birefringence variation in one or more dimensions, e.g., within a plane perpendicular to a thickness direction of the third birefringent medium layer 430. The birefringence variation may have a 1D or 2D birefringence variation profile.

In some embodiments, the third birefringent medium layer 430 may have a uniform thickness or a thickness variation in one or more dimensions, e.g., within the plane perpendicular to the thickness direction of the third birefringent medium layer 430. The one or more dimensions in which the thickness varies may or may not be the same as the one or more dimensions in which the birefringence varies. The third birefringent medium layer 430 may be polymerized to form the polymerized third birefringent medium layer 430′. The polymerization may not affect the birefringence variation. Thus, the polymerized third birefringent medium layer 430′ may have the same birefringence variation and/or the same thickness variation (or same uniform thickness) as the third birefringent medium layer 430. In some embodiments, the polymerized third birefringent medium layer 430′ may be a PVH having the same birefringence variation and/or the same thickness variation (or same uniform thickness) as the third birefringent medium layer 430.

In some embodiments, the first LC precursor 417 and the second LC precursor 427 may have a substantially same birefringence and different chiralities. The first LC precursor 417 may have a first chirality. The first chirality may determine a first slant angle. The second LC precursor 427 may have a second chirality that is different from the first chirality. The second chirality may determine a second slant angle. That is, the second slant angle may be different from the first slant angle. In some embodiments, the first LC precursor 417 may include a first host birefringent material and a first chiral dopant doped into the first host birefringent material with a first concentration. The second LC precursor 427 may include a second host birefringent material and a second chiral dopant doped into the second host birefringent material with a second concentration. The first host birefringent material and the second host birefringent material may have a substantially same birefringence. In some embodiments, the first chiral dopant and the second chiral dopant may have the same HTP, and the first concentration and the second concentration may be different, which may result in different chiralities (and hence different slant angles). In some embodiments, the first chiral dopant and the second chiral dopant may have different HTPs, and the first concentration and the second concentration may be the same or different, which may also result in different chiralities (and hence different slant angles). In some embodiments, the first LC precursor 417 and the second LC precursor 427 may include birefringent materials with a substantially same birefringence and different intrinsic chiralities (and hence different slant angles).

When the first LC precursor 417 having the first chirality and the second LC precursor 427 having the second chirality different from the first chirality are mixed (e.g., during the heating processes) to form a mixed layer (e.g., the third birefringent medium layer 430), a chirality (or slant angle) at a predetermined location of the mixed layer may be a function of the first chirality, the second chirality, and a ratio between the first volume (or first amount, or first thickness) and the second volume (or second amount, or second thickness). Thus, through configuring the ratio between the volume (or amount) of the first LC precursor 417 and the volume (or amount) of the second LC precursor 427 dispensed at a predetermined location to be a predetermined ratio or within a predetermined ratio range, the chirality at the predetermined location in the mixed layer may be controlled to be any suitable value between the first chirality (and the second chirality. Thus, the slant angle at the predetermined location in the mixed layer may be controlled to be any suitable value between the first slant angle and the second slant angle. By configuring different ratios for different locations, a slant angle variation may be achieved in the mixed layer. The slant angle variation may be in one or more dimensions, e.g., within a plane perpendicular to a thickness direction of the mixed layer. The slant angle variation may have a 1D or 2D birefringence variation profile. In some embodiments, the third birefringent medium layer 430 may have a predetermined thickness variation in the one or more dimensions, e.g., within the plane perpendicular to the thickness direction of the third birefringent medium layer 430. In some embodiments, the thickness of the third birefringent medium layer 430 may be uniform.

In some embodiments, during the inkjet printing process shown in FIGS. 4C and 4D, the first printhead 406 may dispense LC droplets of the first LC precursor 417 (having the first chirality) of first predetermined volumes at predetermined locations of the alignment structure 412 to form the first birefringent medium layer 415. The second printhead 416 may dispense LC droplets of the second LC precursor 427 (having the second chirality) of second predetermined volumes at the corresponding locations of the first birefringent medium layer 415 to form the second birefringent medium layer 420. At least one of the first birefringent medium layer 415 and the second birefringent medium layer 420 may be configured with a thickness variation at different locations of the birefringent medium layer. The thickness variation may be in one or more dimensions, e.g., within a plane perpendicular to the thickness direction of the birefringent medium layer 415.

After the second birefringent medium layer 420 is fabricated, the first birefringent medium layer 415 and the second birefringent medium layer 420 may be heated to mix together to form the third birefringent medium layer 430. In the third birefringent medium layer 430, at each predetermined location, the slant angle may be a function of the first slant angle of the first birefringent medium layer 415, the second slant angle of the second birefringent medium layer 420, and a ratio between the first volume (or amount, or thickness) of the first composition and the second volume (or amount, or thickness) of the second composition. By configuring the ratio between the first volume and the second volume to be a predetermined ratio or within a predetermined ratio range, the slant angle at the predetermined location in the third birefringent medium layer 430 may be any suitable value between the first slant angle and the second slant angle. Different ratios may be configured for different locations, resulting in different slant angles. Thus, the third birefringent medium layer 430 may have a predetermined slant angle variation in one or more dimensions, e.g., within a plane perpendicular to the thickness direction of the third birefringent medium layer 430. The slant angle variation may have a predetermined 1D or 2D slant angle variation profile.

After the third birefringent medium layer 430 is polymerized to form the polymerized third birefringent medium layer 430′, the polymerized third birefringent medium layer 430′ may have the same slant angle variation as the third birefringent medium layer 430. In some embodiments, the polymerized third birefringent medium layer 430′ may be a PVH. Thus, the PVH may have the slant angle variation in the one or more dimensions, e.g., within the plane perpendicular to the thickness direction of the PVH. In some embodiments, the PVH may also include a thickness variation in the one or more dimensions, e.g., within the plane perpendicular to the thickness direction of the PVH. In some embodiments, the thickness of the PVH may be uniform.

In some embodiments, the first LC precursor 417 and the second LC precursor 427 may have both different birefringences and different chiralities (e.g., slant angles). For example, the first LC precursor 417 may include a first host birefringent material and a first chiral dopant doped into the first host birefringent material with a first concentration. The second LC precursor 427 may include a second host birefringent material and a second chiral dopant doped into the second host birefringent material with a second concentration. The first host birefringent material and the second host birefringent material may have different birefringences. In some embodiments, the first chiral dopant and the second chiral dopant may have the same HTP, and the first concentration and the second concentration may be different. In some embodiments, the first chiral dopant and the second chiral dopant may have different HTPs, and the first concentration and the second concentration may be the same or different. In some embodiments, the first LC precursor 417 and the second LC precursor 427 may include birefringent materials with different birefringences and different intrinsic chirality.

When the first birefringent medium layer 415 including the first LC precursor 417 and the second birefringent medium layer 420 including the second LC precursor 427, where the first LC precursor 417 and the second LC precursor 427 have different birefringences and different chiralities, are mixed to form the third birefringent medium layer 430, through controlling a ratio between the volume of the first LC precursor 417 and the volume of the second LC precursor 427 at each of the predetermined locations, the third birefringent medium layer 430 may have both a predetermined birefringence variation and a predetermined slant angle variation in one or more dimensions, e.g., within a plane perpendicular to the thickness direction of the third birefringent medium layer 430. The predetermined birefringence variation may have a 1D or 2D variation profile. The predetermined slant angle variation may have a 1D or 2D variation profile. The third birefringent medium layer 430 may be polymerized to form the polymerized third birefringent medium layer 430′. The polymerized third birefringent medium layer 430′ may include both the predetermined birefringence variation and the predetermined slant angle variation of the third birefringent medium layer 430. In some embodiments, the third birefringent medium layer 430′ may be a PVH. Thus, the PVH may include the predetermined birefringence variation and the predetermined slant angle variation in one or more dimensions, e.g., within a plane perpendicular to the thickness direction of the PVH.

In some embodiments, before the first birefringent medium layer 415 and the second birefringent medium layer 420 are heated to mix together to form the third birefringent medium layer 430, one or more additional birefringent medium layers may be formed (e.g., printed) on the second birefringent medium layer 420. Thus, the third birefringent medium layer 430 may be a mixture of three or more birefringent medium layers. For example, a layer of a third LC precursor may be dispensed on the second birefringent medium layer 420 to form a fourth birefringent medium layer. In some embodiments, at least one of the first birefringent medium layer, the second birefringent medium layer, or the fourth birefringent medium layer may be configured with a predetermined thickness variation in one or more dimensions, e.g., within a plane perpendicular to the thickness direction of the birefringent medium layer. In some embodiments, at least two of the first birefringent medium layer, the second birefringent medium layer, or the fourth birefringent medium layer may be configured with predetermined thickness variations in one or more dimensions, e.g., within a plane perpendicular to the thickness direction of the birefringent medium layers, respectively. The predetermined thickness variations of the at least two of the first birefringent medium layer, the second birefringent medium layer, or the fourth birefringent medium layer may be different or may be the same.

In some embodiments, a layer of a fourth LC precursor may be dispensed on the fourth birefringent medium layer to form a fifth birefringent medium layer. At least one of the first birefringent medium layer, the second birefringent medium layer, the fourth birefringent medium layer, or the fifth birefringent medium layer may be configured with a predetermined thickness variation in one or more dimensions, e.g., within a plane perpendicular to the thickness direction of the birefringent medium layer. In some embodiments, at least two of the first birefringent medium layer, the second birefringent medium layer, the fourth birefringent medium layer, or the fifth birefringent medium layer may be configured with predetermined thickness variations in one or more dimensions, e.g., within a plane perpendicular to the thickness direction of the birefringent medium layers, respectively. The predetermined thickness variations of the at least two of the first birefringent medium layer, the second birefringent medium layer, the fourth birefringent medium layer, or the fifth birefringent medium layer may be different or may be the same.

The first birefringent medium layer 415, the second birefringent medium layer 420, the fourth birefringent medium layer, and the fifth birefringent medium layer may be printed onto the alignment structure 412 in any suitable sequence. In some embodiments, the first LC precursor 417 may have a first birefringence Δn₁ and a first chirality C₁, the second LC precursor 427 may have a second birefringence Δn₂ and a second chirality C₂. The second birefringence Δn₂ may be the same as or different from the first birefringence Δn₁. The second chirality C₂ may be the same as or different from the first chirality C₁. In some embodiments, the third LC precursor may have a third birefringence Δn₃ and a third chirality C₃. The third birefringence Δn₃ may be the same as or different from the first or the second birefringence Δn₁ or Δn₂. The third chirality C₃ may be the same as or different from the first or second chirality C₁ or C₂. The fourth LC precursor may have a fourth birefringence Δn₄ and a fourth chirality C₄. The fourth birefringence Δn₄ may be the same as or different from the first, second, or third birefringence Δn₁, Δn₂, or Δn₃. The fourth chirality C₄ may be the same as or different from the first, second, or third chirality C₁, C₂, or C₃. The first birefringent medium layer 415, the second birefringent medium layer 420, the fourth birefringent medium layer, and the fifth birefringent medium layer may be heated to mix together to form a mixed layer (e.g., the third birefringent medium layer 430).

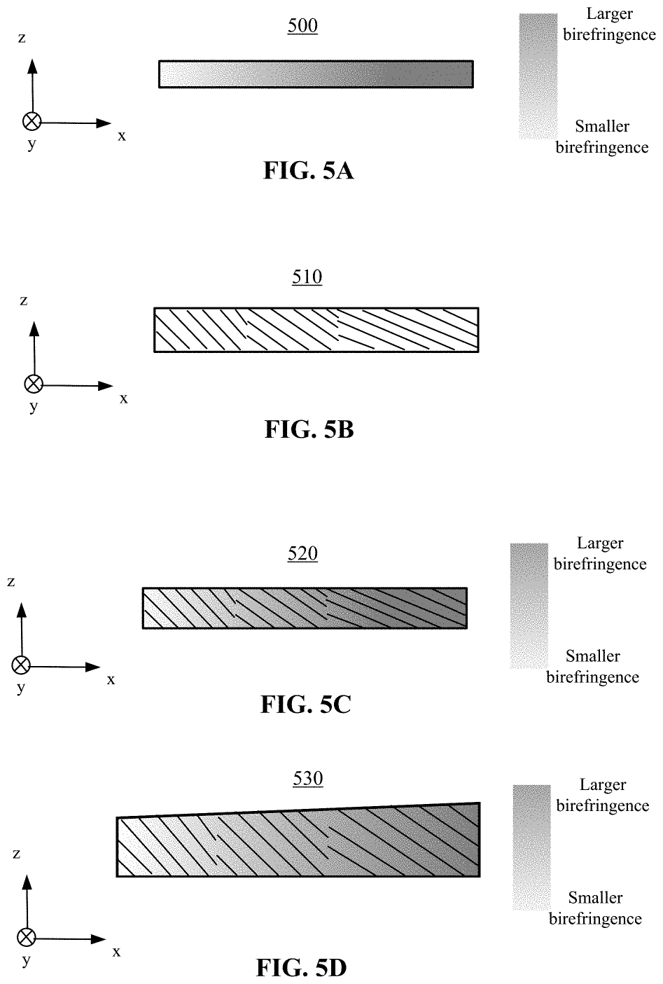

FIGS. 5A-5D show schematic diagrams of x-z sectional views of PVHs fabricated through the disclosed fabrication processes, according to various embodiments of the present disclosure. The fabricated PVHs may have a thickness variation, a birefringence variation, and/or a slant angle variation in one or more dimensions, e.g., within a plane perpendicular to the thickness direction of the PVHs, e.g., in the x-axis direction and/or the y-axis direction in an x-y plane. That is, the fabricated PVHs may have a 1D or 2D thickness variation profile, a 1D or 2D birefringence variation profile, and/or a 1D or 2D slant angle variation profile in one or more dimensions, e.g., within a plane perpendicular to the thickness direction of the PVHs. For illustrative purposes, FIGS. 5A-5D show a thickness variation, a birefringence variation, and/or a slant angle variation of the fabricated PVHs in an x-axis direction.

FIG. 5A shows a PVH 500 having a birefringence variation along the x-axis direction. Darker gray indicates a larger birefringence and lighter gray indicates a smaller birefringence. For example, the birefringence of the PVH 500 may gradually increase along the +x-axis direction. The thickness and slant angle of the PVH 500 may be uniform across the PVH 500. Thus, for lights with predetermined incidence angles, predetermined incidence wavelengths, and predetermined polarizations, the diffraction efficiency of the PVH 500 may gradually increase along the +x-axis direction. The birefringence variation may include any other suitable profile other than a linear profile, such as a non-linear profile. Accordingly, for lights with predetermined incidence angles, predetermined incidence wavelengths, and predetermined polarizations, the diffraction efficiency of the PVH 500 may have a corresponding profile, such as a non-linear profile. When the birefringence variation has a 2D variation profile, the diffraction efficiency of the PVH 500 may have a corresponding 2D variation profile.

FIG. 5B shows a PVH 510 having a slant angle variation along the x-axis direction. The Bragg planes within a volume of the PVH 510 are schematically indicated by inclined lines within the PVH 510. The slant angles of the PVH 510 may be defined as α=90°−β, where β=arctan (Pᵥ/Pₓ), where Pᵥ is the vertical pitch in the z-axis direction and Pₓ is the horizontal pitch in the x-axis direction. FIG. 5B shows that the slant angles of the PVH 510 may be different at different portions. For example, the slant angles may gradually increase along the +x-axis direction. The thickness and birefringence of the PVH 510 may be uniform across the PVH 510. Thus, for lights with predetermined incidence angles, predetermined incidence wavelengths, and predetermined polarizations, the diffraction efficiency of the PVH 510 may gradually increase along the +x-axis direction. The slant angle variation may have any other suitable profile other than the linear profile, such as a non-linear profile. Accordingly, for lights with predetermined incidence angles, predetermined incidence wavelengths, and predetermined polarizations, the diffraction efficiency of the PVH 510 may have a corresponding profile, such as a non-linear profile. When the slant angle variation has a 2D variation profile, the diffraction efficiency of the PVH 510 may have a corresponding 2D variation profile.

FIG. 5C shows a PVH 520 having a combination of a birefringence variation and a slant angle variation along the x-axis direction. The Bragg planes within a volume of the PVH 520 are indicated by inclined lines within the PVH 520. FIG. 5C shows that the birefringence and the slant angle of the PVH 520 may gradually increase along the +x-axis direction. The thickness of the PVH 520 may be uniform across the PVH 520. Thus, for lights with predetermined incidence angles, predetermined incidence wavelengths, and predetermined polarizations, the diffraction efficiency of the PVH 520 may gradually increase along the +x-axis direction. When at least one of the birefringence variation or the slant angle variation has a 2D variation profile, the diffraction efficiency of the PVH 520 may have a 2D variation profile.

FIG. 5D shows a PVH 530 having a combination of a thickness variation, a birefringence variation, and a slant angle variation along the x-axis direction. The Bragg planes within a volume of the PVH 530 are indicated by inclined lines within the PVH 530. FIG. 5D shows that the thickness, the birefringence, and the slant angle of the PVH 530 may gradually increase along the +x-axis direction. Thus, for lights with predetermined incidence angles, predetermined incidence wavelengths, and predetermined polarizations, the diffraction efficiency of the PVH 530 may gradually increase along the +x-axis direction. When at least one of the thickness variation, the birefringence variation, or the slant angle variation has a 2D variation profile, the diffraction efficiency of the PVH 530 may have a 2D variation profile.

The PVHs with thickness, birefringence, and/or slant angle variations shown in FIGS. 5A-5D are for illustrative purposes. PVHs with any desirable combination of a thickness variation, a birefringence variation, and/or a slant angle variation (e.g., any desirable combination of 1D or 2D thickness, birefringence, and/or slant angle variation profiles) may be fabricated based on the disclosed fabrication processes. That is, PVHs with any desirable diffraction efficiency variations (e.g., any desirable 1D or 2D diffraction efficiency profiles) may be fabricated based on the disclosed fabrication processes.

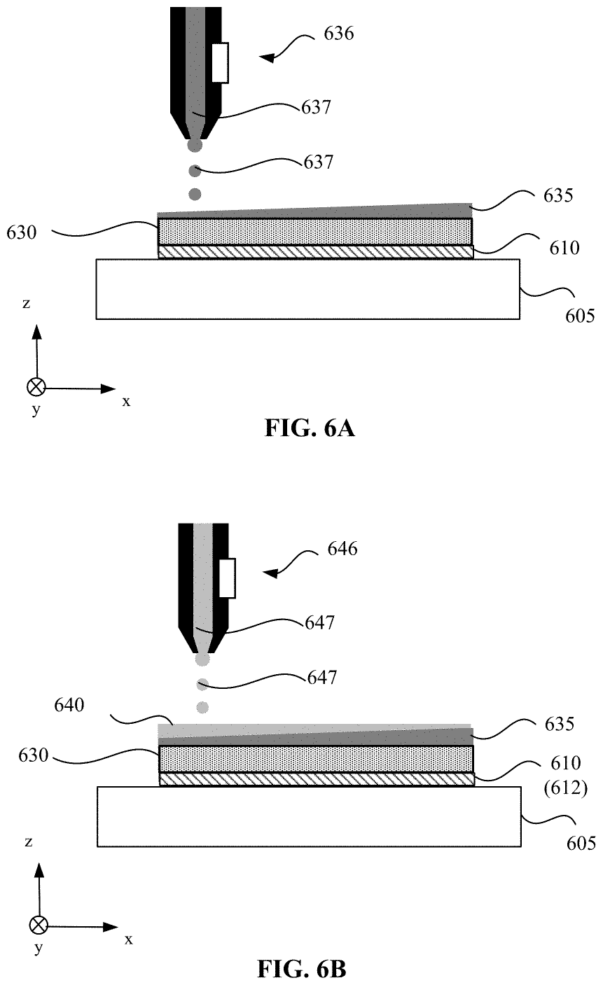

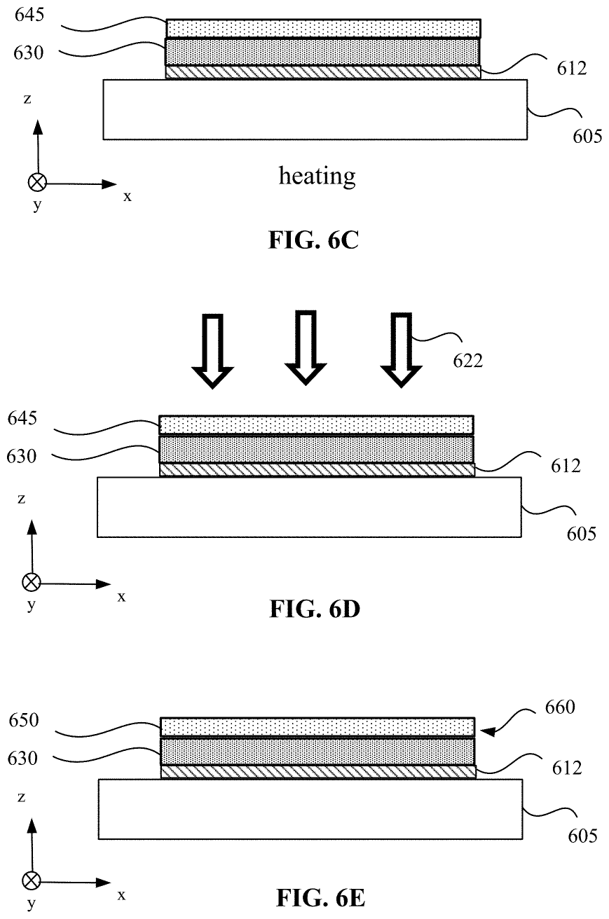

In some embodiments, the polymerized third birefringent medium layer 430′ shown in FIG. 4F may be a first PVH layer, and one or more additional PVH layers may be formed on the first PVH layer through the printing and polymerizing processes shown in FIGS. 2C-2D or the printing, heating, and polymerizing processes shown in FIGS. 4C-4F. As a result, a multi-layer PVH including multiple PVH layers (e.g., multiple polymerized birefringent medium layers) may be obtained. FIGS. 6A-6E illustrate schematic diagrams showing processes for fabricating a PVH, according to an embodiment of the present disclosure. The PVH may be a multi-layer PVH including multiple PVH layers (e.g., multiple polymerized birefringent medium layers). At least one (e.g., each) PVH layer of the multiple PVH layers may have at least one (e.g., two or more) of a thickness variation, a slant angle variation, or a birefringence variation in one or more dimensions, e.g., within a plane perpendicular to the thickness direction of the PVH. The fabrication processes shown in FIGS. 6A-6E may include steps or processes similar to those shown in FIGS. 4A-4F. The PVH fabricated based on the processes shown in FIGS. 6A-6E may include elements similar to those included in the PVH fabricated based on the processes shown in FIGS. 4A-4F. Descriptions of the similar steps and similar elements can refer to the descriptions rendered above in connection with FIGS. 4A-4F. Although the substrate and films or layers are shown as having flat surfaces, in some embodiments, the substrate and films or layers formed thereon may include curved surfaces.

For illustrative purposes, FIGS. 6A-6E illustrate schematic diagrams showing processes for fabricating a PVH including two PVH layers. The processes may be used to fabricate a PVH including more than two PVH layers. In some embodiments, as shown in FIG. 6A, an alignment layer 610 and a first PVH layer 630 may be fabricated on a substrate 605 based on the fabrication processes shown in FIGS. 4A-4F. Descriptions of the similar steps and similar elements can refer to the descriptions rendered above in connection with FIGS. 4A-4F. The first PVH 630 may be an embodiment of the polymerized third birefringent medium layer 430′ shown in FIG. 4F. As shown in FIG. 6A, after the first PVH layer 630 is formed, an LC precursor 637 may be dispensed on the first PVH layer 630 to form a birefringent medium layer 635. In some embodiments, as shown in FIG. 6A, an inkjet printer (FIG. 6A merely shows a printhead 636 of the inkjet printer for illustrative purposes) may print a layer of the LC precursor 637 on the first PVH layer 630 to form the birefringent medium layer 635. After the birefringent medium layer 635 is formed, as shown in FIG. 6B, an LC precursor 647 may be dispensed on the birefringent medium layer 635 to form a birefringent medium layer 640. The LC precursor 647 may be the same as or different from the LC precursor 637. In some embodiments, as shown in FIG. 6B, a printhead 646 (or a plurality of printheads 646) of the inkjet printer may print a layer of the LC precursor 647 on the birefringent medium layer 635 to form the birefringent medium layer 640. In some embodiments, the birefringent medium layer 635 and the birefringent medium layer 640 may be printed by different printheads (e.g., printheads 636 and 646) of the same inkjet printer. In some embodiments, the birefringent medium layer 635 and the birefringent medium layer 640 may be printed by the same printhead (or the same group of printheads). The same printhead or same group of printheads may be supplied with different materials when printing different layers.

At least one of the birefringent medium layer 635 and the birefringent medium layer 640 may be configured to have a thickness variation in one or more dimensions, e.g., within a plane perpendicular to the thickness direction of the corresponding birefringent medium layer. In some embodiments, as shown in FIGS. 6A and 6B, each of the first birefringent medium layer 635 and the birefringent medium layer 640 may be configured to have a thickness variation in one or more dimensions, e.g., within a plane perpendicular to the thickness direction of the respective birefringent medium layer. In some embodiments, the thickness variations in the first birefringent medium layer 635 and the birefringent medium layer 640 may have the same variation profile (e.g., both increasing in the +x-axis direction), or may have different variation profiles (e.g., increasing in the +x-axis direction and in the −x-axis direction, and/or with different maximum and minimum thicknesses, etc.).

After the birefringent medium layer 640 is formed, as shown in FIG. 6C, the birefringent medium layer 635 and the birefringent medium layer 640 may be heated to mix together to form a birefringent medium layer 645. The birefringent medium layer 645 may be cooled, e.g., to a room temperature. After being cooled, the birefringent medium layer 645 may be polymerized to form a second PVH layer 650, as shown in FIG. 6E. In some embodiments, as shown in FIGS. 6D and 6E, the birefringent medium layer 645 may be irradiated with, e.g., a UV light 622. Under a sufficient UV light irradiation, the birefringent medium layer 645 may be photo-polymerized to stabilize the 3D orientation pattern of the LC molecules included therein, thereby forming the second PVH layer 650 on the first PVH layer 630. The second PVH layer 650 may have at least one (e.g., two or more) of a thickness variation, a slant angle variation, or a birefringence variation in one or more dimensions, e.g., within a plane perpendicular to the thickness direction of the second PVH layer 650. With the processes shown in FIGS. 6A-6E, a multi-layer PVH 660 including the second PVH layer 650 and the first PVH layer 630 may be fabricated. In some embodiments, the multi-layer PVH 660 may have at least one (e.g., two or more) of a thickness variation, a slant angle variation, or a birefringence variation in at least one dimension, e.g., in the x-axis direction.

In some embodiments, the first PVH layer 630 and the second PVH layer 650 may have a substantially same in-plane pitch. In some embodiments, the alignment layer 610 may be a first alignment layer 610, and the alignment structure 612 formed based on the first alignment layer 610 may be a first alignment structure. Before forming the birefringent medium layer 635 on the first PVH layer 630, a second alignment layer may be disposed on the first PVH layer 630 and processed to form a second alignment structure. The birefringent medium layer 635 may be formed on the second alignment structure. The second alignment structure may be configured to provide a spatially varying alignment pattern, e.g., a linearly periodic alignment pattern, which may be different from that provided by the first alignment structure. For example, the periodic alignment patterns provided by the first alignment structure and second alignment structure may have different periodicities. As a result, the first PVH layer 630 and the second PVH layer 650 may have different in-plane pitches. For a multi-layer PVH, in some embodiments, each PVH layer may be formed on a corresponding alignment structure. Different alignment patterns (and hence different in-plane pitches) may be provided to the PVH layers by the different alignment structures.

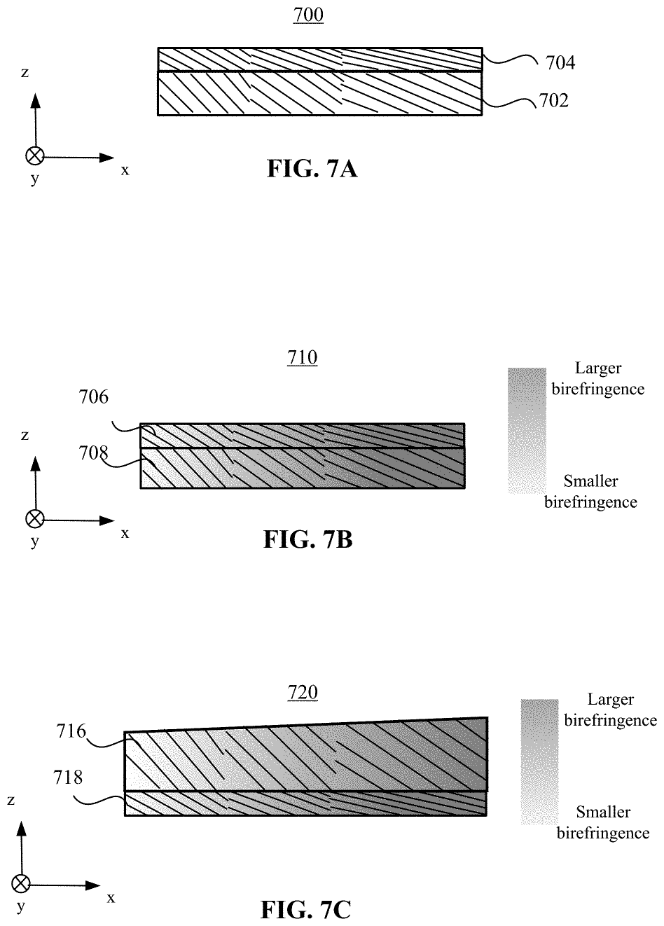

FIG. 7A shows a schematic diagram of a multi-layer PVH 700 fabricated based on disclosed fabrication processes, according to an embodiment of the present disclosure. As shown in FIG. 7A, the multi-layer PVH 700 may include a first PVH layer 702 and a second PVH layer 704 stacked together. The first PVH layer 702 may have a relatively large thickness (which may be referred to as a primary PVH layer 702), and the second PVH layer 704 may have a relatively small thicknesses (which may be referred to as a secondary PVH layer 704).

In some embodiments, the in-plane pitches (e.g., the pitch in a direction in the x-y plane) of the primary PVH layer 702 and the secondary PVH layer 704 may be substantially the same, and the vertical pitch (e.g., the pitch in the thickness direction) of the secondary PVH layer 704 may be configured to be about half of the vertical pitch of the primary PVH layer 702. In some embodiments, when a waveguide coupled with a single layer PVH is implemented as an augmented reality (“AR”) combiner or a mixed reality (“MR”) combiner in a near-eye display (“NED”), the single layer PVH may diffract visible lights propagating from a real world environment, resulting in a multi-colored glare in a see-through view. Such a see-through artifact is referred to as a “rainbow effect,” which may degrade the image quality of the see-through view. The multi-layer PVH 700 may be configured to reduce the rainbow effect in the AR/MR combiner. The secondary PVH layer 704 may be configured to suppress undesirable diffraction orders of the primary PVH layer 702, such that the rainbow effect may be reduced.

In some embodiments, each of the first PVH layer 702 and the second PVH layer 704 may be fabricated based on the disclosed processes. At least one (e.g., each) of the first PVH layer 702 and the second PVH layer 704 may include at least one (e.g., two or more) of a thickness variation, a birefringence variation, or a slant angle variation in one or more dimensions, e.g., within a plane perpendicular to a thickness direction of the respective PVH layer, such that for lights with predetermined incidence angles, the multi-layer PVH 700 may have a predetermined diffraction efficiency variation in one or more dimensions, e.g., within a plane perpendicular to the thickness direction of the multi-layer PVH 700. In some embodiments, the variation profiles of the thickness variation, the birefringence variation, and/or the slant angle variation for the first PVH layer 702, the second PVH layer 704, and/or the multi-layer PVH 700 may be the same or may be different. For illustrative purposes, FIG. 7A shows that each of the primary PVH layer 702 and the secondary PVH layer 704 may be fabricated to have a predetermined 1D slant angle variation along the x-axis direction. In some embodiments, the slant angle variation may have a 2D profile, e.g., in the x-axis direction and in the y-axis direction. In some embodiments, in addition to the slant angle variation, the multi-layer PVH 700 may also include a predetermined thickness variation in one or more dimensions, e.g., within a plane perpendicular to the thickness direction of the multi-layer PVH 700. In some embodiments, the multi-layer PVH 700 may be configured to include more than one secondary PVH layer 704 configured to suppress undesirable diffraction orders of the multi-layer PVH 700. The multi-layer PVH 700 may have a diffraction efficiency variation in one or more dimensions, e.g., within a plane perpendicular to the thickness direction of the multi-layer PVH 700 for lights with predetermined incidence angles, predetermined incidence wavelengths, and predetermined polarizations.

FIG. 7B shows a schematic diagram of a multi-layer PVH 710 fabricated based on disclosed fabrication processes, according to an embodiment of the present disclosure. As shown in FIG. 7B, the multi-layer PVH 710 may include two PVH layers stacked together, a first PVH layer 706 and a second PVH layer 708. Each of the two PVH layers 706 and 708 may be fabricated using the disclosed processes. At least one (e.g., each) of the first PVH layer 706 and the second PVH layer 708 may be configured to have a birefringence variation and a slant angle variation along the x-axis direction. As a result, the multi-layer PVH 710 may have a birefringence variation and a slant angle variation along the x-axis direction. In some embodiments, the birefringence variation and the slant angle variation may have a 2D profile, e.g., in the x-axis direction and the y-axis direction.

In some embodiments, in addition to the birefringence variation and the slant angle variation, at least one of the PVH layer 706 or the PVH layer 708 may also include a thickness variation in one or more dimensions, e.g., within a plane perpendicular to the thickness direction of the corresponding PVH layer (e.g., along the x-axis direction and/or the y-axis direction in the x-y plane). Accordingly, in addition to the birefringence variation and the slant angle variation, the multi-layer PVH 710 may also have a thickness variation in one or more dimensions, e.g., within a plane perpendicular to the thickness direction of the multi-layer PVH 710 (e.g., along the x-axis direction and/or the y-axis direction in the x-y plane). As a result of one or more of the thickness variation, the birefringence variation, and the slant angle variation, the multi-layer PVH 710 may have a predetermined diffraction efficiency variation in one or more dimensions, e.g., within a plane perpendicular to the thickness direction of the multi-layer PVH 710, for lights with predetermined incidence angles. In some embodiments, the variation profiles of the thickness variation, the birefringence variation, and/or the slant angle variation for the first PVH layer 702, the second PVH layer 704, and/or the multi-layer PVH 710 may be the same or may be different. The multi-layer PVH 710 may have a diffraction efficiency variation in one or more dimensions, e.g., within a plane perpendicular to the thickness direction of the multi-layer PVH 710, for lights with predetermined incidence angles, predetermined incidence wavelengths, and predetermined polarizations.

FIG. 7C shows a schematic diagram of a multi-layer PVH 720 fabricated based on disclosed fabrication processes, according to an embodiment of the present disclosure. As shown in FIG. 7C, the multi-layer PVH 720 may include two PVH layers stacked together, a first PVH layer 716 and a second PVH layer 718. One of the two PVH layers 716 and 718 may be configured to have a birefringence variation and a slant angle along the x-axis direction, and the other of the two PVH layers 716 and 718 may be configured to have a thickness variation, a birefringence variation, and a slant angle variation along the x-axis direction. For example, the second PVH layer 718 may have a birefringence variation and a slant angle along the x-axis direction, and the first PVH layer 716 may have a thickness variation, a birefringence variation, and a slant angle variation along the x-axis direction. As a result of the thickness variation, the birefringence variation, and/or the slant angle variation in the two PVH layers 716 and 718, the multi-layer PVH 720 may have a diffraction efficiency variation in one or more dimensions, e.g., within a plane perpendicular to the thickness direction of the multi-layer PVH 720, for lights with predetermined incidence angles, predetermined incidence wavelengths, and predetermined polarizations.

The multi-layer PVHs shown in FIGS. 7A-7C with thickness, birefringence, and/or slant angle variations are for illustrative purposes. PVHs with any desirable combination of thickness, birefringence, and/or slant angle variations (e.g., any desirable 1D or 2D thickness, birefringence, and/or slant angle variation profiles in one or more directions in the plane perpendicular to the thickness direction of the PVH) may be fabricated based on the disclosed fabrication processes. That is, the multi-layer PVHs with any desirable diffraction efficiency variations (e.g., any desirable 1D or 2D diffraction efficiency profiles in one or more directions in the plane perpendicular to the thickness direction of the PVH) and/or desirable rainbow reduced effects may be fabricated based on the disclosed fabrication processes.

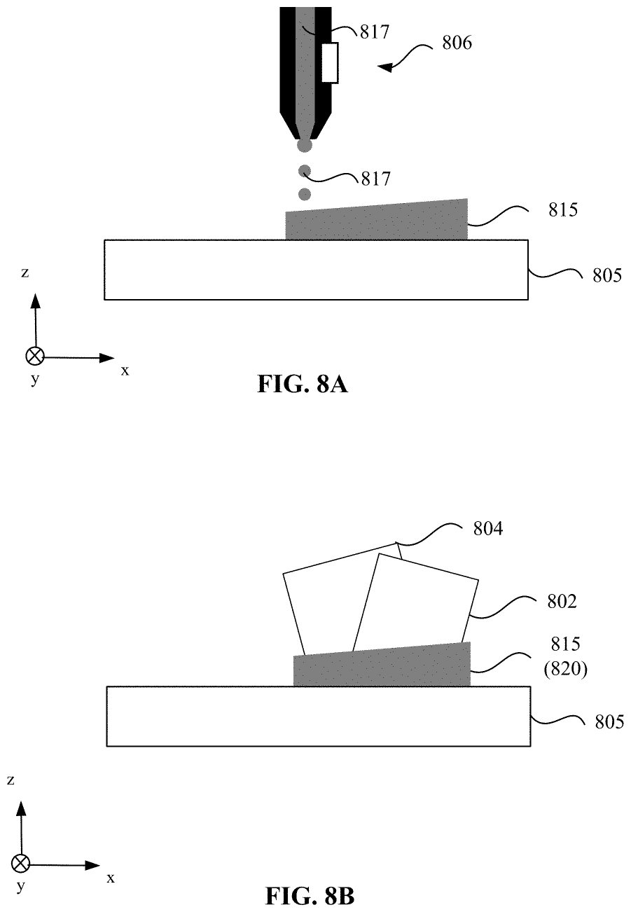

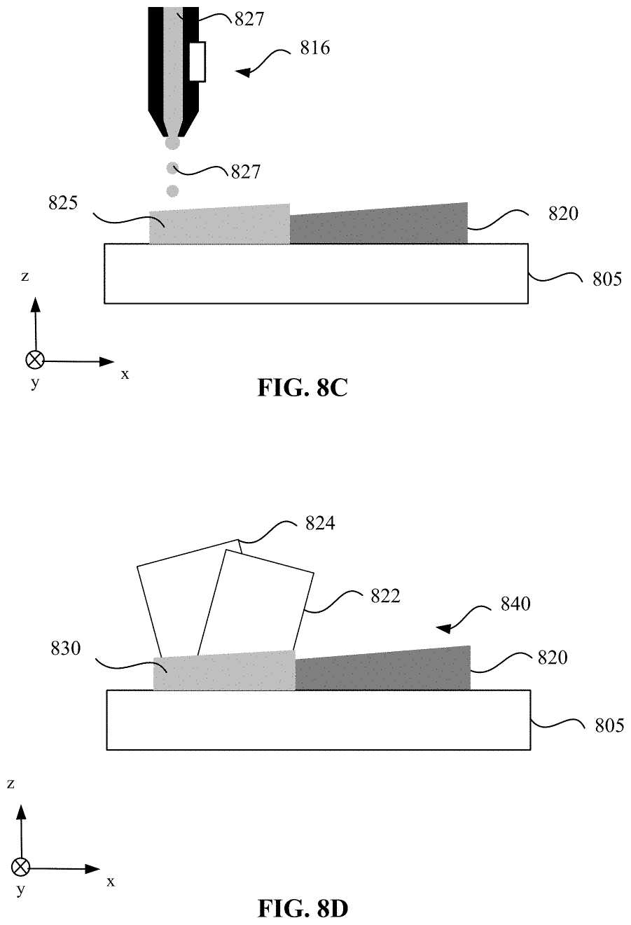

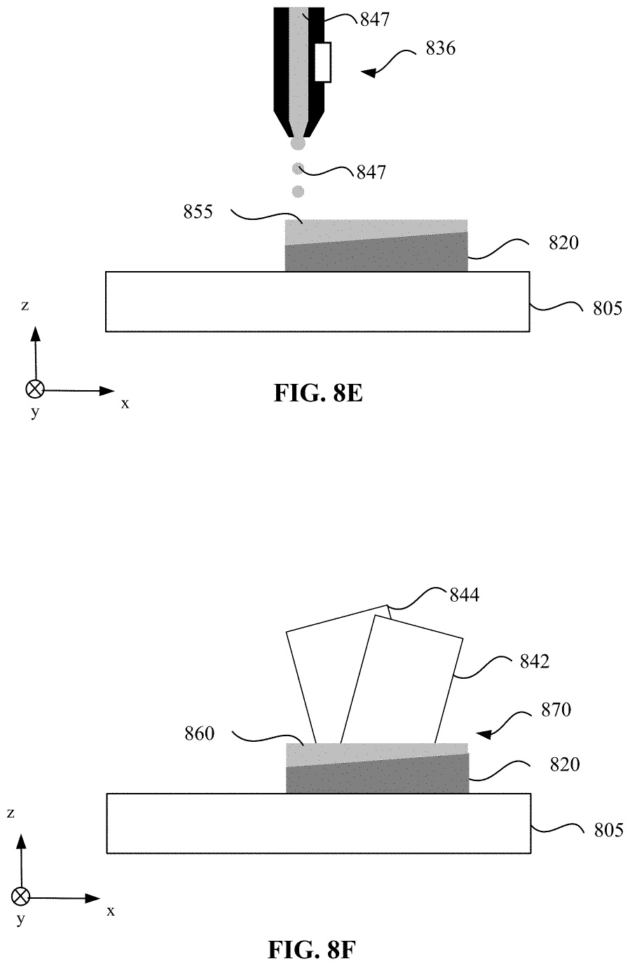

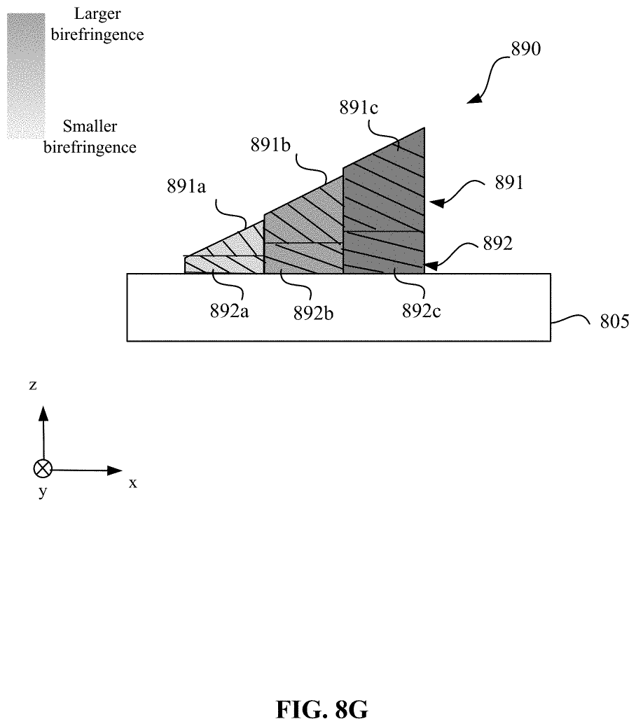

FIGS. 8A-8F illustrate schematic diagrams showing processes for fabricating birefringent medium layers, such as PVHs, according to various embodiments of the present disclosure. FIG. 8G illustrates a PVH fabricated based on the processes shown in FIGS. 8C-8F, according to an embodiment of the present disclosure. A PVH is used as an example of the birefringent medium layer in explaining the fabrication processes. The fabrication processes shown in FIGS. 8A-8F may include steps or processes similar to those shown in FIGS. 4A-4F. PVHs fabricated based on the processes shown in 8A-8F may include elements similar to those included in the PVH fabricated based on the processes shown in FIGS. 4A-4F. Descriptions of the similar steps and similar elements can refer to the descriptions rendered above in connection with FIGS. 4A-4F. Although the substrate and films or layers are shown as having flat surfaces, in some embodiments, the substrate and films or layers formed thereon may include curved surfaces.

As shown in FIG. 8A, a composition 817 may be dispensed (e.g., printed) on a substate 805 to form a composition layer 815 having a thickness variation in one or more directions in the plane perpendicular to the thickness direction of the composition layer 815. The substate 805 may be an embodiment of the substate 205 shown in FIG. 2A, and may be similar to substrates shown in other embodiments. In some embodiments, one or more photosensitive polymers may be dissolved in a suitable solvent, for example, chloroform (“CHCl₃”). In some embodiments, an inkjet printer (FIG. 8A merely shows a printhead 806 of the inkjet printer for illustrative purposes) may print a layer of the composition 817 on the substate 805 to form the composition layer 815 having a thickness variation in one or more directions in the plane perpendicular to the thickness direction of the composition layer 815. The fabrication process of printing a composition layer having a thickness variation in one or more directions in the plane perpendicular to the thickness direction of the composition layer may refer to the descriptions rendered above in connection with FIGS. 3A-3C.

The composition 817 may include one or more photosensitive polymers, such as amorphous polymers, LC polymers, etc., which may generate an induced (e.g., photo-induced) optical anisotropy and induced (e.g., photo-induced) local optic axis orientations when subjected to a polarized light irradiation. Molecules of the photosensitive polymers may include polarization sensitive photoreactive groups embedded in a main or a side polymer chain. In some embodiments, the polarization sensitive groups may include at least one of an azobenzene group, a cinnamate group, or a coumarin group, etc. In some embodiments, the photosensitive polymer may include an LC polymer with a polarization sensitive cinnamate group incorporated in a side polymer chain. An example of the LC polymer with the polarization sensitive cinnamate group incorporated in a side polymer chain is a polymer M1. The polymer M1 may have a nematic mesophase in a temperature range of about 115° C. to about 300° C. An optical anisotropy may be induced by irradiating an M1 film with a polarized UV light irradiation (e.g., a laser light with a wavelength of 325 nm or 355 nm). The induced optical anisotropy may be subsequently enhanced by more than an order of magnitude by annealing at a temperature range of about 115° C. to about 300° C. In some embodiments, by using suitable photosensitizers, visible lights (e.g., violet lights) may also be used to induce anisotropy in the polymer M1. The polymer M1 is for illustrative purposes, and is not intended to limit the scope of the present disclosure. The dependence of the photo-induced birefringence on the exposure energy may be similar for M series liquid crystalline polymers. The M series liquid crystalline polymers are discussed in U.S. patent application Ser. No. 16/433,506, filed on Jun. 17, 2019, titled “Photosensitive Polymers for Volume Holography,” which is incorporated by reference for all purposes.

After the composition layer 815 having a thickness variation in one or more dimensions, e.g., within a plane perpendicular to the thickness direction of the composition layer 815 is formed on the substate 805, the composition layer 815 may be exposed to a polarization interference formed by two circularly polarized lights 802 and 804 having opposite handednesses to record a three-dimensional (“3D”) polarization field into the composition layer 815. The two circularly polarized lights 802 and 804 may be two coherent lights. The two circularly polarized lights 802 and 804 may be UV or visible (e.g., violet) lights. In some embodiments, both the two circularly polarized lights 802 and 804 may be collimated lights. In some embodiments, one of the two circularly polarized lights 802 and 804 may be a collimated light and the other may be a diverging or converging light. Under a sufficient exposure, an optical anisotropy may be photo-induced in the composition layer 815. A value of the photo-induced optical anisotropy (i.e., photo-induced birefringence) may be related to the intensity of the polarization interference. In some embodiments, the photo-induced optical anisotropy (i.e., photo-induced birefringence) may be further enhanced by processing (e.g., annealing) the exposed composition layer 815 at a suitable elevated temperature. In addition, local optic axis orientations (e.g., rotation of the LC directors) of the composition layer 815 may be photo-induced according to the 3D polarization field. Thus, a first PVH (or a first PVH segment) 820 with a thickness variation in one or more dimensions, e.g., within a plane perpendicular to the thickness direction of the PVH (or the PVH segment) may be fabricated. The first PVH segment 820 formed by the composition layer 815 may include a first photo-induced birefringence. In some embodiments, the composition layer 815 may include a chiral dopant or an intrinsic chirality, and thus, the first PVH segment 820 formed based on the composition layer 815 may have a first slant angle.

In some embodiments, as shown in FIGS. 8C and 8D, after the first PVH segment 820 is fabricated, a second PVH segment 830 may be formed adjacent the first PVH segment 820 on the substrate 805 through the fabrication processes shown in FIGS. 8A and 8B. For example, as shown in FIGS. 8C and 8D, an inkjet printer (FIG. 8C merely shows a printhead 816 of the inkjet printer for illustrative purposes) may dispense (e.g., print) a composition 827 on the substate 805 to form a composition layer 825 having a thickness variation in one or more dimensions, e.g., within a plane perpendicular to the thickness direction of the composition layer 825. The thickness variation of the composition layer 815 may have a first thickness variation profile, and the thickness variation of the composition layer 825 may have a second thickness variation profile. The first thickness variation profile may be the same as or different from the second thickness variation profile. In some embodiments, the composition layer 825 may have a uniform thickness across she composition layer 825.

The composition 827 may be similar to the composition 817 described above. For example, the composition 827 may also include one or more photosensitive polymers, such as amorphous polymers, LC polymers, etc., which may generate an induced (e.g., photo-induced) optical anisotropy and induced (e.g., photo-induced) local optic axis orientations when subjected to a polarized light irradiation. The composition layer 825 may be exposed to a polarization interference formed by two circularly polarized lights 822 and 824 having opposite handednesses to record a 3D polarization field into the composition layer 825. Thus, the composition layer 825 may become a second PVH segment 830 with a thickness variation in one or more dimensions, e.g., within a plane perpendicular to the thickness direction of the second PVH segment 830. The second PVH segment 830 formed by the composition layer 825 may include a second photo-induced birefringence. In some embodiments, the composition layer 825 may include a chiral dopant or an intrinsic chirality, and thus, the second PVH segment 830 formed based on the composition layer 825 may have a second slant angle.

The first birefringence of the first PVH segment 820 and the second birefringence of the second PVH segment 830 may be the same or may be different. In some embodiments, when a plurality of PVH segments are formed side by side in one or more dimensions on the substrate 805, a PVH formed by the plurality of PVH segments may have a birefringence variation in one or more dimensions, e.g., within a plane perpendicular to a thickness direction of the PVH. The first slant angle of the first PVH segment 820 and the second slant angle of the second PVH segment 830 may be the same or different. In some embodiments, when a plurality of PVH segments are formed side by side in one or more dimensions on the substrate 805, a PVH formed by the plurality of PVH segments may have a slant angle variation in one or more dimensions, e.g., within a plane perpendicular to a thickness direction of the PVH. In some embodiments, in addition to the slant angle variation and/or the birefringence variation, the PVH formed by the plurality of PVH segments may have a thickness variation in one or more dimensions, e.g., within a plane perpendicular to a thickness direction of the PVH.

In some embodiments, through controlling ingredients of the compositions 817 and 827 dispensed onto the substrate 805, the intensity of the polarization interference formed by two circularly polarized lights 802 and 804, and the intensity of the polarization interference formed by two circularly polarized lights 822 and 824, the first PVH segment 820 and the second PVH segment 830 may be configured to have different photo-induced optical anisotropy (i.e., photo-induced birefringence). For example, the first PVH segment 820 may be configured to have the first photo-induced birefringence, and the second PVH segment 830 may be configured to have the second photo-induced birefringence. The first photo-induced birefringence may be larger than, smaller than, or equal to the second photo-induced birefringence. In some embodiments, through controlling the angle between the two circularly polarized lights 802 and 804, and the angle between the polarization interference formed by two circularly polarized lights 822 and 824, the first PVH segment 820 and the second PVH segment 830 may be configured to have the same or different in-plane pitches. The first PVH segment 820 may have a first in-plane pitch (e.g., an in-plane pitch in the x-axis direction), and the second PVH segment 830 may have a second in-plane pitch (e.g., an in-plane pitch in the x-axis direction). The first in-plane pitch may be the same as or different from the second in-plane pitch.

In some embodiments, a plurality of PVH segments with different photo-induced birefringences may be fabricated based on the disclosed fabrication processes shown in FIGS. 8A-8D. The plurality of PVH segments may be disposed side by side on the substrate 805 to form a PVH 840 shown in FIG. 8D. In some embodiments, the plurality of PVH segments with different photo-induced birefringences and/or different thicknesses may be fabricated through configuring the material of the respective composition forming a composition layer, the respective thickness variation of the composition layer, and intensity of the respective polarization interference irradiated onto the composition layer. As a result, the PVH 840 with a predetermined photo-induced birefringence variation and/or predetermined thicknesses variation in one or more dimensions, e.g., within a plane perpendicular to the thickness direction of the PVH 840 may be obtained. By controlling the chiral dopant or the intrinsic chirality of the composition forming the different PVH segments included in the PVH 840, the PVH 840 may be configured with a slant angle variation in one or more dimensions, e.g., within a plane perpendicular to the thickness direction of the PVH 840. In some embodiments, the PVH 840 formed by a plurality of PVH segments may have any suitable combination of a thickness variation, a birefringence variation, and a slant angle variation in one or more directions within a plane perpendicular to the thickness direction of the PVH 840. Due to at least one of the thickness variation, the birefringence variation, and the slant angle variation, the PVH 840 may have a predetermined diffraction efficiency in one or more dimensions, e.g., within a plane perpendicular to the thickness direction of the PVH 840 for lights with predetermined incidence angles, predetermined incidence wavelengths, and predetermined polarizations.

In some embodiments, as shown in FIGS. 8E and 8F, instead of forming the PVH segments side by side on the substrate 805, the different PVH segments may be stacked on the substrate 805 to form a multi-layer PVH. In some embodiments, the side by side and stacked configurations may be combined to form a PVH. As shown in FIG. 8E, after the first PVH segment 820 (which may also be referred to as a first PVH layer 820 for discussion purposes) is fabricated on the substrate 805, a second PVH segment or layer 860 may be formed on the first PVH layer 820 through the fabrication processes shown in FIGS. 8A and 8B. Additional PVH layers may be formed on the second PVH layer 860. Thus, a multi-layer PVH 870 may be formed. As shown in FIGS. 8E and 8F, an inkjet printer (FIG. 8E merely shows a printhead 836 of the inkjet printer for illustrative purposes) may dispense (e.g., print) a composition 847 on the first PVH layer 820 to form a composition layer 855 having a thickness variation in one or more dimensions, e.g., within a plane perpendicular to the thickness direction of the composition layer 855. The thickness variation in the composition layer 855 may be different from or the same as the thickness variation in the first PVH layer 820. The composition 847 may include one or more photosensitive polymers, such as amorphous polymers, LC polymers, etc., which may generate an induced (e.g., photo-induced) optical anisotropy and induced (e.g., photo-induced) local optic axis orientations when subjected to a polarized light irradiation.

The composition layer 855 may be exposed to a polarization interference formed by two coherent circularly polarized lights 842 and 844 having opposite handednesses to record a 3D polarization field into the composition layer 855. The composition layer 855 may become the second PVH layer 860 with a thickness variation in one or more dimensions, e.g., within a plane perpendicular to the thickness direction of the second PVH layer 860. For illustrative purposes, FIG. 8E shows that the second PVH layer 860 has a thickness variation in the x-axis direction along the surface of the substrate 805. In some embodiments, the multi-layer PVH 870 including the first PVH layer 820 and the second PVH layer 860 may have a uniform thickness across the multi-layer PVH 870.

In some embodiments, each of the multiple layers (including the first PVH layer 820 and the second PVH layer 860) may have a uniform birefringence. In some embodiments, the birefringences of the multiple layers (including the first PVH layer 820 and the second PVH layer 860) may be the same. In some embodiments, the birefringences of the multiple layers (including the first PVH layer 820 and the second PVH layer 860) may be different, and may form a birefringence variation in at least one dimension. For example, the birefringence variation may be along the vertical direction (e.g., the stacking direction of the multiple layers), as shown in FIG. 8G and as described below.

In some embodiments, each of the multiple layers (including the first PVH layer 820 and the second PVH layer 860) may have a uniform slant angle. In some embodiments, the slant angles of the multiple layers (including the first PVH layer 820 and the second PVH layer 860) may be the same. In some embodiments, the slant angles of the multiple layers (including the first PVH layer 820 and the second PVH layer 860) may be different, and may form a slant angle variation in at least one dimension. For example, the slant angle variation may be in the vertical direction (e.g., the stacking direction of the multiple layers), as shown in FIG. 8G and as described below.

Referring to FIG. 8E and FIG. 8F, in some embodiments, through configuring the ingredients of the compositions 847 and 827, the intensity of the polarization interference formed by two circularly polarized lights 802 and 804, and/or the intensity of the polarization interference formed by two circularly polarized lights 842 and 844, the first PVH layer 820 and the second PVH layer 860 may be configured to have different photo-induced optical anisotropy (i.e., photo-induced birefringence). For example, the first PVH layer 820 may be configured to have a first photo-induced birefringence. The second PVH layer 860 may be configured to have a second photo-induced birefringence. The first photo-induced birefringence and the second photo-induced birefringence may be the same or may be different. In some embodiments, the first photo-induced birefringence of the first PVH layer 820 may be larger than or smaller than the second photo-induced birefringence of the second PVH layer 860.

In some embodiments, the plurality of PVH layers included in the multi-layer PVH 870 may be fabricated with predetermined photo-induced birefringences, slant angles, and/or thicknesses through configuring the material forming the respective composition layer, the chiral dopant, the respective thickness variation of the composition layer in a predetermined dimension, intensity of the respective polarization interference irradiated onto the composition layer, and/or an angle between the two circularly polarized lights irradiated onto the composition layer. As a result, the multi-layer PVH 870 may have a predetermined photo-induced birefringence variation, a predetermined slant angle variation, and/or a predetermined thicknesses variation in the thickness direction (i.e., the vertical direction) the PVH 870. Accordingly, the PVH 870 with a predetermined diffraction efficiency.

In some embodiments, the in-plane pitches (e.g., the pitch in a direction in the x-y plane) of the first PVH layer 820 and the second PVH layer 860 may be substantially the same, and the vertical pitch (e.g., the pitch in the thickness direction) of the second PVH layer 860 may be configured to be about half of the vertical pitch of the first PVH layer 820. The first PVH layer 820 may have a relatively large thickness and the second PVH layer 860 may have a relatively small thicknesses. The multi-layer PVH 870 may be configured to reduce the rainbow effect in the AR/MR combiner. The second PVH layer 860 may be configured to suppress undesirable diffraction orders of the first PVH layer 820, such that the rainbow effect may be reduced.

For illustrative purposes, FIG. 8F shows that the multi-layer PVH 870 may have a rectangular cross section in the x-z plane. The multi-layer PVH 870 may have any suitable shape for the x-z plane cross section. In some embodiments, the PVH 870 may have at least one (e.g., two or more) of a thickness variation, a birefringence variation, or a slant angle variation in one or more dimensions, e.g., within a plane perpendicular to a thickness direction of the PVH 870. In some embodiments, the PVH 870 may have at least one of a birefringence variation or a slant angle variation in a thickness direction of the PVH 870.

FIG. 8G illustrates a multi-layer PVH 890 that includes a plurality of PVH layers, e.g., a first PVH layer 891 and a second PVH layer 892. Each PVH layer may include a plurality of PVH segments. For example, the first PVH layer 891 may include a first PVH segment 891a, a second PVH segment 891b, and a third PVH segment 891c. The second PVH layer 892 may include a first PVH segment 892a, a second PVH segment 892b, and a third PVH segment 892c. At least one of the PVH layers included in the multi-layer PVH 890 may have at least one of a predetermined thickness variation, a predetermined birefringence variation, or a predetermined slant angle variation in one or more dimensions (or directions), e.g., within a plane perpendicular to a thickness direction of the PVH layer.

In the embodiment shown in FIG. 8G, each PVH layer may be configured to have a thickness variation, a birefringence variation, and a slant angle variation along the x-axis direction. In each PVH layer, each of the first PVH segment, the second PVH segment, and the third PVH segment may have a uniform birefringence and a uniform slant angle across the PVH segment. In each PVH layer, the thickness, the birefringence, and the slant angle may vary from one PVH segment to another segment. For example, each of the first PVH segment 892a, the second PVH segment 892b, and the third PVH segment 892c in the second PVH layer 892 may have a uniform thickness, a uniform birefringence, and a uniform slant angle across the PVH segment. The first PVH segment 892a may be configured to have the smallest thickness, the smallest birefringence, and the smallest slant angle. The third PVH segment 892c may be configured to have the largest thickness, the largest birefringence, and the largest slant angle. The second PVH segment 892b may be configured to have the medium thickness, the medium birefringence, and the medium slant angle. For example, each of the first PVH segment 891a, the second PVH segment 891b, and the third PVH segment 891c in the first PVH layer 891 may have a uniform birefringence and a uniform slant angle across the PVH segment, and a thickness variation along the x-axis direction. The first PVH segment 891a may be configured to have the smallest thickness, the smallest birefringence, and the smallest slant angle. The third PVH segment 891c may be configured to have the largest thickness, the largest birefringence, and the largest slant angle. The second PVH segment 891b may be configured to have the medium thickness, the medium birefringence, and the medium slant angle. As a result of the thickness variation, the birefringence variation, and/or the slant angle variation in the two PVH layers 891a and 891b, the multi-layer PVH 890 may have a diffraction efficiency variation in one or more dimensions, e.g., within a plane perpendicular to the thickness direction of the multi-layer PVH 890, for lights with predetermined incidence angles, predetermined incidence wavelengths, and predetermined polarizations.

In some embodiments, the in-plane pitches (e.g., the pitch in a direction in the x-y plane) of the first PVH layer 891 and the second PVH layer 892 may be substantially the same, and the vertical pitch (e.g., the pitch in the thickness direction) of the second PVH layer 892 may be configured to be about half of the vertical pitch of the first PVH layer 891. The thickness of the first PVH layer 891 may be relatively large and the thickness of the second PVH layer 892 may be relatively small. The PVH layer 892 may be configured to suppress undesirable diffraction orders of the PVH layer 891, such that the rainbow effect may be reduced.

For discuss purposes, FIG. 8G shows the birefringences of the PVH segment 891a and 892a may be substantially the same, the birefringences of the PVH segment 891b and 892b may be substantially the same, and the birefringences of the PVH segment 891c and 892c may be substantially the same. The birefringences of the PVH segment 891a and 892a may be the smallest, the birefringences of the PVH segment 891c and 892c may be the largest, and the birefringences of the PVH segment 891b and 892b may be between the birefringences of the PVH segment 891a and 892a may be the smallest and the birefringences of the PVH segment 891c and 892c. Although not shown, in some embodiments, the birefringences of the PVH segment 891a and 892a may be different, the birefringences of the PVH segment 891b and 892b may be different, and/or the birefringences of the PVH segment 891c and 892c may be different.

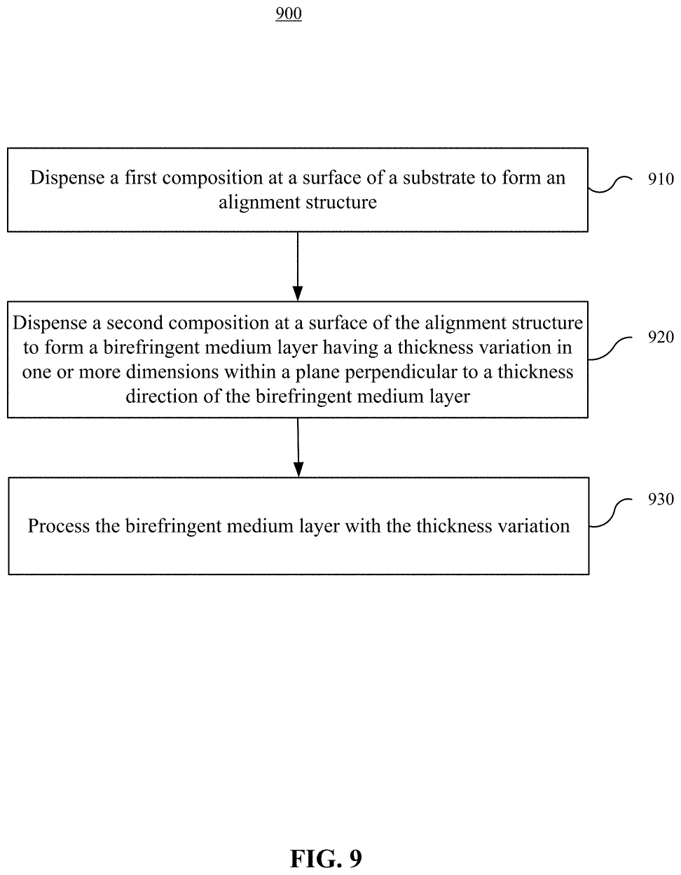

FIG. 9 illustrates a flowchart showing a method 900 for fabricating a PVH, according to an embodiment of the present disclosure. As shown in FIG. 9, the method 900 may include forming a plurality of films, layers, or structures on a substrate. Various processes may be used for forming the different films, layers, or structures. For example, the various films, layers, or structures may be formed through dispensing (e.g., coating, depositing, printing, etc.) a corresponding composition or mixture, and processing (e.g., curing, drying, rubbing, and/or subjecting to a light irradiation, etc.) the composition to change a state or a property of the composition or mixture (e.g., liquid to solid, polymerization, isotropy to anisotropy, alignment, etc.). Detailed descriptions of the materials for the composition or mixture and the processes of forming the various films, layers, or structures may refer to the descriptions rendered above, e.g., including those rendered in connection with FIGS. 2A-2D and FIGS. 3A-3C.

As shown in FIG. 9, the method 900 may include dispensing (e.g., coating, depositing, printing, etc.) a first composition at a surface of a substrate to form an alignment structure (Step 910). The alignment structure may be configured to provide a spatially varying alignment pattern, e.g., a linearly periodic alignment pattern with a uniform period (or pitch). In some embodiments, forming the first alignment structure in Step 910 may also include processing (e.g., curing, drying, rubbing, and/or subjecting to a light irradiation, etc.) the first composition dispensed at the surface of the substrate to form the alignment structure. The first composition may be any of the disclosed materials or compositions for forming an alignment structure. In some embodiments, the first composition may include a photo-alignment material (“PAM”). Dispensing (e.g., coating, depositing, printing, etc.) the first composition to form the alignment structure may also include dispensing (e.g., coating, depositing, printing, etc.) the PAM to form an PAM layer on the surface of the substrate, and exposing the PAM layer to a polarization interference formed by two circularly polarized lights having opposite handednesses.

The method 900 may also include dispensing (e.g., coating, depositing, printing, etc.) a second composition at (e.g., on) a surface of the alignment structure to form a birefringent medium layer with a thickness variation in one or more dimensions, e.g., within a plane perpendicular to a thickness direction of the birefringent medium layer (Step 920). In some embodiments, the second composition may include a birefringent medium having an induced or intrinsic chirality. The second composition may be any of the disclosed materials or compositions for forming a birefringent medium layer. In some embodiments, dispensing the second composition at the surface of the alignment structure to form the birefringent medium layer with a thickness variation in one or more dimensions, e.g., within a plane perpendicular to the thickness direction of the birefringent medium layer may include printing, using an inkjet printer, a layer of the second composition onto the alignment structure to form a birefringent medium layer having a thickness variation in one or more dimensions, e.g., within a plane perpendicular to the thickness direction of the birefringent medium layer. In some embodiments, printing, using the inkjet printer, the layer of the second composition onto the alignment structure to form the birefringent medium layer having the thickness variation may also include: controlling driving voltage waveforms applied to a flow control device to dispense droplets of the second composition with predetermined volumes at predetermined locations of the alignment structure.

The method 900 may also include processing the birefringent medium layer with the thickness variation (Step 930). In some embodiments, processing the birefringent medium layer may include polymerizing (e.g., photo-polymerizing or thermally polymerizing) the birefringent medium layer. In some embodiments, the polymerized birefringent medium layer may be referred to as a PVH.

In some embodiments, the method 900 may omit one or more steps shown in FIG. 9. For example, in some embodiments, a substrate with a separately formed or integrally formed alignment structure may be directly provided, and the method 900 may not include Step 910. In some embodiments, the method 900 may include additional steps. For example, the polymerized birefringent medium layer formed in Step 930 may be a first polymerized birefringent medium layer, and the method 900 may also include forming one or more additional polymerized birefringent medium layers on the first polymerized birefringent medium layer. For example, the method 900 may also include dispensing (e.g., coating, depositing, printing, etc.) a third composition at (e.g., on) a surface of the first polymerized birefringent medium layer to form a second birefringent medium layer with a thickness variation in one or more dimensions, e.g., within a plane perpendicular to the thickness direction of the second birefringent medium layer. The third composition may be the same as or different from the second composition. The thickness variation in the second birefringent medium layer and the thickness variation in the first birefringent medium layer may have the same variation profile or different variation profiles. Forming the second birefringent medium layer may also include printing the third composition in a manner similar to the manner in which the second composition is printed in forming the first birefringent medium layer. The method 900 may also include processing the second birefringent medium layer. Processing the second birefringent medium layer may include polymerizing the second birefringent medium layer. In some embodiments, the first polymerized birefringent medium layer formed in Step 930 may be a first PVH layer, and the second birefringent medium layer after polymerization (a second polymerized birefringent medium layer) may be a second PVH layer. Thus, a multi-layer PVH may be obtained.

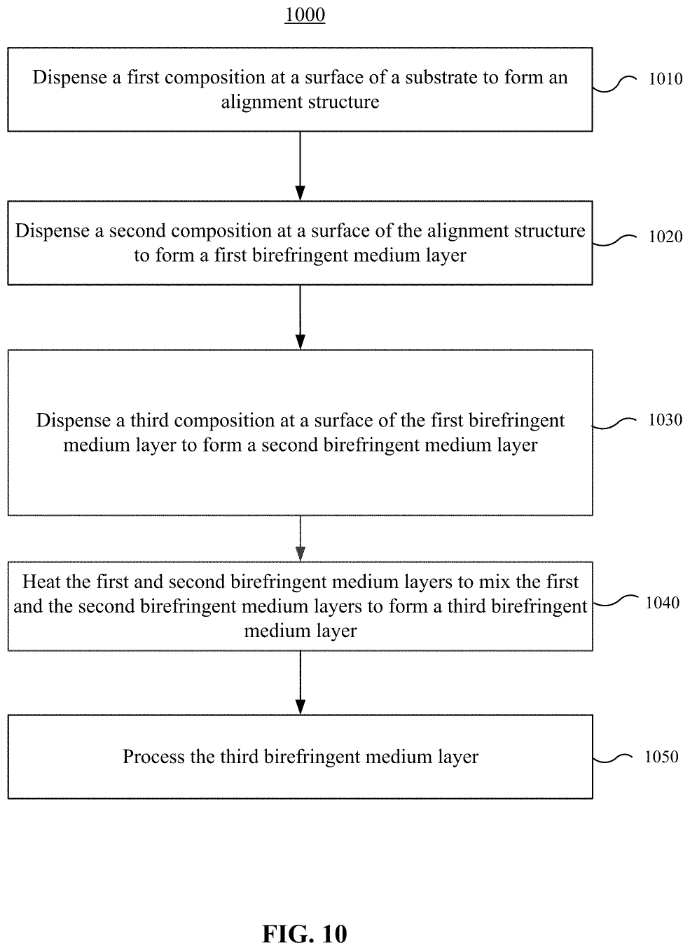

FIG. 10 illustrates a flowchart showing a method 1000 for fabricating a PVH, according to an embodiment of the present disclosure. As shown in FIG. 10, the method 1000 may include forming a plurality of films, layers, or structures on a substrate. Various processes may be used for forming the different films, layers, or structures. For example, the various films, layers, or structures may be formed through dispensing (e.g., coating, depositing, printing, etc.) a corresponding composition or mixture, and processing (e.g., curing, drying, rubbing, and/or subjecting to a light irradiation, etc.) the composition to change a state or a property of the composition or mixture (e.g., liquid to solid, polymerization, isotropy to anisotropy, alignment, etc.). Detailed descriptions of the materials for the composition or mixture and the processes of forming the various films, layers, or structures may refer to the descriptions rendered above, e.g., including those rendered in connection with FIGS. 3A-3C, FIGS. 4A-4F, and FIGS. 6A-6E.

The method 1000 shown in FIG. 10 may include steps similar to those included in the method 900 shown in FIG. 9. Descriptions of the similar steps and similar elements can refer to the descriptions rendered above in connection with FIG. 9. As shown in FIG. 10, the method 1000 may include dispensing (e.g., coating, depositing, printing, etc.) a first composition at a surface of a substrate to form an alignment structure (Step 1010). Step 1010 may be similar to Step 910 shown in FIG. 9. The method 1000 may also include dispensing (e.g., coating, depositing, printing, etc.) a second composition at (e.g., on) a surface of the alignment structure to form a first birefringent medium layer (Step 1020). The method 1000 may also include dispensing (e.g., coating, depositing, printing, etc.) a third composition at (e.g., on) a surface of the first birefringent medium layer to form a second birefringent medium layer (Step 1030). At least one of the first birefringent medium layer or the second birefringent medium layer may have a thickness variation in one or more dimensions, e.g., within a plane perpendicular to the thickness direction of the at least one of the first birefringent medium layer or the second birefringent medium layer. When both the first birefringent medium layer and the second birefringent medium layer have a respective thickness variation, the thickness variations in the two layers may have the same variation profile or may have different variation profiles. The second composition may include a first birefringent medium with a first induced or intrinsic chirality and a first birefringence. The third composition may include a second birefringent medium with a second induced or intrinsic chirality and a second birefringence. The first birefringence may be the same as or different from the second birefringence. The first chirality may be the same as or different from the second chirality. In some embodiments, the first birefringent medium and the second birefringent medium may have a substantially same birefringence and different chiralities. In some embodiments, the first birefringent medium and the second birefringent medium may have different birefringences and a substantially same chirality. In some embodiments, the first birefringent medium and the second birefringent medium may have different birefringences and different chiralities.

In some embodiments, dispensing the second composition may include printing, using an inkjet printer, a layer of the second composition onto the alignment structure to form the first birefringent medium layer. In some embodiments, printing, using the inkjet printer, the layer of the second composition onto the alignment structure to form the first birefringent medium layer may also include: controlling driving voltage waveforms applied to a flow control device coupled to a printhead of the inkjet printer to dispense droplets of the second composition with first predetermined volumes at predetermined locations of the alignment structure.

In some embodiments, dispensing the third composition may include printing, using an inkjet printer, a layer of the third composition onto the first birefringent medium layer to form the second birefringent medium layer. In some embodiments, printing, using the inkjet printer, the layer of the third composition onto the first birefringent medium layer to form the second birefringent medium layer may also include: controlling driving voltage waveforms applied to a flow control device coupled to a printhead of the inkjet printer to dispense droplets of the third composition with second predetermined volumes onto the corresponding predetermined locations of the first birefringent medium layer.

Through dispensing the droplets of the second composition with the first predetermined volumes at the predetermined locations of the alignment structure, and dispensing the droplets of the third composition with the second predetermined volumes at the corresponding predetermined locations of the first birefringent medium layer, ratios between the volumes of the droplets of the second composition and the volumes of the droplets of the third composition sequentially dispensed at the predetermined locations of the alignment structure may be configured to be predetermined ratios. In some embodiments, different printheads of the inkjet printer may be used to print the first birefringent medium layer and the second birefringent medium layer, respectively. In some embodiments, the same printhead (or printheads) of a same inkjet printer may be used to print the first birefringent medium layer and the second birefringent medium layer. The same printhead or same group of printheads may be supplied with different materials when printing different layers.

The method 1000 may also include heating the first and second birefringent medium layers to mix the first and second birefringent medium layers to form a third birefringent medium layer (Step 1040). In the third birefringent medium layer, the second and third compositions are mixed together. In some embodiments, the first birefringent medium layer and the second birefringent medium layer may be heated to a temperature that is close to a nematic-to-isotropic transition point of a mixture of the first composition or the second composition. The method 1000 may also include processing the third birefringent medium layer (Step 1050). In some embodiments, processing the third birefringent medium layer may include polymerizing (e.g., photopolymerizing or thermally polymerizing) the third birefringent medium layer. In some embodiments, the polymerized third birefringent medium layer may be referred to as a PVH. The PVH may have at least one (e.g., two or more) of a thickness variation, a birefringence variation, or a slant angle variation in one or more dimensions, e.g., within a plane perpendicular to a thickness direction of the PVH, or in a vertical direction when the PVH is a multi-layer PVH. Thus, the PVH fabricated through the disclosed methods may have at least one (e.g., two or more) of a thickness variation, a birefringence variation, or a slant angle variation in one or more dimensions.

In some embodiments, the method 1000 may omit one or more steps shown in FIG. 10. For example, in some embodiments, a substrate with a separately formed or integrally formed alignment structure may be directly provided, and the method 1000 may not include Step 1010. In some embodiments, the method 1000 may include additional steps. For example, after Step 1030 and before Step 1040, the method 1000 may include forming one or more additional birefringent medium layers on the second birefringent medium layer. For example, the method 1000 may include dispensing a fourth composition at a surface of the second birefringent medium layer to form a third birefringent medium layer. At least one of the first birefringent medium layer, the second birefringent medium layer, or the third birefringent medium layer having a thickness variation in one or more dimensions, e.g., within a plane perpendicular to a thickness direction of the at least one of the first birefringent medium layer, the second birefringent medium layer, or the third birefringent medium layer. The fourth composition may include a third birefringent medium having an induced or intrinsic chirality. Forming the third birefringent medium layer may include printing the fourth composition in a manner similar to the manner in which the second composition is printed in forming the first birefringent medium layer, or in a manner similar to the manner in which the third composition is printed in forming the second birefringent medium layer. In some embodiments, the method 1000 may include heating the first, second, and third birefringent medium layers to mix the first, second, and third birefringent medium layers to form a fourth birefringent medium layer. In the fourth birefringent medium layer, the second, third, and fourth compositions are mixed together. In some embodiments, the method 1000 may include processing (e.g., polymerizing) the fourth birefringent medium layer. In some embodiments, the polymerized fourth birefringent medium layer may be referred to as a PVH. The PVH may have at least one (e.g., two or more) of a thickness variation, a birefringence variation, or a slant angle variation in one or more dimensions, e.g., within a plane perpendicular to a thickness direction of the PVH, or in a vertical direction when the PVH is a multi-layer PVH.

In some embodiments, the PVH formed in Step 1050 may be a first PVH layer. In some embodiments, the method 1000 may also include forming one or more additional PVH layers on the first PVH layer to form a multi-layer PVH. In some embodiments, the method 1000 may include forming each of the one or more additional PVH layers in a manner similar to the manner in which the first PVH layer is formed. That is, the method 1000 may include forming an alignment structure for each additional PVH layer. The alignment structures in the multi-layer PVH may be the same or different from one another. In some embodiments, forming each additional PVH layer may include forming two or more birefringent medium layers, heating the two or more birefringent medium layers to mix the two or more birefringent medium layers together to form a mixed birefringent medium layer, and processing (e.g., polymerizing) the mixed birefringent medium layer.

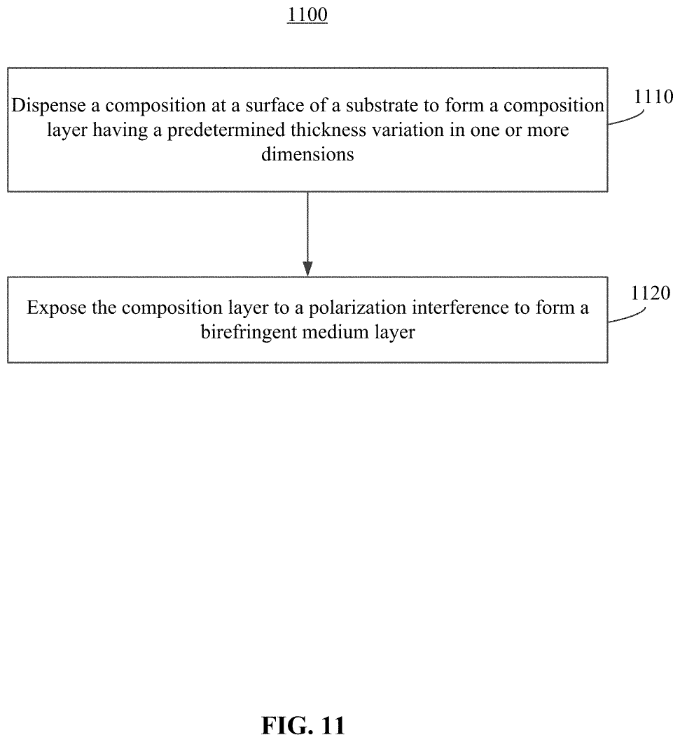

FIG. 11 illustrates a flowchart showing a method 1100 for fabricating a PVH, according to an embodiment of the present disclosure. As shown in FIG. 11, the method 1100 may include forming a plurality of films or layers, or structures on a substrate. Various processes may be used for forming the different films, layers, or structures. For example, the various films, layers, or structures may be formed through dispensing (e.g., coating, depositing, printing, etc.) a corresponding composition or mixture, and processing (e.g., curing, drying, rubbing, and/or subjecting to a light irradiation, etc.) the composition to change a state or a property of the composition or mixture (e.g., liquid to solid, polymerization, isotropy to anisotropy, alignment, etc.). Detailed descriptions of the materials for the composition or mixture and the processes of forming the various films, layers, or structures may refer to the descriptions rendered above, e.g., including those rendered in connection with FIGS. 3A-3C and FIGS. 8A-8F.

The method 1100 shown in FIG. 11 may include steps similar to those included in the method 900 shown in FIG. 9 and the method 1000 shown in FIG. 10. Descriptions of the similar steps and similar elements can refer to the descriptions rendered above in connection with FIG. 9 and FIG. 10. As shown in FIG. 11, the method 1100 may include dispensing (e.g., coating, depositing, printing, etc.) a composition at (e.g., on) a surface of a substrate to form a composition layer having a predetermined thickness variation in one or more dimensions (Step 1110). For example, the one or more dimensions may be within a plane perpendicular to a thickness direction of the composition layer. In some embodiments, the composition may include one or more photosensitive polymers, such as amorphous polymers, LC polymers, etc., which may generate an induced (e.g., photo-induced) optical anisotropy and induced (e.g., photo-induced) local optic axis orientations when subjected to a polarized light irradiation. In some embodiments, dispensing the composition on the surface of the substrate to form the composition layer in Step 1110 may include printing, using an inkjet printer, a layer of the composition onto the substrate to form the composition layer. In some embodiments, printing, using the inkjet printer, the layer of the composition onto the substrate to form the composition layer may include: controlling driving voltage waveforms applied to a flow control device coupled to a printhead of the inkjet printer to dispense droplets of predetermined volumes of the composition at predetermined locations of the substrate. The method 1100 may also include exposing the composition layer to a polarization interference to form a birefringent medium layer (Step 1120). In some embodiments, the birefringent medium layer may be a PVH. In some embodiment, the polarization interference may be formed by two circularly polarized lights having opposite handednesses. In some embodiments, the method 1100 may also include annealing the composition layer at a predetermined elevated temperature after the composition layer is exposed to the polarization interference. As a result, the photo-induced optical anisotropy in the composition layer may be enhanced.

In some embodiments, the method 1100 may include additional steps. For example, the PVH formed in Step 1120 may be a first PVH layer, the method 1100 may include forming one or more additional PVH layers on the first PVH layer by repeating Step 1110 and Step 1120. As a result, a multi-layer PVH may be formed. In some embodiments, each PVH layer may have a uniform birefringence, a uniform slant angle, and a thickness variation in at least one dimension, e.g., within a plane perpendicular to a thickness direction of the PVH. The birefringences and the slant angles of the multiple layers may be the same or may be different. In some embodiments, the thickness variations of the multiple layers in at least one dimension, e.g., within a plane perpendicular to a thickness direction of the multi-layer PVH, may have the same variation profile or may have different variation profiles. In some embodiments, the different thickness variations of the multiple layers may result in a uniform thickness or a varying thickness across the multi-layer PVH. In some embodiments, the birefringence of the multi-layer PVH may vary along the vertical direction. In some embodiments, the slant angle of the multi-layer PVH may vary along the vertical direction. Detailed descriptions of the multi-layer PVH may refer to the descriptions rendered in connection with FIG. 8G.

In some embodiments, the PVH formed in Step 1120 may be a first PVH segment, the method 1100 may include forming one or more additional PVH segments disposed adjacent (e.g., side by side with) the first PVH segment on the substrate by repeating Step 1110 and Step 1120. As a result, a PVH including a plurality of PVH segments may be formed. In some embodiments, each PVH segment may have a thickness variation in a direction (e.g., x-axis direction) along the surface of the substrate. In some embodiments, the thickness variations in the different segments may have different variation profiles. As a result, the PVH formed by the plurality of PVH segments disposed side by side on the surface of the substrate may have a thickness variation in at least one dimension (e.g., in the x-axis direction) along the surface of the substrate. In some embodiments, compositions forming the plurality of PVH segments may be configured to have different slant angles and/or different birefringences. As a result, the PVH formed by the plurality of PVH segments disposed side by side on the substrate may have at least one (e.g., two or more) of a thickness variation, a birefringence variation, or a slant angle variation in at least one dimension (e.g., in the x-axis direction) along the surface of the substrate.

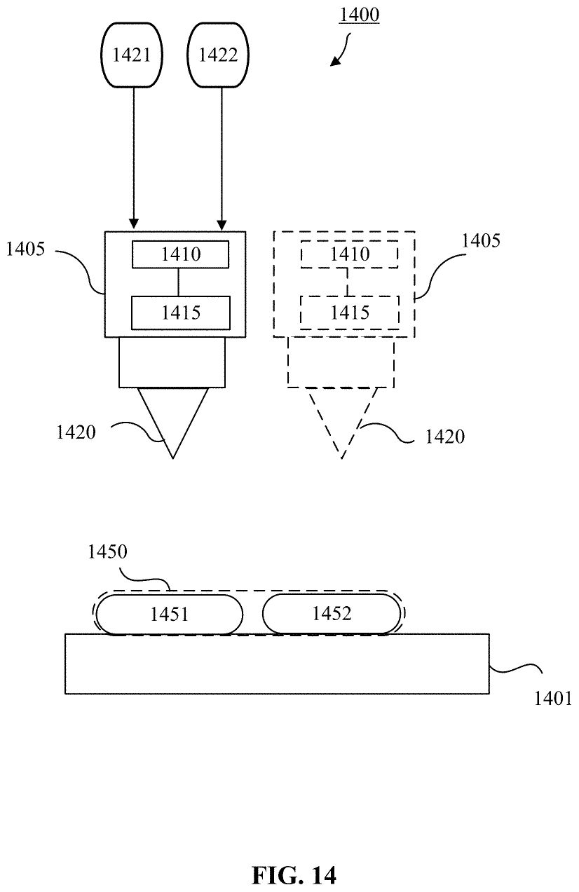

FIG. 14 schematically illustrates a fabrication system and method for fabricating a birefringent medium layer, such as a PVH disclosed herein, according to an embodiment of the present disclosure. In some embodiments, the method may include in-line heated mixing of one or more LC materials of different indices of refraction (an index of refraction may be, e.g., an extraordinary refractive index, an ordinary refractive index, an average refractive index, and/or an effective refractive index). In some embodiments, the method may include in-line headed mixing of one or more LC materials in combination with one or more alternative polymers with at least two different indices of refraction. In some embodiments, the method may include in-line solvent mixing of one or more LC materials of different indices of refraction. In some embodiments, the method may include in-line solvent mixing of one or more LC materials in combination with one or more alternative polymers with at least two different indices of refraction.

FIG. 14 shows an inkjet printer 1400 including a plurality of composition storages 1421 and 1422 configured to store a first composition and a second composition, respectively. Each of the first composition and the second composition may include an LC material or a polymer. For example, in some embodiments, the first composition and the second composition may be embodiments of the composition 417 and the composition 427 used in the fabrication processes shown in FIGS. 4A-4D, respectively. In some embodiments, the first composition and the second composition may be embodiments of the composition 817 and the composition 827 used in the fabrication processes shown in FIGS. 8A-8D, respectively. Although two storages are shown, the inkjet printer 1400 may include more than two composition storages, for example, when more than two compositions are used to form a mixture to provide a desirable property. The inkjet printer 1400 is an illustrative example of a fabrication system or a part of the fabrication system. The fabrication system may be any other suitable device or system for fabricating the birefringent medium films or layers, such as PVHs disclosed herein according to the disclosed methods or processes. The inkjet printer 1400 may include a printhead 1405. The printhead 1405 may include a composition amount controller 1410 and a mixer 1415. The composition amount controller 1410 may be coupled with the composition storages 1421 and 1422, and may receive a supply of the first composition and the second composition from the composition storages 1421 and 1422. The composition amount controller 1410 may control the amount of each of the first composition and the second composition, such that a ratio of the amounts (e.g., volumes) of the first composition and the second composition may be controlled to be a predetermined ratio or within a predetermined ratio range.

The first composition and the second composition may be mixed in the mixer 1415 to form a mixture. In some embodiments, the mixer 1415 may be a chamber. In some embodiments, the mixer 1415 may include a chamber with a solvent for dissolving the first composition and the second composition such that the first composition and the second composition may be uniformly mixed. In some embodiments, the mixer 1415 may include an agitator to achieve a uniform mixing of the first composition and the second composition. In some embodiments, the mixer 1415 may include a chamber with a heater for heating the first composition and the second composition such that the first composition and the second composition may be uniformly mixed. The printhead 1405 may also include a nozzle 1420 configured to dispense the mixture onto a substrate 1401. The printhead 1405 may be dispense the mixture with the first composition and the second composition mixed according to a first ratio (e.g., a ratio in volumes) at a first location to form a first droplet or a first portion 1451 of a composition layer. The printhead 1405 may move to a location over a second location of the substrate 1401 and dispense the mixture with the first composition and the second composition mixed according to a second ratio (as controlled by the composition amount controller 1410) at the second location to form a second droplet or a second portion 1452 of the composition layer. In FIG. 14, the printhead 1405 at the location over the second location of the substrate 1401 is shown in dashed lines. In some embodiments, the inkjet printer 1400 may include a plurality of printheads each connected with the composition storages 1421 and 1422, and the dashed printhead may represent another printhead located over the second location of the substrate 1401. Although for illustrative purposes, the droplets or portions 1451 and 1452 are shown with a gap, there may be no gap between the droplets or layers 1451 and 1452. The printhead 1405 may continue to move to other locations on the substrate 1401 to dispense the mixture at those locations with the first composition and the second composition mixed at a respective ratio. The ratios of the first composition and the second composition may be different for different locations. All of the droplets or portions may form an overall composition layer 1450. In some embodiments, the substrate 401 may be provided with an alignment structure, and the composition layer 1450 may be formed on the alignment structure. The composition layer 1450 may be a birefringent medium layer having at least one (e.g., two or more) of a thickness variation, a slant angle variation, or a birefringence variation in at least one dimension of the composition layer 1450. In some embodiments, the composition layer 1450 may be polymerized to form a PVH. In some embodiments, a stack of multiple PVHs may be formed on the substrate 1401 by repeating the above fabrication processes.

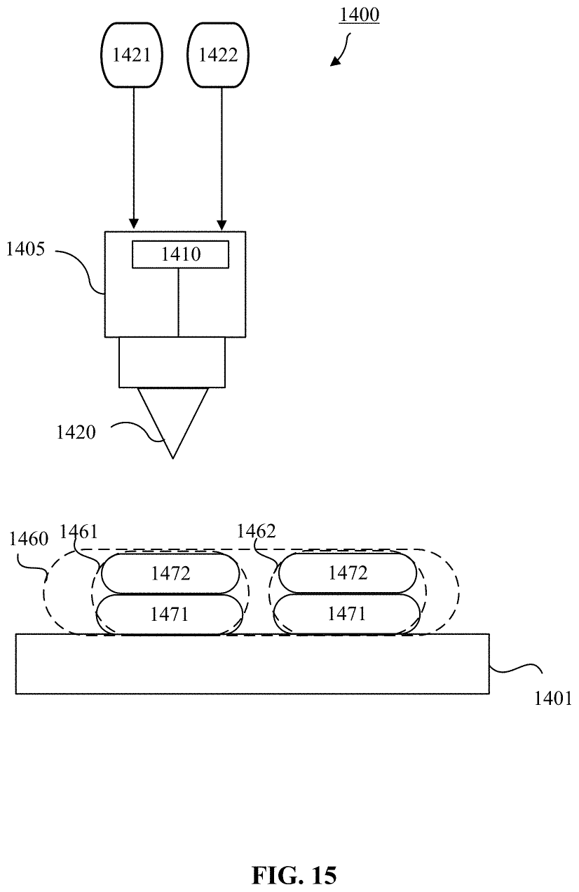

FIG. 15 schematically illustrates a fabrication system and method for fabricating a birefringent medium layer, such as a PVH disclosed herein, according to another embodiment of the present disclosure. As shown in FIG. 15, the printhead 1405 may not include a mixer 1415. The composition amount controller 1410 may control one of the first composition or the second composition to be supplied to the nozzle 1420 at a predetermined amount for dispensing. For example, at a first time instance, the composition amount controller 1410 may control a first amount of the first composition to be supplied from the composition storage 1421 to the nozzle 1420 for dispensing. The nozzle 1420 may dispense the first composition at the first amount onto a first location of the substrate 1401 as a first droplet or first composition layer 1471. At a second time instance, the composition amount controller 1410 may control a second amount of the second composition to be supplied from the composition storage 1422 to the nozzle 1420 for dispensing. The nozzle 1420 may dispense the second composition at the second amount onto the first composition dispensed at the first location on the substrate 1401 as a second droplet or second composition layer 1472. The first composition in the first droplet or first composition layer 1471 and the second composition in the second droplet or second composition layer 1472 may be mixed by a suitable process (e.g., heating, dissolving in a solvent), on the substrate 1401 at the first location to form a first portion or mixture 1461. The ratio of between the first amount (e.g., first volume) of the first composition and the second amount (e.g., second volume) of the second composition in the first portion 1461 may be a predetermined first ratio or may be within a predetermined ratio range.

In some embodiments, the printhead 1405 may be moved to a location over a second location on the substrate 1401 to dispense the first composition and the second composition at the second location, as described above, to form a second portion or mixture 1462, in which a ratio between the first amount of the first composition and the second amount of the second composition is a predetermined second ratio or is within a predetermined ratio range. For simplicity of illustration, the moved printhead 1405 at the location over the second location of the substrate 1401 is not shown in FIG. 15. Alternatively, there may be a plurality of printheads each positioned above a location on the substrate 1401 for dispensing the first composition and the second composition to the specific location at a specific ratio. The ratios at different locations may be different. For example, at least two ratios at at least two locations may be different. Different portions (including 1461 and 1462) at different locations may form an overall composition layer 1460. In some embodiments, the substrate 401 may be provided with an alignment structure, and the composition layer 1460 may be formed on the alignment structure. The composition layer 1460 may be a birefringent medium layer having at least one (e.g., two or more) of a thickness variation, a slant angle variation, or a birefringence variation in at least one dimension of the composition layer 1460. In some embodiments, the composition layer 1460 may be polymerized to form a PVH. In some embodiments, a stack of multiple PVHs may be formed on the substrate 1401 by repeating the above fabrication processes. In any of the processes shown in FIG. 14 and FIG. 15, additional processes disclosed herein may also be included. For example, in the processes shown in FIG. 14, after the mixture having the first composition and the second composition mixed according to the first ratio is dispensed at the first location to form the first droplet or the first portion 1451 of the overall composition layer 1450, the first portion 1451 may be polymerized. After the mixture having the first composition and the second composition mixed according to the second ratio is dispensed at the second location to form the second droplet or the second portion 1452 of the overall composition layer 1450, the second portion 1452 may be polymerized. In some embodiments, the polymerization may be performed after the first mixture 1461 and the second mixture 1462 are formed.

In some embodiments, additional processes may be included in the processes described above in connection with FIG. 15. For example, at the first location of the substrate 1401, after an amount of the first composition and an amount of the second composition are dispensed according to the first ratio to obtain the first mixture 1461, the first mixture 1461 may be polymerized to obtain the first portion 1461 of the layer 1460 at the first location. At the second location of the substrate 1401, after an amount of the first composition and an amount of the second composition are dispensed according to the second ratio to obtain the second mixture 1462, the second mixture 1462 may be polymerized to obtain the second portion 1462 of the layer 1460 at the second location. In some embodiments, the polymerization process may be performed on the first mixture 1461 and the second mixture 1462 after the first mixture 1461 and the second mixture 1462 are formed (or dispensed) on the substrate at the first location and the second location to form the layer 1460.

In the processes described above in connection with FIG. 14, in some embodiments, the first composition and the second composition may be heated to mix together in the mixer 1415 then the mixture may be dispensed on the substate 1401. In the processes described above in connection with FIG. 15, in some embodiments, at the first location of the substrate 1401, after an amount of the first composition and an amount of the second composition are dispensed according to a first ratio, the first composition and the second composition at the first location may be heated to mix together to form the first mixture 1461. At the second location of the substrate 1401, after an amount of the first composition and an amount of the second composition are dispensed on the substrate according to a second ratio, the first composition and the second composition may be heated to mix together to form the second mixture 1462.

In the embodiments shown in FIG. 14 and FIG. 15, a solvent may be used to dissolve and mix the first composition and the second composition. For example, in the processes described above in connection with FIG. 14, in some embodiments, the solvent may be injected into the mixer 1415 to dissolve the first composition and the second composition to form a solution for dispensing to the substrate. Thus, the processes described above in connection with the embodiment shown in FIG. 14 may include additional processes. For example, the processes may also include dissolving the first composition and the second composition in a first solvent according to a first ratio to obtain a first mixture (e.g., a first solution). The processes may also include dissolving the first composition and the second composition in a second solvent according to a second ratio to obtain a second mixture (e.g., a second solution). The processes may also include dispensing the first mixture on the substrate 1401 at the first location and removing the first solvent from the first mixture to form the first portion 1451 of the layer 1450. The processes may also include dispensing the second mixture on the substrate 1401 at the second location and removing the second solvent from the second mixture to form the second portion 1452 of the layer 1450. In some embodiments, removing the first solvent and the second solvent to form the first portion 1451 and the second portion 1452 may be performed in a single process after the first mixture and the second mixture are dispensed on the substrate at the first location and at the second location, respectively. In some embodiments, the solvent may not be injected into the mixer 1415. Instead, the solvent may be injected into the composition storages 1421 and 1422, for example, in the embodiment shown in FIG. 15. The solvent may be mixed with the first composition and the second composition in the composition storages 1421 and 1422 to form a first composition solution and a second composition solution, respectively.

In some embodiments, the substrate 1401 may not be provided with an alignment structure. In the processes described above in connection with FIG. 14, in some embodiments, after the first portion 1451 including a mixture of the first composition and the second composition at the first ratio is dispensed on the substrate 1401 at the first location, the first portion 1451 may be exposed to a first polarization interference to form a first birefringent medium layer or a first portion of the birefringent medium layer with a first optic axis having a first varying orientation. After the second portion 1452 including a mixture of the first composition and the second composition at the second ratio is dispensed onto the substrate 1401 at the second location (or dispensed on the exposed first portion 1451), the second portion 1452 may be exposed to a second polarization interference to form a second birefringent medium layer or a second portion of the birefringent medium layer with a second optic axis having a second varying orientation. In the processes described above in connection with FIG. 15, in some embodiments, after the first portion or mixture 1461 is formed onto the substrate 1401, the first portion or mixture 1461 may be exposed to a first polarization interference to form a first birefringent medium layer or a first portion of a birefringent medium layer with a first optic axis having a first varying orientation. After the second portion or mixture 1462 is formed onto the first birefringent medium layer or the first portion of the birefringent medium layer, the first portion or mixture 1461 may be exposed to a second polarization interference to form a second birefringent medium layer or a second portion of the birefringent medium layer with a second optic axis having a second varying orientation.

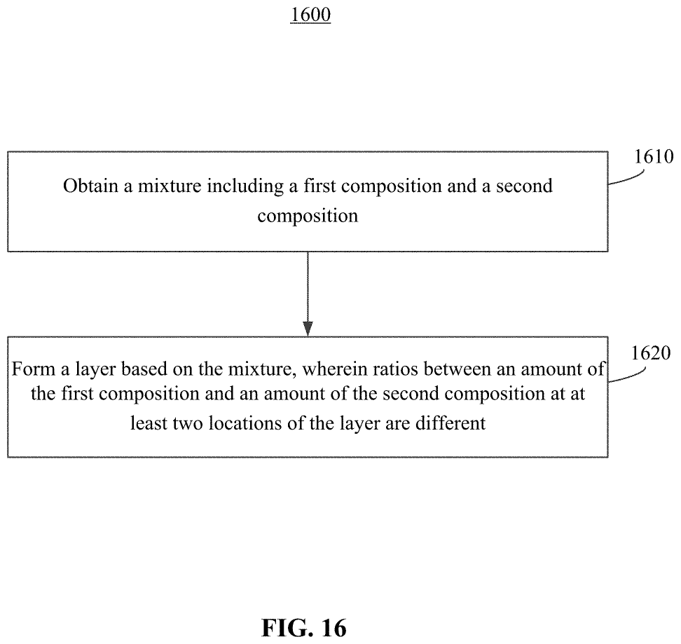

FIG. 16 is a flowchart showing a method 1600 for fabricating a birefringent medium layer, such as a PVH disclosed herein, according to an embodiment of the present disclosure. The method 1600 may include obtaining a mixture including a first composition and a second composition (step 1610). The method may also include forming a layer based on the mixture, wherein ratios between an amount of the first composition and an amount of the second composition at at least two locations of the layer are different (step 1620). In some embodiments, the layer may be a birefringent medium layer having at least one (e.g., two or more) of a thickness variation, a slant angle variation, or a birefringence variation in at least one dimension of the birefringent medium layer. In some embodiments, at least one (e.g., each) of the first composition and the second composition may include an LC material or a polymer. In some embodiments, at least one of the first composition or the second composition is a birefringent medium or becomes a birefringent medium when formed into a birefringent medium layer. In some embodiments, the first composition may have a first birefringence and a first chirality, the second composition may have a second birefringence and a second chirality. The first composition and the second composition may have a difference between at least one of the first birefringence and the second birefringence or the first chirality and the second chirality.

In some embodiments, obtaining the mixture and forming the layer based on the mixture may include mixing an amount of the first composition and an amount of the second composition according to a first ratio to form a first mixture, and dispensing the first mixture to a first location of a substrate. In some embodiments, obtaining the mixture and forming the layer based on the mixture may include mixing an amount of the first composition and an amount of the second composition according to a second ratio to form a second mixture, and dispensing the second mixture to a second location of the substrate. The first mixture at the first location and the second mixture at the second location may have at least one of different thicknesses, different slant angles, or different birefringences.

In some embodiments, obtaining the mixture and forming the layer based on the mixture may include obtaining a first mixture in which an amount of the first composition and an amount of the second composition are mixed according to a first ratio. In some embodiments, obtaining the mixture and forming the layer based on the mixture may include obtaining a second mixture in which an amount of the first composition and an amount of the second composition are mixed according to a second ratio. In some embodiments, obtaining the mixture and forming the layer based on the mixture may include dispensing the first mixture to a first location of a substrate. In some embodiments, obtaining the mixture and forming the layer based on the mixture may include dispensing the second mixture to a second location of the substrate. The first mixture at the first location and the second mixture at the second location may have at least one of different thicknesses, different slant angles, or different birefringences.

In some embodiments, obtaining the mixture and forming the layer based on the mixture may include dispensing an amount of the first composition at a first location and an amount of the second composition at the first location according to a first ratio to obtain a first mixture. In some embodiments, obtaining the mixture and forming the layer based on the mixture may include polymerizing the first mixture to obtain a first portion of the layer at the first location. In some embodiments, obtaining the mixture and forming the layer based on the mixture may include dispensing an amount of the first composition at a second location and an amount of the second composition at the second location according to a second ratio to obtain a second mixture. In some embodiments, obtaining the mixture and forming the layer based on the mixture may include polymerizing the second mixture to obtain a second portion of the layer at the second location.

In some embodiments, obtaining the mixture and forming the layer based on the mixture may include dispensing an amount of the first composition at a first location and an amount of the second composition at the first location according to a first ratio to obtain a first mixture. In some embodiments, obtaining the mixture and forming the layer based on the mixture may include dispensing an amount of the first composition at a second location and an amount of the second composition at the second location according to a second ratio to obtain a second mixture. In some embodiments, obtaining the mixture and forming the layer based on the mixture may include polymerizing the first mixture and the second mixture to form the layer.

In some embodiments, obtaining the mixture and forming the layer based on the mixture may include dispensing, at a first location, an amount of the first composition and an amount of the second composition according to a first ratio. In some embodiments, obtaining the mixture and forming the layer based on the mixture may include heating the first composition and the second composition at the first location to mix the first composition and the second composition to obtain a first mixture. In some embodiments, obtaining the mixture and forming the layer based on the mixture may include polymerizing the first mixture to form a first portion of the layer at the first location. In some embodiments, obtaining the mixture and forming the layer based on the mixture may include dispensing, at a second location, an amount of the first composition and an amount of the second composition according to a second ratio. In some embodiments, obtaining the mixture and forming the layer based on the mixture may include heating the first composition and the second composition to mix the first composition and the second composition at the second location to obtain a second mixture. In some embodiments, obtaining the mixture and forming the layer based on the mixture may include polymerizing the second mixture to form a second portion of the layer at the second location.

In some embodiments, obtaining the mixture and forming the layer based on the mixture may include dissolving the first composition and the second composition in a first solvent according to a first ratio to obtain a first mixture. In some embodiments, obtaining the mixture and forming the layer based on the mixture may include dispensing the first mixture on a substrate at a first location and removing the first solvent from the first mixture to form a first portion of the layer. In some embodiments, obtaining the mixture and forming the layer based on the mixture may include polymerizing the first mixture to form a first portion of the layer at the first location. In some embodiments, obtaining the mixture and forming the layer based on the mixture may include dissolving the first composition and the second composition in a second solvent according to a second ratio to obtain a second mixture. In some embodiments, obtaining the mixture and forming the layer based on the mixture may include dispensing the second mixture on the substrate at a second location and removing the second solvent from the second mixture to form a second portion of the layer. In some embodiments, obtaining the mixture and forming the layer based on the mixture may include polymerizing the second mixture to form a second portion of the layer at the second location.

In some embodiments, obtaining the mixture and forming the layer based on the mixture may include dispensing a first composition on an alignment structure to form a first portion. In some embodiments, obtaining the mixture and forming the layer based on the mixture may include dispensing a second composition on the first portion to form a second portion. In some embodiments, obtaining the mixture and forming the layer based on the mixture may include mixing the first and second portions to form the mixture. In some embodiments, obtaining the mixture and forming the layer based on the mixture may include polymerizing the mixture to form the layer.

In some embodiments, obtaining the first mixture may include mixing an amount of the first composition and an amount of the second composition according to the first ratio. In some embodiments, mixing the amount of the first composition and the amount of the second composition according to the first ratio may include heating the first composition and the second composition to mix the amount of the first composition and the amount of the second composition. In some embodiments, mixing the amount of the first composition and the amount of the second composition according to the first ratio may include dissolving the first composition and the second composition in a first solvent according to the first ratio.

In some embodiments, obtaining the second mixture may include mixing an amount of the first composition and an amount of the second composition according to the second ratio. In some embodiments, mixing the amount of the first composition and the amount of the second composition according to the second ratio may include heating the first composition and the second composition to mix the amount of the first composition and the amount of the second composition. In some embodiments, mixing the amount of the first composition and the amount of the second composition according to the second ratio may include dissolving the first composition and the second composition in a second solvent according to the second ratio.

In some embodiments, the method 1600 may also include forming an alignment structure at (e.g., on and/or at least partially within) the substrate. Forming the layer based on the mixture may include dispensing the first mixture and the second mixture on the alignment structure to form the layer. Molecules in the layer may be aligned at least partially by the alignment structure. In some embodiments, after dispensing the first mixture to the first location of the substrate and before dispensing the second mixture to the second location of the substrate, obtaining the mixture and forming the layer based on the mixture may further include polymerizing the first mixture to obtain a first portion of the layer at the first location. In some embodiments, after dispensing the second mixture to the second location of the substrate, obtaining the mixture and forming the layer based on the mixture may include polymerizing the second mixture to obtain a second portion of the layer at the second location. The first portion of the layer at the first location and the second portion of the layer at the second location may have a difference in at least one (e.g., two or more) of a thickness, a slant angle, or a birefringence. In some embodiments, after dispensing the first mixture to the first location and the second mixture to the second location of the substrate, obtaining the mixture and forming the layer based on the mixture may include polymerizing the first mixture and the second mixture to form the layer. Portions of the layer at the first location and the second portion may have a difference in at least one (e.g., two or more) of a thickness, a slant angle, or a birefringence.

In some embodiments, an alignment structure may not be formed or provided at the substrate. In some embodiments, after dispensing the first mixture to the first location of the substrate and before dispensing the second mixture to the second location of the substrate, obtaining the mixture and forming the layer based on the mixture may further include exposing the first mixture to a first polarization interference to obtain the first portion of the layer at the first location. The first portion of the layer may have a first optic axis having a first varying orientation. In some embodiments, after dispensing the second mixture to the second location of the substrate, obtaining the mixture and forming the layer based on the mixture may include exposing the second mixture to a second polarization interference to obtain the second portion of the layer at the second location. The second portion of the layer may have a second optic axis having a second varying orientation. The first portion of the layer at the first location and the second portion of the layer at the second location may have a difference in at least one (e.g., two or more) of a thickness, a slant angle, or a birefringence. In some embodiments, after dispensing the second mixture to the second location of the substrate, obtaining the mixture and forming the layer based on the mixture may include exposing the first mixture and the second mixture to a polarization interference to form the layer having an optic axis with a varying orientation. Portions of the layer at the first location and the second portion may have a difference in at least one (e.g., two or more) of a thickness, a slant angle, or a birefringence.

In some embodiments, obtaining the mixture and forming the layer based on the mixture may include dispensing, at a first location, an amount of the first composition and an amount of the second composition according to a first ratio. In some embodiments, obtaining the mixture and forming the layer based on the mixture may include dispensing, at the first location, an amount of the first composition on a substate and dispensing an amount of the second composition on the first composition according to the first ratio. In some embodiments, obtaining the mixture and forming the layer based on the mixture may include heating the first composition and the second composition at the first location to mix the first composition and the second composition to obtain a first mixture or form a first portion of the layer. In some embodiments, obtaining the mixture and forming the layer based on the mixture may include dispensing, at a second location, an amount of the first composition and an amount of the second composition according to a second ratio. In some embodiments, obtaining the mixture and forming the layer based on the mixture may include dispensing, at the second location, the amount of the first composition on the substate and dispensing the amount of the second composition on the first composition according to the second ratio. In some embodiments, obtaining the mixture and forming the layer based on the mixture may include heating the first composition and the second composition to mix the first composition and the second composition at the second location to obtain a second mixture or form a second portion of the layer.

In some embodiments, obtaining the mixture and forming the layer based on the mixture may include dissolving the first composition and the second composition in a first solvent according to a first ratio to obtain a first mixture. In some embodiments, obtaining the mixture and forming the layer based on the mixture may include dispensing the first mixture on a substrate at a first location and removing the first solvent from the first mixture to form a first portion of the layer. In some embodiments, obtaining the mixture and forming the layer based on the mixture may include dissolving the first composition and the second composition in a second solvent according to a second ratio to obtain a second mixture. In some embodiments, obtaining the mixture and forming the layer based on the mixture may include dispensing the second mixture on the substrate at a second location and removing the second solvent from the second mixture to form a second portion of the layer.

In some embodiments, the method 1600 may also include forming an alignment structure at (e.g., on and/or at least partially in) the substrate. Forming the layer based on the mixture may include dispensing the first composition on the alignment structure and dispensing the second composition on the first composition. Molecules in the first and second compositions may be aligned at least partially by the alignment structure. In some embodiments, after forming the first portion at the first location of the substrate and before forming the second portion at the second location of the substrate, obtaining the mixture and forming the layer based on the mixture may further include polymerizing the first portion at the first location. In some embodiments, after forming the second portion at the second location of the substrate, obtaining the mixture and forming the layer based on the mixture may include polymerizing the second portion at the second location. The first portion of the layer at the first location and the second portion of the layer at the second location may have a difference in at least one (e.g., two or more) of a thickness, a slant angle, or a birefringence. In some embodiments, after forming the first portion at the first location and forming the second portion at the second location of the substrate, obtaining the mixture and forming the layer based on the mixture may include polymerizing the first portion and the second portion to form the layer. Portions of the layer at the first location and the second portion may have a difference in at least one (e.g., two or more) of a thickness, a slant angle, or a birefringence.

In some embodiments, an alignment structure may not be formed at the substrate. In some embodiments, after forming the first portion at the first location of the substrate and before forming the second portion at the second location of the substrate, obtaining the mixture and forming the layer based on the mixture may further include exposing the first portion to a first polarization interference. The exposed first portion of the layer may have a first optic axis having a first varying orientation. In some embodiments, after forming the second portion at the second location of the substrate, obtaining the mixture and forming the layer based on the mixture may include exposing the second portion to a second polarization interference. The exposed second portion of the layer may have a second optic axis having a second varying orientation. The exposed first portion of the layer at the first location and the exposed second portion of the layer at the second location may have a difference in at least one (e.g., two or more) of a thickness, a slant angle, or a birefringence. In some embodiments, after forming the first portion at the first location and forming the second portion at the second location of the substrate, obtaining the mixture and forming the layer based on the mixture may include exposing the first portion and the second portion to a polarization interference to form the layer having an optic axis with a varying orientation. Portions of the layer at the first location and the second portion may have a difference in at least one (e.g., two or more) of a thickness, a slant angle, or a birefringence.

Referring to FIG. 16, the first composition, the second composition, the first mixture, or the second mixture may be dispensed using a suitable system and method. In some embodiments, the first composition, the second composition, the first mixture, or the second mixture may be dispensed using an inkjet printer. For example, in some embodiments, obtaining the mixture and forming the layer based on the mixture may include dispensing, through an inkjet printer, an amount of the first composition to the first location of the substrate and an amount of the second composition on the first composition to form the first mixture, where a ration between the amount of the first composition and the amount of the second composition is the first ratio. In some embodiments, obtaining the mixture and forming the layer based on the mixture may include dispensing, through the inkjet printer, an amount of the first composition to the second position of the substrate and an amount of the second composition on the first composition to form the second mixture, where a ration between the amount of the first composition and the amount of the second composition is the second ratio. In some embodiments, obtaining the mixture and forming the layer based on the mixture may include dispensing, through an inkjet printer, the first mixture to the first location of the substrate. In some embodiments, obtaining the mixture and forming the layer based on the mixture may include dispensing, through the inkjet printer, the second mixture to the second location of the substrate.

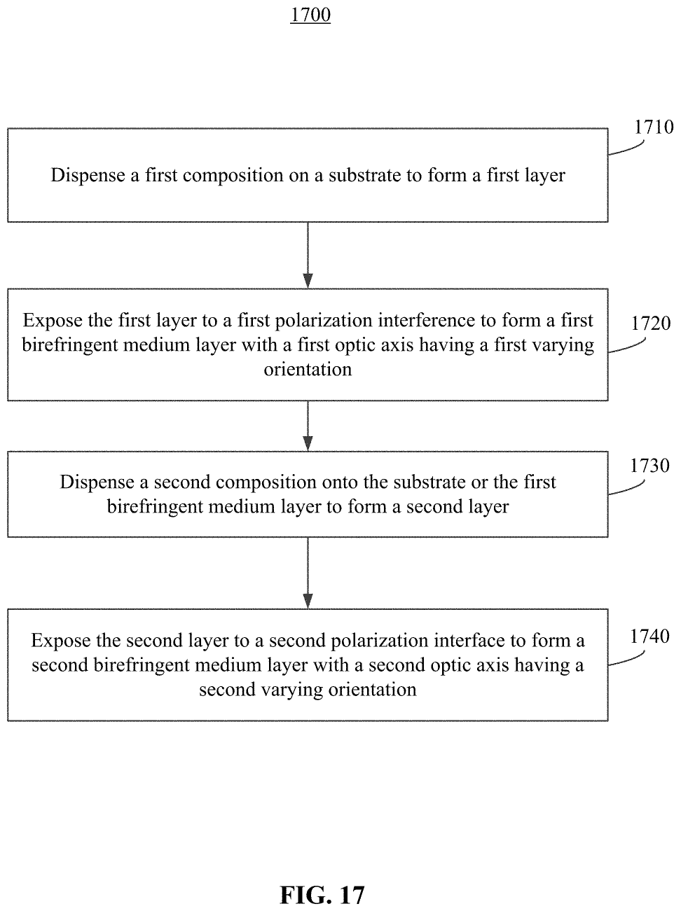

FIG. 17 is a flowchart illustrating a method 1700 for fabricating a birefringent medium layer, such as a PVH disclosed herein, according to another embodiment of the present disclosure. The method 1700 may include dispensing a first composition on a substrate to form a first layer (step 1710). The method 1700 may also include exposing the first layer to a first polarization interference to form a first birefringent medium layer with a first optic axis having a first varying orientation (step 1720). The method 1700 may also include dispensing a second composition onto the substrate or the first birefringent medium layer to form a second layer (step 1730). The method 1700 may further include exposing the second layer to a second polarization interface to form a second birefringent medium layer with a second optic axis having a second varying orientation (step 1740). In some embodiments, the first birefringent medium layer and the second birefringent medium layer may form a third birefringent medium layer having at least one (e.g., two or more) of a thickness variation, a birefringence variation, or a slant angle variation in at least one dimension of the third birefringent medium layer. The at least one dimension may be a dimension within a plane perpendicular to a thickness direction of the third birefringent medium layer. In some embodiments, the first birefringent medium layer may have a first thickness variation, a first birefringence, and a first slant angle. In some embodiments, the second birefringent medium layer may have a second thickness variation, a second birefringence, and a second slant angle. In some embodiments, the first birefringent medium layer and the second birefringent medium layer may have at least one of a difference in the first thickness variation and the second thickness variation, a difference in the first birefringence and the second birefringence, or a difference in the first slant angle and the second slant angle.

In some embodiments, the present disclosure provides a birefringent medium layer. The birefringent medium layer may include a first composition having a first birefringence and a first chirality. The birefringent medium layer may include a second composition having a second birefringence and a second chirality, the second composition being mixed with the first composition. At at least two different locations of the birefringent medium layer, ratios between amounts of the first composition and the second composition may be different. The birefringent medium layer may have at least one (e.g., two or more) of a thickness variation, a birefringence variation, or a slant angle variation along at least one dimension at a plurality of different locations. In some embodiments, the birefringent medium layer includes a thickness variation, a birefringence variation, and a slant angle variation in two dimensions (e.g., an x-axis direction and a y-axis direction) within a plane (e.g., a surface plane) perpendicular to a thickness direction (e.g., a z-axis direction) of the birefringent medium layer.

In some embodiments of the present disclosure, the first birefringence and the second birefringence may be substantially the same, and the first chirality and the second chirality may be substantially the same. In some embodiments, the first birefringence and the second birefringence may be substantially the same, and the first chirality and the second chirality may be different. In some embodiments, the first birefringence and the second birefringence may be different, and the first chirality and the second chirality may be substantially the same. In some embodiments, the first birefringence and the second birefringence may be different, and the first chirality and the second chirality may be different. In some embodiments, the first composition may include a first host birefringent material having the first birefringence, and a first chiral dopant of a first helical twist power doped into the first host birefringent material at a first concentration to provide the first chirality. The second composition may include a second host birefringent material having the second birefringence, and a second chiral dopant having a second helical twist power doped into the second host birefringent material at a second concentration to provide the second chirality.

In some embodiments, the birefringent medium layer may be a polarization volume hologram (“PVH”) layer. Multiple birefringent medium layers (e.g., multiple PVH layers) disclosed herein may be stacked to form a multi-layer PVH. For example, in some embodiments, a first PVH layer may have a first vertical pitch along a thickness direction of the first PVH layer and a first in-plane pitch within a plane perpendicular to the thickness direction of the first PVH layer. The second PVH layer may have a second vertical pitch along a thickness direction of the second PVH layer and a second in-plane pitch within a plane perpendicular to the thickness direction of the second PVH layer. A thickness of the first PVH layer may be larger than a thickness of the second PVH layer, the second vertical pitch may be about half of the first vertical pitch, and the second in-plane pitch may be substantially the same as the first in-plane pitch.

In some embodiments, the present disclosure provides a method for fabricating a birefringent medium layer disclosed herein. In some embodiments, the disclosed method may include dispensing a first composition on an alignment structure to form a first portion, and dispensing a second composition on the first portion to form a second portion. The method may also include mixing the first and second portions to form a mixture. The method may further include polymerizing the mixture to form a layer. At least one of the first portion or the second portion is configured to have a thickness variation in at least one dimension of the layer. In some embodiments, mixing the first and second portions may include heating the first and second portions to form the mixture. The method may also include forming an alignment material layer on a substrate. Forming the layer based on the mixture may include forming the layer on the alignment structure based on the mixture. The molecules in the layer may be aligned at least partially by the alignment structure. In some embodiments, dispensing the first composition on the alignment structure to form the first portion may include dispensing, using an inkjet printer, droplets of the first composition at predetermined locations on the alignment structure to form the first portion, with amounts of the first composition dispensed at at least two different locations being different. In some embodiments, dispensing the second composition on the first portion may include dispensing, using an inkjet printer, droplets of the second composition at predetermined locations on the first portion, with amounts of the second composition dispensed at at least two different locations being different. In some embodiments, the first composition includes a first birefringent medium having a first chirality and a first birefringence, and the second composition includes a second birefringent medium having a second chirality and a second birefringence.

In some embodiments, the first birefringent medium includes a first host birefringent material having the first birefringence, and a first chiral dopant of a first helical twist power doped into the first host birefringent material at a first concentration to provide the first chirality. The second birefringent medium may include a second host birefringent material having the second birefringence, and a second chiral dopant having a second helical twist power doped into the second host birefringent material at a second concentration to provide the second chirality. In some embodiments, the first portion of the layer may have a first thickness variation in one or more dimensions within a first plane perpendicular to a first thickness direction of the first portion. The second layer may have a second thickness variation in one or more dimensions within a second plane perpendicular to a second thickness direction of the second portion. In some embodiments, the first thickness variation has a first variation profile that is different from a second variation profile of the second thickness variation. In some embodiments, the layer formed by the first portion and the second portion may include at least one (e.g., two or more) of a thickness variation, a birefringence variation, and a slant angle variation in one or more dimensions within a plane perpendicular to a thickness direction of the layer. In some embodiments, after dispensing the second composition on the first portion and the second portion to mix the first composition and the second composition to form the layer, the method may further include dispensing a third composition on the second portion to form a third portion, and heating the first portion, the second portion, and the third portion to mix them together to form the layer. In some embodiments, the polymerized layer may be a PVH.

PVHs fabricated based on the fabrication processes disclosed herein have various applications in a number of technical fields. Some exemplary applications in augmented reality (“AR”), virtual reality (“VR”), and mixed reality (“MR)” fields or some combinations thereof will be explained below. Near-eye displays (“NEDs”) have been widely used in a wide variety of applications, such as aviation, engineering, scientific research, medical devices, computer games, videos, sports, training, and simulations. NEDs can function as a VR device, an AR device, and/or an MR device. When functioning as AR and/or MR devices, NEDs are at least partially transparent from the perspective of a user, enabling the user to view a surrounding real world environment. Such NEDs are also referred to as optically see-through NEDs. When functioning as VR devices, NEDs are opaque such that the user is substantially immersed in the VR imagery provided via the NEDs. An NED may be switchable between functioning as an optically see-through device and functioning as a VR device.

Pupil-replication (or pupil-expansion) waveguide display systems with diffractive coupling structures have been implemented in NEDs, which can potentially offer eye-glasses form factors, a moderately large field of view (“FOV”), a high transmittance, and a large eyebox. A pupil-replication waveguide display system includes a display element (e.g., an electronic display) that generates an image light, and an optical waveguide that guides the image light to an eyebox provided by the waveguide display system. Diffraction gratings may be coupled with the optical waveguide as in-coupling and out-coupling diffractive elements. The optical waveguide may also function as an AR and/or MR combiner to combine the image light and a light from the real world environment, such that virtual images generated by the display element may be superimposed with real-world images or see-through images. In a pupil-replication waveguide display system, a waveguide coupled with the in-coupling and out-coupling diffractive elements may expand the exit pupil along a light propagating direction of a light propagating inside the waveguide. As the light propagating inside the waveguide is repeatedly diffracted out of the waveguide by the out-coupling diffractive element, with a portion of the light exiting the waveguide at each location of the waveguide, the illuminance (or light intensity) of the light exiting the waveguide may decrease (i.e., may be non-uniform) along the light propagating direction. A uniform illuminance over an expanded exit pupil may be desirable for a pupil-replication waveguide display system to maintain a wide FOV. In addition, when the waveguide functions as an AR and/or MR combiner, the out-coupling diffractive element may diffract visible lights coming from a real world, resulting in a multi-colored glare in a see-through view. Such a see-through artifact is referred to a “rainbow effect,” which may degrade the image quality of the see-through view.

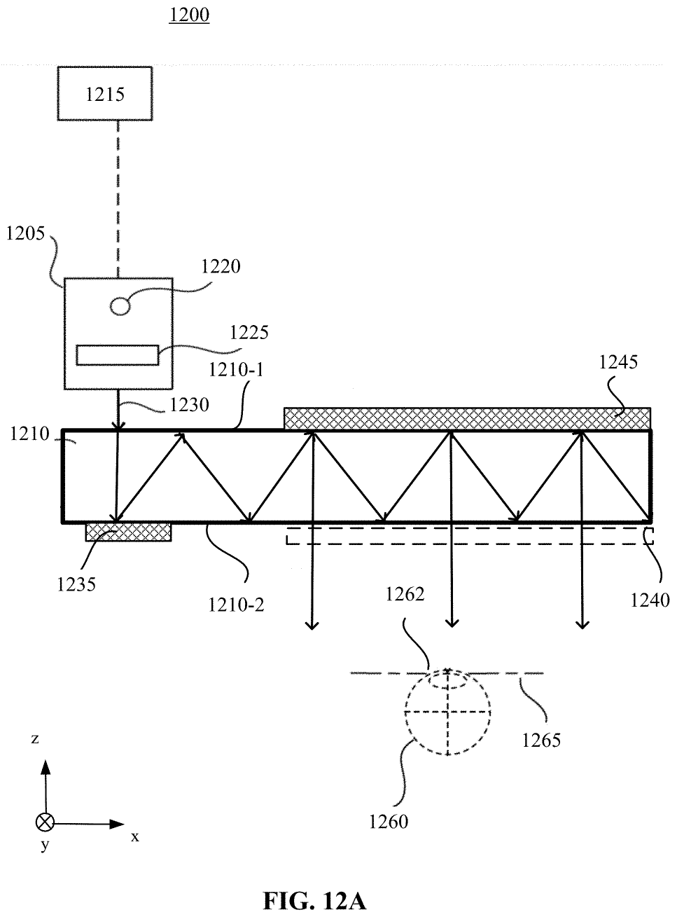

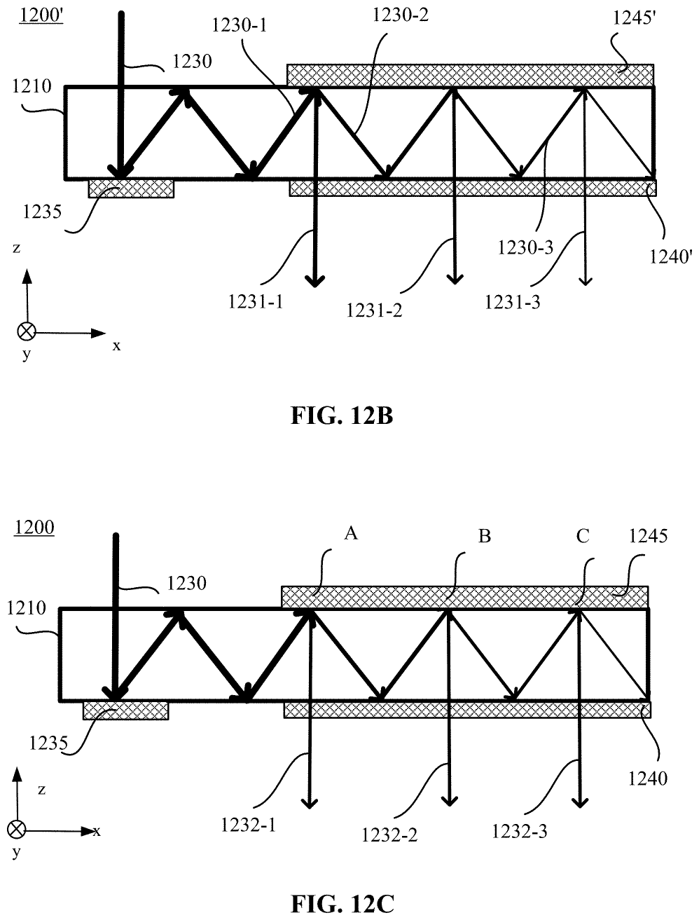

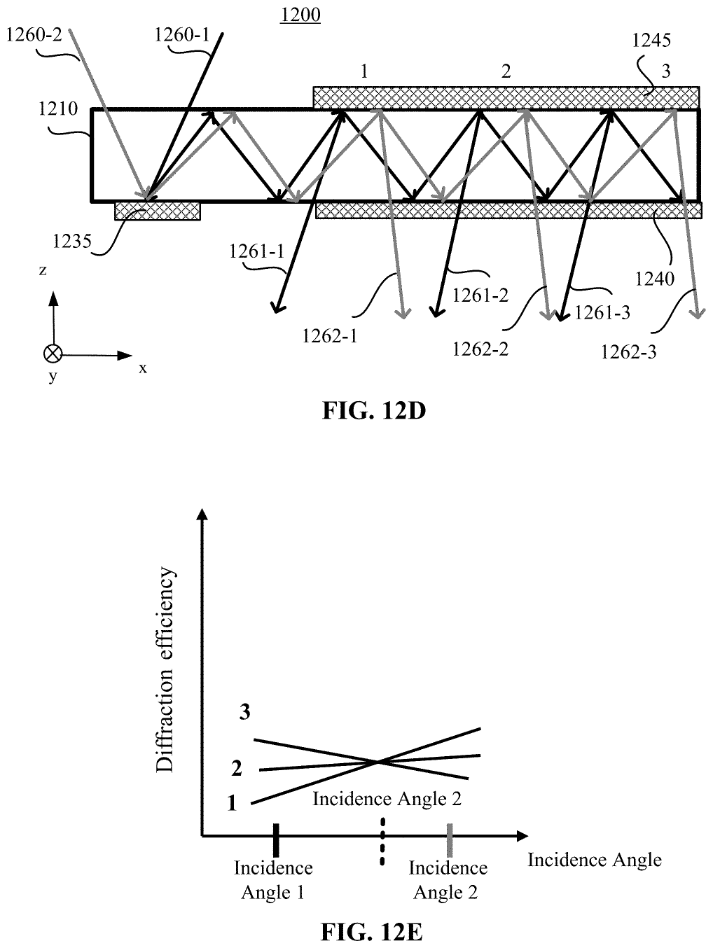

FIG. 12A illustrates a schematic diagram of a waveguide display system 1200, according to an embodiment of the present disclosure. The waveguide display system 1200 may provide pupil-replication (or pupil-expansion). The waveguide display system 1200 may be implemented in NEDs for VR, AR, and/or MR applications. The waveguide display system 1200 may include an out-coupling diffractive element 1245 (or out-coupling element 1245) including a PVH fabricated based on the disclosed methods, including, e.g., the methods described above in connection with FIGS. 2A-8G. That is, the PVH included in the out-coupling diffractive element 1245 may include at least one (e.g., two or more) of a thickness variation, a birefringence variation, or a slant angle variation in one or more dimensions, e.g., in a plane perpendicular to a thickness direction of the birefringent medium layer. The at least one of the thickness variation, the birefringence variation, or the slant angle variation in the PVH may provide a predetermined non-uniform diffraction efficiency profile (any suitable diffraction efficiency variation profile) in one or more dimensions. The predetermined non-uniform diffraction efficiency profile may provide a predetermined illuminance distribution (or profile) along one or more expansion directions of the expanded exit pupil.

In some embodiments, with the predetermined non-uniform diffraction efficiency profile, the PVH may provide an illuminance with an improved uniformity over an expanded exit pupil. predetermined illuminance distribution may be any suitable illuminance distribution profile in one or more dimensions, such as a Gaussian distribution or any other desirable distribution. In some embodiments, the predetermined illuminance distribution may not be uniform depending on the application need. In some embodiments, the out-coupling diffractive element 1245 may include a multi-PVH layer fabricated based on the disclosed methods. The waveguide display system 1200 may reduce the rainbow effect that may be caused by a conventional out-coupling diffractive element.

As shown in FIG. 12A, the waveguide display system 1200 may include a light source assembly 1205, a waveguide 1210, and a controller 1215. The light source assembly 1205 may include a light source 1220 and an light conditioning system 1225. In some embodiments, the light source 1220 may be a light source configured to generate a coherent or partially coherent light. The light source 1220 may include, e.g., a laser diode, a vertical cavity surface emitting laser, a light emitting diode, or a combination thereof. In some embodiments, the light source 1220 may be a display panel, such as a liquid crystal display (“LCD”) panel, an liquid-crystal-on-silicon (“LCoS”) display panel, an organic light-emitting diode (“OLED”) display panel, a micro light-emitting diode (“micro-LED”) display panel, a digital light processing (“DLP”) display panel, or a combination thereof. In some embodiments, the light source 1220 may be a self-emissive panel, such as an OLED display panel or a micro-LED display panel. In some embodiments, the light source 1220 may be a display panel that is illuminated by an external source, such as an LCD panel, an LCoS display panel, or a DLP display panel. Examples of an external source may include a laser, an LED, an OLED, or a combination thereof. The light conditioning system 1225 may include one or more optical components configured to condition the light from the light source 1220. For example, the controller 1215 may control the light conditioning system 1225 to condition the light from the light source 1220, which may include, e.g., transmitting, attenuating, expanding, collimating, and/or adjusting orientation of the light.

The light source assembly 1205 may generate an image light 1230 and output the image light 1230 to an in-coupling element 1235 disposed at a first portion of the waveguide 1210. The waveguide 1210 may expand and direct the image light 1230 to an eye 1260 positioned in an eye-box 1265 of the waveguide display system 1200. An exit pupil 1262 may be a location where the eye 1260 is positioned in the eye-box 165. The waveguide 1210 may receive the image light 1230 at the in-coupling element 1235 located at the first portion of the waveguide 1210. The image light 1230 may propagate (e.g., through TIR) inside the waveguide 1210 toward an out-coupling element 1245 located at a second portion of the waveguide 1210. The first portion and the second portion may be located at different portions of the waveguide 1210. The out-coupling element 1245 may be configured to couple the image light 1230 out of the waveguide 1210 toward the eye 1260. In some embodiments, the in-coupling element 1235 may couple the image light 1230 into a TIR path inside the waveguide 1210. The image light 1230 may propagate inside the waveguide 1210 through TIR along the TIR path.

The waveguide 1210 may include a first surface or side 1210-1 facing the real-world environment and an opposing second surface or side 1210-2 facing the eye 1260. In some embodiments, as shown in FIG. 12A, the in-coupling element 1235 may be disposed at the second surface 1210-2 of the waveguide 1210. In some embodiments, the in-coupling element 1235 may be integrally formed as a part of the waveguide 1210 at the second surface 1210-2. In some embodiments, the in-coupling element 1235 may be separately formed, and may be disposed at (e.g., affixed to) the second surface 1210-2 of the waveguide 1210. In some embodiments, the in-coupling element 1235 may be disposed at the first surface 1210-1 of the waveguide 1210. In some embodiments, the in-coupling element 1235 may be integrally formed as a part of the waveguide 1210 at the first surface 1210-1. In some embodiments, the in-coupling element 1235 may be separately formed and disposed at (e.g., affixed to) the first surface 1210-1 of the waveguide 1210. In some embodiments, the in-coupling element 1235 may include one or more diffraction gratings, one or more cascaded reflectors, one or more prismatic surface elements, and/or an array of holographic reflectors, or any combination thereof. In some embodiments, the in-coupling element 1235 may include one or more diffraction gratings, such as a surface relief grating, a volume hologram, a polarization selective grating, a polarization volume hologram, a metasurface grating, another type of diffractive element, or any combination thereof. A pitch of the diffraction grating may be configured to enable total internal reflection (“TIR”) of the image light 1230 within the waveguide 1210. As a result, the image light 1230 may propagate internally within the waveguide 1210 through TIR. In some embodiments, the in-coupling element 1235 may include a PVH fabricated based on the disclosed methods. For example, the in-coupling element 1235 may include a PVH having at least one (e.g., two or more) of a thickness variation, a birefringence variation, or a slant angle variation in at least one dimension to provide a non-uniform diffraction efficiency in the at least one dimension for image lights of predetermined incidence angles.

The out-coupling element 1245 may be disposed at the first surface 1210-1 or the second surface 1210-2 of the waveguide 1210. For example, as shown in FIG. 12A, the out-coupling element 1245 may be disposed at the first surface 1210-1 of the waveguide 1210. In some embodiments, the out-coupling element 1245 may be integrally formed as a part of the waveguide 1210, for example, at the first surface 1210-1. In some embodiments, the out-coupling element 1245 may be separately formed and dispose at (e.g., affixed to) the first surface 1210-1 of the waveguide 1210. In some embodiments, the out-coupling element 1245 may be disposed at the second surface 1210-2 of the waveguide 1210. For example, in some embodiments, the out-coupling element 1245 may be integrally formed as a part of the waveguide 1210 at the second surface 1210-2. In some embodiments, the out-coupling element 1245 may be separately formed and disposed at (e.g., affixed to) the second surface 1210-2 of the waveguide 1210. In some embodiments, the out-coupling element 1245 may include one or more diffraction gratings, one or more cascaded reflectors, one or more prismatic surface elements, and/or an array of holographic reflectors, or any combination thereof. In some embodiments, the out-coupling element 1245 may include one or more diffraction gratings, such as a surface relief grating, a volume hologram, a polarization selective grating, a polarization volume hologram (“PVH”), a metasurface grating, another type of diffractive element, or any combination thereof. A pitch of the diffraction grating may be configured to cause the incident image light 1230 to exit the waveguide 1210, i.e., redirecting the image light 1230 so that the TIR no longer occurs. In other words, the diffraction grating of the out-coupling element 1245 may couple the image light 1230 that has been propagated inside the waveguide 1210 through TIR out of the waveguide 1210 via diffraction. In some embodiments, the out-coupling element 1245 may also be referred to as an out-coupling grating 1245.

In some embodiments, the out-coupling element 1245 may include a PVH (e.g., a single layer PVH, or a multi-layer PVH) fabricated based on disclosed fabrication processes. The PVH may be fabricated to have at least one of a predetermined thickness variation, a predetermined birefringence variation, or a predetermined slant angle variation in one or more dimensions, e.g., within a plane perpendicular to a thickness direction of the PVH, such as the PVH 500 shown in FIG. 5A, the PVH 510 shown in FIG. 5B, the PVH 520 shown in FIG. 5C, or the PVH 530 shown in FIG. 5D, the multi-layer PVH 660 shown in FIG. 6E, the multi-layer PVH 700, 710, or 720 shown in FIG. 7A, 7B, or 7C, or the PVH 840 shown in FIG. 8D. In some embodiments, the PVH included in the out-coupling element 1245 may have at least one of a predetermined thickness variation in one or more dimensions, e.g., within a plane perpendicular to a thickness direction of the PVH, a predetermined birefringence variation in one or more dimensions, e.g., within a plane perpendicular to a thickness direction of the PVH, or a predetermined slant angle variation in one or more dimensions, e.g., within a plane perpendicular to a thickness direction of the PVH, such as the PVH 890 shown in FIG. 8G.

The PVH included in the out-coupling element 1245 may be configured to provide a predetermined (e.g., a non-uniform) diffraction efficiency profile, e.g., a predetermined 1D or 2D diffraction efficiency profile in an x-y plane, to image lights incident onto different portions of the surface of the PVH at predetermined incidence angles, with predetermined incidence wavelengths and predetermined polarizations. In some embodiments, the PVH in the out-coupling element 1245 may diffract the image lights out of the waveguide 1210 at different diffraction efficiencies at different positions along the propagating direction of the image light (e.g., along the x-axis direction of the waveguide 1210). As discussed above, in a conventional pupil-replication waveguide display system, the waveguide may expand the exit pupil in the propagating direction of the image light that propagates inside the waveguide. As the image light propagates, a portion of the image light may be diffracted out of the waveguide by the out-coupling element 1245. Thus, the intensity of the image light diffracted out of the waveguide 1210 may decrease in the propagating direction. Accordingly, the illuminance of the image light output from the waveguide may be non-uniform (e.g., may decrease) along the propagating direction of the image light (or the direction in which the exit pupil is expanded). In the waveguide display system 1200 according to the present disclosure, through implementing a PVH that provides a non-uniform diffraction efficiency profile, different diffraction efficiencies may be provided at different locations for diffracting the image light 1230 in the propagating direction. For example, at least one of the thickness, the birefringence, or the slant angle of the PVH may be configured to vary at least along the +x-axis direction in FIG. 12A, resulting in a varying (e.g., non-uniform) diffraction efficiency of the PVH at least along the +x-axis direction in FIG. 12A. In some embodiments, the diffraction efficiency of the PVH may increase along the +x-axis direction. As a result, when the intensity of the image light 1230 decreases as the image light 130 propagates along the propagating direction, the portions of the image light diffracted out of the waveguide 1210 may be uniform due to the increasing diffraction efficiency along the propagating direction. Thus, the uniformity of the illuminance of the image light 1230 output from the waveguide at least along the +x-axis direction (or the exit pupil expansion direction) may be improved.

Although not shown in FIG. 12A, in some embodiments, when the image light 1230 propagating inside the waveguide 1210 is diffracted by the PVH included in the out-coupling element 1245 out of the waveguide 1210, the out-coupling element 1245 may be configured to provide a uniform illuminance in two dimensions (e.g., the x-axis direction and the y-axis direction) of the expanded exit pupil. In addition, the PVH may diffract an image light toward regions outside of the eyebox 1260 with a relatively small (e.g., negligible) diffraction efficiency, and diffract an image light toward regions inside the eyebox 1260 with a relatively large diffraction efficiency. Thus, the loss of the image light directed to regions outside of the eyebox 1260 may be reduced. As a result, the power consumption of the light source assembly 1205 may be significantly reduced, while the power efficiency of the waveguide display system 1200 may be significantly improved. In some embodiments, the PVH may be a multi-layer PVH, such as the PVH 700 shown in FIG. 7A, the PVH 710 shown in FIG. 7B, the PVH 720 shown in FIG. 7C, the PVH 870 shown in FIG. 8F, or the PVH 890 shown in FIG. 8G. When the waveguide 1210 coupled with the in-coupling element 1235 and the out-coupling element 1245 functions as an AR or MR combiner, the multi-layer PVH may be configured to reduce the rainbow effect caused by undesirable visible diffraction orders.

The waveguide 1210 may include one or more materials configured to facilitate the total internal reflection of the image light 1230. The waveguide 1210 may include, for example, a plastic, a glass, and/or polymers. The waveguide 1210 may have a relatively small form factor. For example, the waveguide 1210 may be approximately 50 mm wide along the x-dimension, 30 mm long along the y-dimension, and 0.5-1 mm thick along the z-dimension.

The controller 1215 may be communicatively coupled with the light source assembly 1205, and may control the operations of the light source assembly 1205. In some embodiments, the waveguide 1210 may output the expanded image light 1230 to the eye 1260 with an increased or expanded field of view (“FOV”). For example, the expanded image light 1230 may be provided to the eye 1260 with a diagonal FOV (in x and y) of equal to or greater than 60 degrees and equal to or less than 150 degrees. The waveguide 1210 may be configured to provide an eye-box with a width of equal to or greater than 8 mm and equal to or less than 50 mm, and/or a height of equal to or greater than 6 mm and equal to or less than 120 mm. With the waveguide display assembly 1200, the physical display and electronics may be moved to a side of a front rigid body of an NED, and a substantially fully unobstructed view of the real world environment may be achieved, which enhances the AR user experience.

In some embodiments, the waveguide 1210 may include additional elements configured to redirect, fold, and/or expand the pupil of the light source assembly 1205. For example, as shown in FIG. 12A, the waveguide 1210 may include a directing element 1240 configured to redirect the received input image light 1230 to the out-coupling element 1245, such that the received input image light 1230 is coupled out of the waveguide 1210 via the out-coupling element 1245. In some embodiments, the directing element 1240 may be arranged at a location of the waveguide 1210 opposing the location of the out-coupling element 1245. In some embodiments, the directing element 1240 may be disposed at the second surface 1210-2 of the waveguide 1210. For example, in some embodiments, the directing element 1240 may be integrally formed as a part of the waveguide 1210 at the second surface 1210-2. In some embodiments, the directing element 1240 may be separately formed and disposed at (e.g., affixed to) the second surface 1210-2 of the waveguide 1210. In some embodiments, the directing element 1240 may be disposed at the first surface 1210-1 of the waveguide 1210. For example, in some embodiments, the directing element 1240 may be integrally formed as a part of the waveguide 1210 at the first surface 1210-1. In some embodiments, the directing element 1240 may be separately formed and disposed at (e.g., affixed to) the first surface 1210-1 of the waveguide 1210.

In some embodiments, the directing element 1240 and the out-coupling element 1245 may have a similar structure. In some embodiments, the directing element 1240 may include one or more diffraction gratings, one or more cascaded reflectors, one or more prismatic surface elements, and/or an array of holographic reflectors, or any combination thereof. In some embodiments, the directing element 1240 may include one or more diffraction gratings, such as a surface relief grating, a volume hologram, a polarization selective grating, a polarization volume hologram, a metasurface grating, another type of diffractive element, or any combination thereof. The directing element 1240 may also be referred to as a folding grating 1240 or a directing grating 1240. In some embodiments, the directing element 1240 may include one or more PVHs fabricated based on disclosed fabrication processes, such as the PVH 500 shown in FIG. 5A, the PVH 510 shown in FIG. 5B, the PVH 520 shown in FIG. 5C, the PVH 530 shown in FIG. 5D, the PVH 700 shown in FIG. 7A, the PVH 710 shown in FIG. 7B, or the PVH 720 shown in FIG. 7C, the PVH 840 shown in FIG. 8D, the PVH 870 shown in FIG. 8F, or the PVH 890 shown in FIG. 8G. The PVH included in the directing element 1240 may provide a predetermined, non-uniform diffraction efficiency profile in at least one dimension within a plane perpendicular to a thickness direction of the PVH. For example, the PVH may include at least one (e.g., two or more) of a thickness variation, a birefringence variation, or a slant angle variation in one or more dimensions within the plane perpendicular to the thickness direction of the PVH. In some embodiments, multiple functions, e.g., redirecting, folding, and/or expanding the pupil of the light generated by the light source assembly 1205 may be combined into a single grating, e.g. an out-coupling grating.

In some embodiments, the waveguide display system 1200 may include a plurality of waveguides 1210 disposed in a stacked configuration (not shown in FIG. 12A). At least one (e.g., each) of the plurality of waveguides 1210 may be coupled with or include one or more diffractive elements (e.g., in-coupling element, out-coupling element, and/or directing element), which may be configured to direct the image light 1230 toward the eye 1260. In some embodiments, the plurality of waveguides 1210 disposed in the stacked configuration may be configured to output an expanded polychromatic image light (e.g., a full-color image light). In some embodiments, the waveguide display system 1200 may include one or more light source assemblies 1205 and/or one or more waveguides 1210. In some embodiments, at least one (e.g., each) of the light source assemblies 1205 may be configured to emit a monochromatic image light of a specific wavelength band corresponding to a primary color (e.g., red, green, or blue) and a predetermined FOV (or a predetermined portion of an FOV). In some embodiments, the waveguide display system 1200 may include three different waveguides 1210 configured to deliver component color images (e.g., primary color images) by in-coupling and subsequently out-coupling, e.g., red, green, and blue lights, respectively, in any suitable order. In some embodiments, the waveguide display assembly 1200 may include two different waveguides configured to deliver component color images (e.g., primary color images) by in-coupling and subsequently out-coupling, e.g., a combination of red and green lights, and a combination of green and blue lights, respectively, in any suitable order. In some embodiments, at least one (e.g., each) of the light source assemblies 1205 may be configured to emit a polychromatic image light (e.g., a full-color image light).

FIG. 12B illustrates a conventional waveguide display system 1200′ in which an out-coupling element 1245 and a directing element 1240′ each include one or more diffraction elements (e.g., one or more PVHs) having a uniform diffraction efficiency in the x-axis direction. As shown in FIG. 12B, when the image light 1230 propagates inside the waveguide 1210 through TIR, as portions of the image light 1230 are diffracted out of the waveguide 1210 by the out-coupling element 1245′ at different locations, the intensity of the image light 1230 becomes lower in the light propagating direction, as schematically indicated by the gradually reducing thickness of the lines 1230-1, 1230-2, and 1230-3. As a result, the intensity (or illuminance) of output lights 1231-1, 1231-2, and 1231-3 output from the waveguide 1210 gradually decreases. Thus, the conventional waveguide display system 1200′ with diffraction elements providing a uniform diffraction efficiency in the x-axis direction may provide a non-uniform illuminance.

According to an embodiment of the present disclosure, the disclosed PVH with a non-uniform diffraction efficiency may improve the uniformity of the output illuminance of the output image light. FIG. 12C illustrates diffraction of the image light by the disclosed waveguide display system 1200 include the out-coupling element 1245 with a PVH having a non-uniform diffraction efficiency. FIG. 12C shows that in the disclosed waveguide display system 1200 shown in FIG. 12A, the PVH included in the out-coupling element 1245 may be configured to have a gradually increasing diffraction efficiency along the x-axis direction. This may be achieved by fabricating the PVH using the disclosed method to have at least one (e.g., two or more) of a thickness variation, a birefringence variation, or a slant angle variation in at least the x-axis direction within a plane perpendicular to the thickness direction (the z-axis direction) of the PVH. For example, at three exemplary diffraction points A, B, and C, the diffraction efficiency of the PVH may gradually decrease. Thus, at point A where the intensity of the image light 1230 is the largest, the diffraction efficiency may be the smallest. At point B, the intensity of the image light 1230 may be lower than the intensity at point A. Hence, the diffraction efficiency at point B may be higher than the diffraction efficiency at point A. At point C, the intensity of the image light 1230 may be further reduced. Thus, at point C, the diffraction efficiency may be further increased as compared to the diffraction efficiency at point B. Thus, the diffraction efficiency at point C may be the highest. As a result of the non-uniform diffraction efficiency provided at different portions of the PVH, the illuminance (or intensity) of the image light 1232-1, 1232-2, and 1232-3 output from the waveguide 1210 may become more uniform as compared with the conventional configuration shown in FIG. 12B. In FIG. 12C, the diffraction efficiency of the PVH is presumed to be non-uniform in one dimension. It is understood that the diffraction efficiency of the PVH may be non-uniform in two dimensions, i.e., the x-axis direction and the y-axis direction. The PVH may have any suitable diffraction efficiency distribution profile in one dimension or two dimensions.

FIG. 12D illustrates diffraction of two image lights with different in-coupling incident angles by the disclosed waveguide display system 1200. Two input lights, 1260-1 and 1260-2, may represent the leftmost and the rightmost portions of an FOV. The two input lights 1260-1 and 1260-2 may be incident onto the in-coupling element 1235 at two different in-coupling incident angles. FIG. 12E illustrates a relationship between the diffraction efficiency of the PVH included in the out-coupling element 1245 and the incidence angle in which the image light is incident onto the out-coupling element 1245. It is noted that the incidence angle in which the image light is incident onto the out-coupling element 1245 is related to the in-coupling incident angle of the input light (e.g., 1260-1 and 1260-2). For a same image light propagating along the waveguide 1210, the diffraction efficiency provided by the PVH at different locations may vary along the x-axis direction (i.e., the light propagating direction). That is, for a same image light propagating along the waveguide 1210, the diffraction efficiency provided by the PVH at different locations may be different (e.g., non-uniform). At a same location of the PVH, the diffraction efficiency provided by the PVH for different image lights (having different incidence angle and same incidence wavelength and same polarization) may vary (e.g., may be non-uniform) with the incidence angle. At different locations of the PVH, the fashion in which the non-uniform diffraction efficiency varies may be different.

For illustrative purposes, as shown in FIG. 12D, three locations 1, 2, 3, of the PVH along the light propagating direction (i.e., x-axis direction) are selected. Exemplary relationships between the diffraction efficiency and the angle of incidence for different locations 1, 2, and 3 are shown in FIG. 12E. As shown in FIG. 12E, for each location 1, 2, or 3, the diffraction efficiency varies with the incidence angle. At location 1, the diffraction efficiency of the PVH may increase linearly as the incidence angle increases. At location 2, the diffraction efficiency of the PVH may increase linearly as the incidence angle increases. The rate of increase of the diffraction efficiency at location 2 may be smaller than the rate of increase at location 1. At location 3, the diffraction efficiency of the PVH may decrease linearly as the incidence angle increases. For an image light with a specific incidence angle, the diffraction efficiency at different locations of the PVH may increase, decrease, or remain constant. For example, for an angle of incidence “incidence angle 1,” which corresponds to the input light 1260-1, the diffraction efficiency provided by the PVH increases from location 1 to location 2 to location 3. For an angle of incidence “incidence angle 2,” which corresponds to the input light 1260-2, the diffraction efficiency provided by the PVH decreases from location 1 to location 2 to location 3. As shown in FIG. 12E, at a certain incidence angle 3 between incidence angle 1 and incidence angle 2, the three straight lines for location 1, location 2, and location 3 cross each other, meaning that for the image light having angle 3 as an angle of incidence, the diffraction efficiency provide by the PVH remain constant for different locations along the x-axis direction (i.e., the light propagating direction). As shown in FIG. 12D, due to the non-uniform diffraction efficiency (shown in FIG. 12E) provided by the PVH included in the out-coupling element 1245, the illuminance of the output lights 1261-1, 1261-2, 1261-3, 1262-1, 1262-2, and 1262-3 corresponding to the input lights 1260-1 and 1260-2 may become uniform in the x-axis direction.

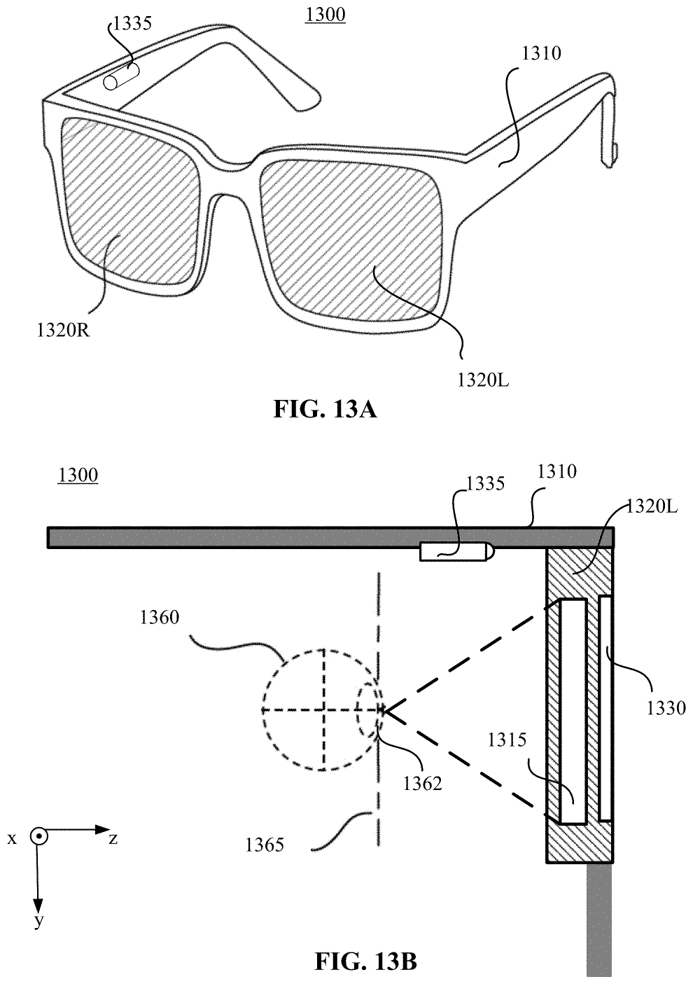

FIG. 13A illustrates a schematic diagram of an optical system 1300 according to an embodiment of the present disclosure. For illustrative purposes, a near-eye display (“NED”) is used as an example of the optical system 1300, in which the disclosed PVH may be implemented. For the convenience of discussion, the optical system 1300 may also be referred to as the NED 1300. In some embodiments, the NED 1300 may be referred to as a head-mounted display (“HMD”). The NED 1300 may present media content to a user, such as one or more images, videos, audios, or a combination thereof. In some embodiments, an audio may be presented to the user via an external device (e.g., a speaker and/or a headphone). The NED 1300 may operate as a VR device, an AR device, an MR device, or a combination thereof. In some embodiments, when the NED 1300 operates as an AR and/or MR device, a portion of the NED 1300 may be at least partially transparent, and internal components of the NED 1300 may be at least partially visible.

As shown in FIG. 13A, the NED 1300 may include a frame 1310, a right display system 1320R, and a left display system 1320L. In some embodiments, certain device(s) shown in FIG. 13A may be omitted. In some embodiments, additional devices or components not shown in FIG. 13A may also be included in the NED 1300. The frame 1310 may include a suitable type of mounting structure configured to mount the right display system 1320R and the left display system 1320L to a body part (e.g. a head) of the user (e.g., adjacent a user's eyes). The frame 1310 may be coupled to one or more optical elements, which may be configured to display media to users. In some embodiments, the frame 1310 may represent a frame of eye-wear glasses. The right display system 1320R and the left display system 1320L may be configured to enable the user to view content presented by the NED 1300 and/or to view images of real-world objects (e.g., each of the right display system 1320R and the left display system 1320L may include a see-through optical element). In some embodiments, the right display system 1320R and the left display system 1320L may include any suitable display assembly (not shown) configured to generate a light (e.g., an image light corresponding to a virtual image) and to direct the image light to an eye of the user. In some embodiments, the NED 1300 may include a projection system. For illustrative purposes, FIG. 13A shows the projection system may include a projector 1335 coupled to the frame 1310.

FIG. 13B is a cross-section view of half of the NED 1300 shown in FIG. 13A in accordance with an embodiment of the present disclosure. For purposes of illustration, FIG. 13B shows the cross-sectional view associated with the left display system 1320L. As shown in FIG. 13B, the left display system 1320L may include a waveguide display assembly 1315 for an eye 1360 of the user. The waveguide display assembly 1315 may be an embodiment of the waveguide display system 1200 shown in FIG. 12A. That is, the waveguide display assembly 1315 may include at least one PVH serving as or included in an in-coupling element or an out-coupling element. The PVH may be fabricated based on the disclosed methods. The PVH may include a non-uniform diffraction efficiency in at least one dimension of the PVH. The illuminance of the image light diffracted out of a waveguide by the PVH may have an improved uniformity with the rainbow effect reduced, suppressed, or eliminated. The waveguide display assembly 1315 may include a waveguide or a stack of waveguides. An exit pupil 1362 may be a location where an eye 1360 is positioned in an eye-box 1365 when the user wears the NED 1300. For purposes of illustration, FIG. 13B shows the cross section view associated with a single eye 1360 and a single waveguide display assembly 1315. In some embodiments, another waveguide display assembly that is separate from and similar to the waveguide display assembly 1315 shown in FIG. 13B may provide an image light to an eye-box located at an exit pupil of another eye of the user.

The waveguide display assembly 1315 may include one or more materials (e.g., a plastic, a glass, etc.) with one or more refractive indices. The waveguide display assembly 1315 may effectively minimize the weight and expand the FOV of the NED 1300. In some embodiments, the waveguide display assembly 1315 may be a component of the NED 1300. In some embodiments, the waveguide display assembly 1315 may be a component of some other NED or system that directs an image light to a particular location. As shown in FIG. 13B, the waveguide display assembly 1315 may be provided for one eye 1360 of the user. The waveguide display assembly 1315 for one eye may be separated or partially separated from the waveguide display assembly 1315 for the other eye. In some embodiments, a single waveguide display assembly 1315 may be included for both eyes 1360 of the user.

In some embodiments, the NED 1300 may include one or more optical elements disposed between the waveguide display assembly 1315 and the eye 1360. The optical elements may be configured to, e.g., correct aberrations in an image light output from the waveguide display assembly 1315, magnify an image light output from the waveguide display assembly 1315, or perform another type of optical adjustment of an image light output from the waveguide display assembly 1315. Examples of the one or more optical elements may include an aperture, a Fresnel lens, a convex lens, a concave lens, a filter, any other suitable optical element that affects an image light, or a combination thereof. In some embodiments, the waveguide display assembly 1315 may include a stack of waveguide displays (each waveguide display may include a waveguide, a light source assembly, an in-coupling element, and/or an out-coupling element). In some embodiments, the stacked waveguide displays may include a polychromatic display (e.g., a red-green-blue (“RGB”) display) formed by stacking waveguide displays whose respective monochromatic light sources are configured to emit lights of different colors. For example, the stacked waveguide displays may include a polychromatic display configured to project image lights onto multiple planes (e.g., multi-focus colored display). In some embodiments, the stacked waveguide displays may include a monochromatic display configured to project image lights onto multiple planes (e.g., multi-focus monochromatic display). In some embodiments, the NED 1300 may include an adaptive dimming element 1330, which may dynamically adjust the transmittance of lights reflected by real-world objects, thereby switching the NED 1300 between a VR device and an AR device or between a VR device and a MR device. In some embodiments, along with switching between the AR/MR device and the VR device, the adaptive dimming element 1330 may be used in the AR and/MR device to mitigate differences in brightness of lights reflected by real-world objects and virtual image lights.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A method, comprising:
obtaining a mixture including a first composition and a second composition; and
forming a layer based on the mixture, wherein ratios between an amount of the first composition and an amount of the second composition at at least two locations of the layer are different.

2. The method of claim 1, wherein the layer has at least one of a thickness variation, a slant angle variation, or a birefringence variation in at least one dimension of the layer.

3. The method of claim 1, wherein at least one of the first composition or the second composition includes a liquid crystal material or a polymer.

4. The method of claim 1, wherein
the first composition has a first birefringence and a first chirality,
the second composition has a second birefringence and a second chirality, and
the first composition and the second composition have a difference between at least one of the first birefringence and the second birefringence or the first chirality and the second chirality.

5. The method of claim 1, wherein obtaining the mixture and forming the layer based on the mixture comprise:
obtaining a first mixture in which an amount of the first composition and an amount of the second composition are mixed according to a first ratio;
obtaining a second mixture in which an amount of the first composition and an amount of the second composition are mixed according to a second ratio;
dispensing the first mixture to a first location of a substrate; and
dispensing the second mixture to a second location of the substrate.

6. The method of claim 1, wherein obtaining the mixture and forming the layer based on the mixture comprise:
mixing an amount of the first composition and an amount of the second composition according to a first ratio to form a first mixture;
dispensing the first mixture to a first location of a substrate;
mixing an amount of the first composition and an amount of the second composition according to a second ratio to form a second mixture; and
dispensing the second mixture to a second location of the substrate.

7. The method of claim 1, wherein obtaining the mixture and forming the layer based on the mixture comprise:
dispensing an amount of the first composition at a first location and an amount of the second composition at the first location according to a first ratio to obtain a first mixture;
polymerizing the first mixture to obtain a first portion of the layer at the first location;
dispensing an amount of the first composition at a second location and an amount of the second composition at the second location according to a second ratio to obtain a second mixture; and
polymerizing the second mixture to obtain a second portion of the layer at the second location.

8. The method of claim 1, wherein obtaining the mixture and forming the layer based on the mixture comprise:
dispensing an amount of the first composition at a first location and an amount of the second composition at the first location according to a first ratio to obtain a first mixture;
dispensing an amount of the first composition at a second location and an amount of the second composition at the second location according to a second ratio to obtain a second mixture; and
polymerizing the first mixture and the second mixture to form the layer.

9. The method of claim 1, wherein obtaining the mixture and forming the layer based on the mixture comprise:
dispensing, at a first location, an amount of the first composition and an amount of the second composition according to a first ratio;
heating the first composition and the second composition at the first location to mix the first composition and the second composition to obtain a first mixture;
polymerizing the first mixture to form a first portion of the layer at the first location;
dispensing, at a second location, an amount of the first composition and an amount of the second composition according to a second ratio;
heating the first composition and the second composition to mix the first composition and the second composition at the second location to obtain a second mixture; and
polymerizing the second mixture to form a second portion of the layer at the second location.

10. The method of claim 1, wherein obtaining the mixture and forming the layer based on the mixture comprise:
dissolving the first composition and the second composition in a first solvent according to a first ratio to obtain a first mixture;
dispensing the first mixture on a substrate at a first location and removing the first solvent from the first mixture to form a first portion of the layer;
polymerizing the first mixture to form a first portion of the layer at the first location;
dissolving the first composition and the second composition in a second solvent according to a second ratio to obtain a second mixture;
dispensing the second mixture on the substrate at a second location and removing the second solvent from the second mixture to form a second portion of the layer; and
polymerizing the second mixture to form a second portion of the layer at the second location.

11. The method of claim 1, wherein obtaining the mixture and forming the layer based on the mixture comprise:
dispensing a first composition on an alignment structure to form a first portion, dispensing a second composition on the first portion to form a second portion;
mixing the first and second portions to form the mixture; and
polymerizing the mixture to form the layer.

12. The method of claim 11, wherein mixing the first and second portions comprises heating the first and second portions to form the mixture.

13. The method of claim 1, further comprising:
forming an alignment structure on a substrate,
wherein forming the layer based on the mixture comprises forming the layer on the alignment structure based on the mixture, and
wherein molecules in the layer are aligned at least partially by the alignment structure.

14. The method of claim 1, wherein forming a layer based on the mixture comprises dispensing the mixture using an inkjet printer.

15. The method of claim 1, wherein obtaining the mixture and forming the layer based on the mixture comprise:
dispensing, through an inkjet printer, the first composition on a substrate; and
dispensing, through the inkjet printer, the second composition on the first composition to form the mixture.

16. A method, comprising:
dispensing a first composition on a substrate to form a first layer;
exposing the first layer to a first polarization interference to form a first birefringent medium layer with a first optic axis having a first varying orientation;
dispensing a second composition onto the substate or the first birefringent medium layer to form a second layer; and
exposing the second layer to a second polarization interface to form a second birefringent medium layer with a second optic axis having a second varying orientation,
wherein the first birefringent medium layer and the second birefringent medium layer form a third birefringent medium layer having at least one of a thickness variation, a birefringence variation, or a slant angle variation in at least one dimension of the third birefringent medium layer.

17. The method of claim 16, wherein
the first birefringent medium layer has a first thickness variation, a first birefringence, and a first slant angle,
the second birefringent medium layer has a second thickness variation, a second birefringence, and a second slant angle, and
the first birefringent medium layer and the second birefringent medium layer have at least one of a difference in the first thickness variation and the second thickness variation, a difference in the first birefringence and the second birefringence, or a difference in the first slant angle and the second slant angle.

18. A birefringent medium layer, comprising:
a first composition having a first birefringence and a first chirality; and
a second composition having a second birefringence and a second chirality, the second composition being mixed with the first composition,
wherein at at least two different locations of the birefringent medium layer, ratios between amounts of the first composition and the second composition are different, and
wherein the birefringent medium layer has at least one of a thickness variation, a birefringence variation, or a slant angle variation along at least one dimension at a plurality of different locations.

19. The birefringent medium layer of claim 18, wherein the birefringent medium layer includes a thickness variation, a birefringence variation, and a slant angle variation in two dimensions within a plane perpendicular to a thickness direction of the birefringent medium layer.

20. The birefringent medium layer of claim 18, wherein the first composition and the second composition have a difference between at least one of the first birefringence and the second birefringence or the first chirality and the second chirality.
